(19) United States
(12) Patent Application Publication
(10) Pub. No.: US 2007/0094384 A1
(43) Pub. Date: Apr. 26, 2007

(54) Macro information generation system, macro information generation device, macro information generation method and macro information generation program

(75) Inventors: Norikazu Matsumura, Tokyo (JP); Satoshi Morinaga, Tokyo (JP); Kenji Yamanishi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/500,937

(22) Filed: Aug. 9, 2006

(30) Foreign Application Priority Data
Aug. 11, 2005 (JP) 2005-233638
Dec. 1, 2005 (JP) 2005-348322

(51) Int. Cl. G06F 15/16

(52) U.S. Cl. 709/224; 709/202

(57) ABSTRACT

By integrating at a center and analyzing not only data accumulated in a single site but also data accumulated in distribution in a plurality of sites, macro information can be obtained. An aggregation unit of a site device of a plurality of remote sites extracts information contained in accumulated data to generate aggregated information. An aggregated information integration unit of a center device generates integrated aggregated information by integrating aggregated information which is received from each site and an approximate information generation unit generates approximate information which reproduces the contents of data of all the remote sites. Then, an analysis unit generates macro information based on the approximate information. This arrangement enables macro information as the whole system to be generated to high precision. In addition, the volume of communication between the site and the center at the time of data analysis can be reduced to ensure privacy protection.

### BACKGROUND OF THE INVENTION

1. Field of the Invention

The present invention relates to a macro information generation system, a macro information generation device, a macro information generation method and a macro information generation program for generating macro information as information obtained by macroscopically integrating heterogeneous data which is accumulated by a plurality of distributed information sources. The present invention also relates to a macro information distribution system, a macro information distribution device and a macro information distribution program for distributing macro information. The present invention relates to a data accumulation device for accumulating data and an accumulated data processing program for processing accumulated data.

2. Description of the Related Art

Executed with a macro information generation device is obtaining, with respect to data from an information source of each site, information (macro information) to high precision which is a bird's eye view of the entire data without concentrating raw data of each site (data itself accumulated by each site) on one place. Recited, for example, in Literature 1 is a system of increasing an estimation precision of obtained macro information by repeatedly executing information integration and estimation processing at an individual site. Also, recited in Literature 4 is a system of increasing an estimation precision of obtained macro information by repeatedly executing estimation processing and modification of an estimation parameter at an individual site.

Macro information can be obtained to high precision with respect to data from an information source of each site without concentrating raw data of each site at one place and without repeatedly executing data communication (transmission and reception of raw data) through a communication network. Recited, for example, in Literature 2 is a system in which a plurality of sites estimate probability distributions from respective data sets and based on these probability distributions, estimate a simultaneous probability distribution obtained with a plurality of information sources regarded as one information source to obtain macro information.

Further executed is obtaining macro information not as a probability distribution but as predetermined rules. Recited, for example, in Literature 3 is a system in which a plurality of sites estimate rules from respective data sets and by using the estimation result, estimate rules which explain the whole data to obtain macro information.

Literature 1: Patent Laying-Open No 10-171772 (paragraphs 0035-0037, FIG. 2)

Literature 2: Patent Laying-Open No 2004-102537 (paragraphs 0033-0036, FIG. 1)

Literature 3: Patent Laying-Open No 09-034721 (paragraphs 0030-0041,Fig. 1 - FIG. 4)

Literature 4: C. Clifton, M. Kantarcioglu, X. Lin and M. Y. Zhu, “Tools for Privacy Preserving Distributed Data Mining”, ACM SIGKDD Explorations Newsletter, Volume 4, Issue 2, pp. 28-34, December 2002.

In a case of generating macro information by using the system recited in Literature 1 or Literature 4, however, in order to estimate a probability distribution as a whole from data accumulated by the respective information sources to high precision, communication is required several times between each site and a device which integrates information (which will be referred to as a center device hereafter) to repeat estimation processing every time a center receives information. As a result, repetitious execution of communication invites high costs, as well as increasing a probability of leakage of secret information. Further problem is increasing danger of privacy invasion because secret information of other site is accessibly by inverse operation of information sent from the center.

In a case of generating macro information by using the system recited in Literature 2, however, in order to solve the above-described problems, a simultaneous probability distribution is estimated to high precision without repeatedly executing data communication through a communication network. For obtaining similarity between sites in advance, however, the center device needs to accumulate advance knowledge as information indicative of similarity between sites in advance. As a result, requirement of advance knowledge largely limits a range where macro information can be generated by applying the method recited in Literature 2. Further problem is that even with the system recited in Literature 2, when the center device fails to accumulate advance knowledge, macro information can not be generated appropriately in some cases.

On the other hand, when generating macro information by using the system recited in Literature 3, predetermined rules which explain whole data at a high speed can be estimated without repetitious execution of data communication through a communication network. The system recited in Literature 3, however, has a problem of failing to assume existence of heterogeneousness such as variation of data property in the respective sites. Therefore, even with the system recited in Literature 3, when each information source accumulates heterogeneous data, macro information can not be appropriately generated in some cases.

For example, under actual various information processing environments, obtaining macro information is in some cases crucial by integrating and analyzing, by the center, not only data accumulated in a single site but also data accumulated in a plurality of distributed sites. In this case, due to such problems as the volume of communication and privacy, concentrating the whole raw data of the respective sites at one place in itself lacks a reality in many cases. Even if raw data is concentrated on one place, such heterogeneousness often exists between sites as a difference in dimension of data used in analysis between data sets. “Dimension of data” represents a dimension of data expressed as a vector which is obtained when the data is analyzed at the center.

In addition, it is desirable that even if raw data is not transmitted to the center, when analyzing data accumulated by each information source to generate macro information, the analysis should be made to approximately the same precision as that in a case where the whole raw data is concentrated at one place (center) and analyzed. It is also desirable to enable analysis by various kinds of analysis methods when analyzing data accumulated by each information source. Furthermore, it is desirable, when presenting macro information to a user, to present the data in a data form easy to understand and significant for the user.

### SUMMARY OF THE INVENTION

Accordingly, an object of the present invention is to provide a macro information generation system, a macro information distribution system, a macro information generation device, a macro information distribution device, a data accumulation device, a macro information generation method, a macro information generation program, a macro information distribution program and an accumulated data processing program which enable generation of macro information without concentrating raw data as data itself accumulated by each site at one place.

Another object of the present invention is to provide a macro information generation system, a macro information distribution system, a macro information generation device, a macro information distribution device, a data accumulation device, a macro information generation method, a macro information generation program, a macro information distribution program and an accumulated data processing program which enable generation of macro information even when the amount of information of data transmitted from each site is small.

A further object of the present invention is to provide a macro information generation system, a macro information distribution system, a macro information generation device, a macro information distribution device, a data accumulation device, a macro information generation method, a macro information generation program, a macro information distribution program and an accumulated data processing program which enable generation of macro information with respect to heterogeneous data accumulated in distribution.

A still further object of the present invention is to provide a macro information generation system, a macro information distribution system, a macro information generation device, a macro information distribution device, a data accumulation device, a macro information generation method, a macro information generation program, a macro information distribution program and an accumulated data processing program which enable generation of macro information without requiring advance knowledge as information indicative of similarity between sites.

A still further object of the present invention is to provide a macro information generation system, a macro information distribution system, a macro information generation device, a macro information distribution device, a data accumulation device, a macro information generation method, a macro information generation program, a macro information distribution program and an accumulated data processing program which enable generation of macro information to approximately the same degree of precision as that of a case where raw data is concentrated on one place.

A still further object of the present invention is to provide a macro information generation system, a macro information distribution system, a macro information generation device, a macro information distribution device, a data accumulation device, a macro information generation method, a macro information generation program, a macro information distribution program and an accumulated data processing program which enable generation of macro information by various analysis manners.

A still further object of the present invention is to provide a macro information generation system, a macro information distribution system, a macro information generation device, a macro information distribution device, a data accumulation device, a macro information generation method, a macro information generation program, a macro information distribution program and an accumulated data processing program which enable macro information easy to grasp and significant to be presented to a user.

According to the first aspect of the invention, a macro information generation system, comprises a plurality of data accumulation devices which accumulate data, and a data processing device which processes data accumulated by each the data accumulation device, wherein the data accumulation device includes aggregated information generation unit which generates aggregated information obtained by aggregating accumulated data by a predetermined method, and aggregated information transmission unit which transmits aggregated information generated by the aggregated information generation unit to the data processing device through a communication network, and the data processing device includes data reproduction unit which generates reproduction data which reproduces the contents of data accumulated by each the data accumulation device based on aggregated information received from each the data accumulation device, and macro information generation unit which analyzes reproduction data generated by the data reproduction unit to generate macro information as information obtained by macroscopically integrating data accumulated by each the data accumulation device.

In the preferred construction of the macro information generation system, the data processing device includes aggregated information integration unit which generates integrated aggregated information which is obtained by integrating aggregated information received from each data accumulation device, and the data reproduction unit generates reproduction data based on integrated aggregated information which is generated by the aggregated information integration unit.

In another preferred construction of the macro information generation system, the macro information generation unit generates sampling data as reproduction data by sampling aggregated information received from each data accumulation device.

In another preferred construction of the macro information generation system, the data processing device includes aggregated information integration unit which generates integrated aggregated information which is obtained by integrating aggregated information received from each data accumulation device, the data reproduction unit generates reproduction data based on integrated aggregated information which is generated by the aggregated information integration unit, and the macro information generation unit generates sampling data as reproduction data by sampling aggregated information received from each data accumulation device.

In another preferred construction of the macro information generation system, the data accumulation device includes dimension information generation unit which generates dimension information indicative of a dimension of accumulated data, and dimension information transmission unit which transmits dimension information generated by the dimension information generation unit to the data processing device through the communication network, and the data processing device includes dimension information integration unit which generates integrated dimension information obtained by integrating dimension information received from each data accumulation device, and the data reproduction unit generates reproduction data based on aggregated information received from each the data accumulation device and integrated dimension information generated by the dimension information integration unit.

In another preferred construction of the macro information generation system, the data processing device includes dictionary storage unit which stores a predetermined word dictionary, and the dimension information integration unit generates, as integrated dimension information, a correspondence rule indicative of a corresponding relationship between words contained in dimension information received from each data accumulation device based on the word dictionary stored by the dictionary storage unit.

In another preferred construction of the macro information generation system, the macro information generation unit obtains, as macro information, a macro distribution which is a distribution of a probability that an information element contained in data accumulated by each data accumulation device will appear in the data.

In another preferred construction of the macro information generation system, the data processing device includes data conversion unit which converts a macro distribution generated by the macro information generation unit into a predetermined data form.

In another preferred construction of the macro information generation system, the data conversion unit converts a macro distribution generated by the macro information generation unit into a predetermined data form by extracting activeness or a characteristic word in each topic contained in data accumulated by each data accumulation device.

In another preferred construction of the macro information generation system, the data conversion unit extracts partial information from a macro distribution generated by the macro information generation unit to convert the partial information extracted into a predetermined data form according to predetermined extraction conditions.

In another preferred construction of the macro information generation system, the data processing device includes corresponding relationship calculation unit which obtains information indicative of a corresponding relationship between a macro distribution generated by the macro information generation unit and partial information extracted by the data conversion unit.

In another preferred construction of the macro information generation system, the data processing device includes domain dictionary storage unit which stores a domain dictionary as a dictionary in which information and a technical domain are correlated, and labeling processing unit which executes predetermined labeling processing based on the domain dictionary stored by the domain dictionary storage unit.

In another preferred construction of the macro information generation system, the data conversion unit extracts partial information from a macro distribution generated by the macro information generation unit according to predetermined extraction conditions, and the labeling processing unit applies predetermined label information to partial information extracted by the data conversion unit based on the domain dictionary stored by the domain dictionary storage unit.

In another preferred construction of the macro information generation system, the labeling processing unit extracts a technical domain corresponding to partial information from the domain dictionary to apply the extracted technical domain as label information to the partial information.

In another preferred construction of the macro information generation system, the data processing device includes graph generation unit which generates a graph for displaying comparison between data accumulated by the respective data accumulation devices.

In another preferred construction of the macro information generation system, the graph generation unit generates a radar chart for competition analysis by using a constitution ratio of a topic on the data accumulation device side and a topic on the data processing device side.

In another preferred construction of the macro information generation system, the aggregated information generation unit obtains, as aggregated information, a distribution of a probability that an information element contained in data accumulated by the data accumulation device will appear in the data or a quantity of statistics based on a dimension of the data accumulated by the data accumulation device.

In another preferred construction of the macro information generation system, the data processing device includes topic extraction unit which extracts a common topic appearing commonly over the whole time zone, an individual topic appearing in a specific period or a new topic newly appearing based on time series text data.

In another preferred construction of the macro information generation system, the data accumulation device includes evaluation information storage unit which stores evaluation information indicative of evaluation of data contents of text data or a target, and evaluation information transmission unit which transmits evaluation information stored by the evaluation information storage unit to the data processing device through the communication network, and the data processing device includes correspondence information generation unit which generates correspondence information indicative of a corresponding relationship between text data corresponding to evaluation information received from the data accumulation device and data contents of the text data or a target.

According to the second aspect of the invention, a macro information generation system, comprises a plurality of data accumulation devices which accumulate data, and a data processing device which processes data accumulated by each the data accumulation device, wherein the data accumulation device includes aggregated information generation unit which generates aggregated information obtained by aggregating accumulated data by a predetermined method, and aggregated information transmission unit which transmits aggregated information generated by the aggregated information generation unit to the data processing device through a communication network, and the data processing device includes aggregated information integration unit which generates integrated aggregated information which is obtained by integrating aggregated information received from each data accumulation device, and macro information generation unit which generates macro information as information obtained by macroscopically integrating data accumulated by each the data accumulation device based on integrated aggregated information generated by the aggregated information integration unit.

According to the third aspect of the invention, a macro information generation system, comprises a plurality of data accumulation devices which accumulate data, and a data processing device which processes data accumulated by each the data accumulation device, wherein the data accumulation device includes aggregated information generation unit which generates aggregated information obtained by aggregating accumulated data by a predetermined method, data reproduction unit which generates reproduction data which reproduces the contents of data accumulated by the data accumulation device based on aggregated information generated by the aggregated information generation unit, and reproduction data transmission unit which transmits reproduction data generated by the data reproduction unit to the data processing device through a communication network, and the data processing device includes macro information generation unit which analyzes reproduction data received from the data accumulation device to generate macro information as information obtained by macroscopically integrating data accumulated by each the data accumulation device.

According to another aspect of the invention, a macro information distribution system, comprises a plurality of data accumulation devices which accumulate data, and a data processing device which processes data accumulated by each the data accumulation device, wherein the data accumulation device includes aggregated information generation unit which generates aggregated information obtained by aggregating accumulated data by a predetermined method, and aggregated information transmission unit which transmits aggregated information generated by the aggregated information generation unit to the data processing device through a communication network, and the data processing device includes data reproduction unit which generates reproduction data which reproduces the contents of data accumulated by each the data accumulation device based on aggregated information received from each the data accumulation device, macro information generation unit which analyzes reproduction data generated by the data reproduction unit to generate macro information as information obtained by macroscopically integrating data accumulated by each the data accumulation device, and macro information distribution unit which transmits macro information generated by the macro information generation unit to the data accumulation device through the communication network.

According to another aspect of the invention, a macro information generation device, comprises aggregated information reception unit which receives, from a plurality of data accumulation devices which accumulate data, aggregated information obtained by aggregating data accumulated by the data accumulation device by a predetermined method through a communication network, data reproduction unit which generates reproduction data which reproduces the contents of data accumulated by each the data accumulation device based on aggregated information received by the aggregated information reception unit, and macro information generation unit which analyzes reproduction data generated by the data reproduction unit to generate macro information as information obtained by macroscopically integrating data accumulated by each the data accumulation device.

According to another aspect of the invention, a macro information distribution device, comprises aggregated information reception unit which receives, from a plurality of data accumulation devices which accumulate data, aggregated information obtained by aggregating data accumulated by the data accumulation device by a predetermined method through a communication network, data reproduction unit which generates reproduction data which reproduces the contents of data accumulated by each the data accumulation device based on aggregated information received by the aggregated information reception unit, macro information generation unit which analyzes reproduction data generated by the data reproduction unit to generate macro information as information obtained by macroscopically integrating data accumulated by each the data accumulation device, and macro information distribution unit which transmits macro information generated by the macro information generation unit to the data accumulation device through the communication network.

According to another aspect of the invention, a data accumulation device in a macro information generation system which generates macro information as information obtained by macroscopically integrating data accumulated by a plurality of data accumulation devices, comprises aggregated information generation unit which generates aggregated information obtained by aggregating accumulated data by a predetermined method, data reproduction unit which generates reproduction data which reproduces the contents of data accumulated by the data accumulation device based on aggregated information generated by the aggregated information generation unit, and reproduction data transmission unit which transmits reproduction data generated by the data reproduction unit to a data processing device which processes data accumulated by each data accumulation device through a communication network.

According to another aspect of the invention, a macro information generation method, comprising the steps of a step, of a plurality of data accumulation devices which accumulate data, of generating aggregated information which is obtained by aggregating accumulated data by a predetermined method, a step of each the data accumulation device of transmitting the aggregated information generated to a data processing device which processes data accumulated by each the data accumulation device through a communication network, a step of the data processing device of generating reproduction data which reproduces the contents of data accumulated by each the data accumulation device based on aggregated information received from each the data accumulation device, and a step of the data processing device of analyzing the reproduction data generated to generate macro information as information obtained by macroscopically integrating data accumulated by each the data accumulation device.

According to another aspect of the invention, a macro information generation program for generating macro information as information obtained by macroscopically integrating data accumulated by a plurality of data accumulation devices, comprising the following functions executed on a computer, aggregated information reception function of receiving aggregated information obtained by aggregating data accumulated by the data accumulation device by a predetermined method from the plurality of data accumulation devices which accumulate data through a communication network, data reproduction“function of generating reproduction data which reproduces the contents of data accumulated by each the data accumulation device based on the aggregated information received, and macro information generation function of analyzing the reproduction data generated to generate macro information.

According to another aspect of the invention, a macro information distribution program for distributing macro information as information obtained by macroscopically integrating data accumulated by a plurality of data accumulation devices, comprising the following functions executed on a computer, aggregated information reception function of receiving aggregated information obtained by aggregating data accumulated by the data accumulation device by a predetermined method from the plurality of data accumulation devices which accumulate data through a communication network, data reproduction function of generating reproduction data which reproduces the contents of data accumulated by each the data accumulation device based on aggregated information received from each data accumulation device, macro information generation function of analyzing the reproduction data generated to generate macro information, and macro information distribution function of transmitting the macro information generated to the data accumulation device through the communication network.

According to another aspect of the invention, an accumulated data processing program for a data accumulation device to process accumulated data in a macro information generation system which generates macro information as information obtained by macroscopically integrating data accumulated by a plurality of data accumulation devices, comprising the following functions executed on a computer including data accumulation unit for accumulating data, aggregated information generation function of generating aggregated information obtained by aggregating data accumulated by the data accumulation unit by a predetermined method, data reproduction function of generating reproduction data which reproduces the contents of data accumulated by the data accumulation unit based on the aggregated information generated, and reproduction data transmission function of transmitting the reproduction data generated to a data processing device which processes data accumulated by each data accumulation device through a communication network.

In the macro information generation system according to the present invention, a data accumulation device on the side of a site preferably includes a data storage unit for storing data and an aggregation unit for aggregating data, and a data processing device on the side of a center includes an aggregated information storage unit for storing aggregated information from the site, an aggregated information integration unit for integrating aggregated information of all the sites, an approximate information generation unit for generating information approximated to raw data of all the sites from aggregated information integrated, an approximate information storage unit for storing generated approximate information and an analysis unit for generating macro information.

With such a structure as described above, macro information can be generated based on only information aggregated at the site and integrated by the center. Therefore, the first object of the present invention can, be achieved, which is to enable generation of macro information without concentrating raw data as data itself accumulated by each site on one place. The second object of the present invention can be also achieved which is to enable generation of macro information even when the amount of information of data transmitted from each site is small. The fourth object of the present invention can be achieved as well which is to enable generation of macro information without requiring advance knowledge as information indicative of similarity between sites.

Moreover, data analysis can be made at the same state as that in a case where information approximated to raw data of all the sites is generated to concentrate raw data on one place to execute data analysis. Therefore, the fifth object of the present invention can be achieved which is to enable macro information to be generated with approximately the same degree of precision as that of a case where raw data is concentrated on one place. In addition, the sixth object of the present invention to enable generation of macro information by various analysis methods can be achieved as well.

In the macro information generation system according to the present invention, in addition to the above-described components, the site side data accumulation device desirably includes a dimension counting unit for counting a dimension for use in analyzing data and the center side data processing device desirably includes an integrated dimension generation unit for integrating dimensions of all the sites and an integrated dimension storage unit for storing the integrated dimension. Adopting such a structure enables the third object of the present invention to be achieved which is to enable generation of macro information with respect to heterogeneous data accumulated in distribution.

Furthermore, the macro information generation system according to the present invention, in place of the analysis unit, includes a macro distribution generation unit and in addition to the above-described components, desirably includes a display unit for converting macro information into a form easy to grasp for a user. Adopting such a structure enables the seventh object of the present invention to be achieved which is to present macro information easy to grasp and significant to a user.

According to the present invention, the data accumulation device generates aggregated information and transmits the same to the data processing device without transmitting accumulated raw data. In addition, the data processing device generates reproduction data based on aggregated information to generate macro information. Accordingly, macro information can be generated without concentrating, on one place, raw data as data itself which is accumulated by each site. In addition, even without reception of raw data from each data accumulation device, the data processing device is allowed to analyze data accumulated by all the sites similarly to the case of analyzing raw data.

Further according to the present invention, only the transmission of aggregated information by each data accumulation device to the data processing device enables reproduction of raw data accumulated by each data accumulation device. Therefore, at the time of executing data analysis to generate macro information, the data accumulation device is allowed to execute data analysis by using various analysis methods without being limited to a specific analysis manner. Moreover, according to the present invention, because the data processing device is allowed to execute data analysis with data accumulated by each data accumulation device being reproduced, data analysis is possible to the same degree of precision as that of a case of analysis of raw data accumulated by each data accumulation device.

Moreover, structuring the data processing device in the present invention to integrate aggregated information received and generate reproduction data which reproduces the contents of the data of all the sites by using only the aggregated information integrated enables the data processing device to generate macro information by only one transmission of aggregated information by each data accumulation device to the data processing device. In addition, since macro information can be generated only by one transmission of aggregated information from the data accumulation device to the data processing device, the volume of communication of the system as a whole can be small. Furthermore, since no transmission of information of a certain site to other site is required for the analysis of macro information, there is no danger of information of its own site being analyzed and known by other site. In addition, since information transmitted by the data accumulation device is not raw data itself but aggregated information and transmission to the data processing device is only once, there is no danger of leakage of the information to the outside of the system. Accordingly, as compared with a case where raw data is gathered at one place and analyzed, privacy can be more reliably preserved.

Furthermore, structuring each data accumulation device in the present invention to transmit dimension information in addition to aggregated information to the data processing device enables the data processing device to generate macro information based on the dimension information in addition to the aggregated information. Since data analysis taking a dimension of accumulated data into consideration can be executed, even when there exists heterogeneousness in data accumulated by each data accumulation device, macro information can be generated by integrating dimensions between data. Accordingly, as to heterogeneous data accumulated in distribution, macro information can be generated.

In addition, structuring in the present invention to convert a generated macro distribution into a predetermined data form enables even a macro distribution generated with a data form not easy to understand for a user to be converted into information of a data form easy to understand and valuable for a user and presented to the user.

In addition, structuring in the present invention to obtain information indicative of a corresponding relationship between a macro distribution and partial information enables macro information easy to grasp and significant to be presented to a user.

Furthermore, structuring in the present invention to apply predetermined label information to extracted partial information enables partial information to be converted into information easier to grasp for a user. Accordingly, macro information easier to grasp and more significant can be presented to the user.

Moreover, structuring in the present invention to generate a graph for comparing and displaying data accumulated by each data accumulation device enables information necessary for relative comparison between sites to be presented to a user to support competition analysis and the like.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing one example of a structure of a macro information generation system according to the present invention;

FIG. 2 is a flow chart showing one example of processing of generating aggregated information and transmitting the same to a center device by a site device;

FIG. 3 is a flow chart showing one example of processing of generating macro information by the center device;

FIG. 4 is a block diagram showing another example of a structure of the macro information generation system;

FIG. 5 is a flow chart showing another example of processing of generating aggregated information and transmitting the same to the center device by the site device;

FIG. 6 is a flow chart showing another example of processing of generating macro information by the center device;

FIG. 7 is a block diagram showing a further example of a structure of the macro information generation system;

FIG. 8 is a flow chart showing a further example of processing of generating macro information by the center device;

FIG. 9 is a block diagram showing a still further example of a structure of the macro information generation system;

FIG. 10 is a flow chart showing a still further example of processing of generating macro information by the center device;

FIG. 11 is a block diagram showing a still further example of a structure of the macro information generation system;

FIG. 12 is a flow chart showing a still further example of processing of generating macro information by the center device;

FIG. 13 is a block diagram showing a still further example of a structure of the macro information generation system;

FIG. 14 is a flow chart showing a still further example of processing of generating macro information by the center device;

FIG. 15 is a block diagram showing a still further example of a structure of the macro information generation system;

FIG. 16 is a flow chart showing an example of processing of generating approximate information and transmitting the same to the center device by the site device;

FIG. 17 is a flow chart showing a still further example of processing of generating macro information by the center device;

FIG. 18 is a block diagram showing a still further example of a structure of the macro information generation system;

FIG. 19 is a block diagram showing a still further example of a structure of the macro information generation system;

FIG. 20 is a flow chart showing a still further example of processing of generating macro information by the center device;

FIG. 21 is a block diagram showing a still further example of a structure of the macro information generation system;

FIG. 22 is a flow chart showing a still further example of processing of generating macro information by a center device 30;

FIG. 23 is a block diagram showing a specific example of a structure of a macro information generation system;

FIG. 24 is a block diagram showing another specific example of a structure of the macro information generation system;

FIG. 25 is a diagram for use in explaining an output example of text data and topic analysis results accumulated at each site and an output example of topic analysis results of the whole site as macro information;

FIG. 26 is a block diagram showing a further specific example of a structure of the macro information generation system;

FIG. 27 is a diagram for use in explaining an example of a constitution ratio of a site or a topic of a site obtained by a constitution predicting unit with respect to each topic on the center side;

FIG. 28 is a diagram for use in explaining an example of a table in which topics on the center side and the site side are correlated with each other;

FIG. 29 is a diagram for use in explaining a business model application concept in the present embodiment;

FIG. 30 is a block diagram showing a still further specific example of a structure of the macro information generation system;

FIG. 31 is a diagram for use in explaining an example of labeling of a topic;

FIG. 32 is a block diagram showing a still further specific example of a structure of the macro information generation system; and

FIG. 33 is a diagram for use in explaining an output example of a radar chart automatically generated and output based on a site constitution ratio of a center topic.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

(First Mode of Implementation)

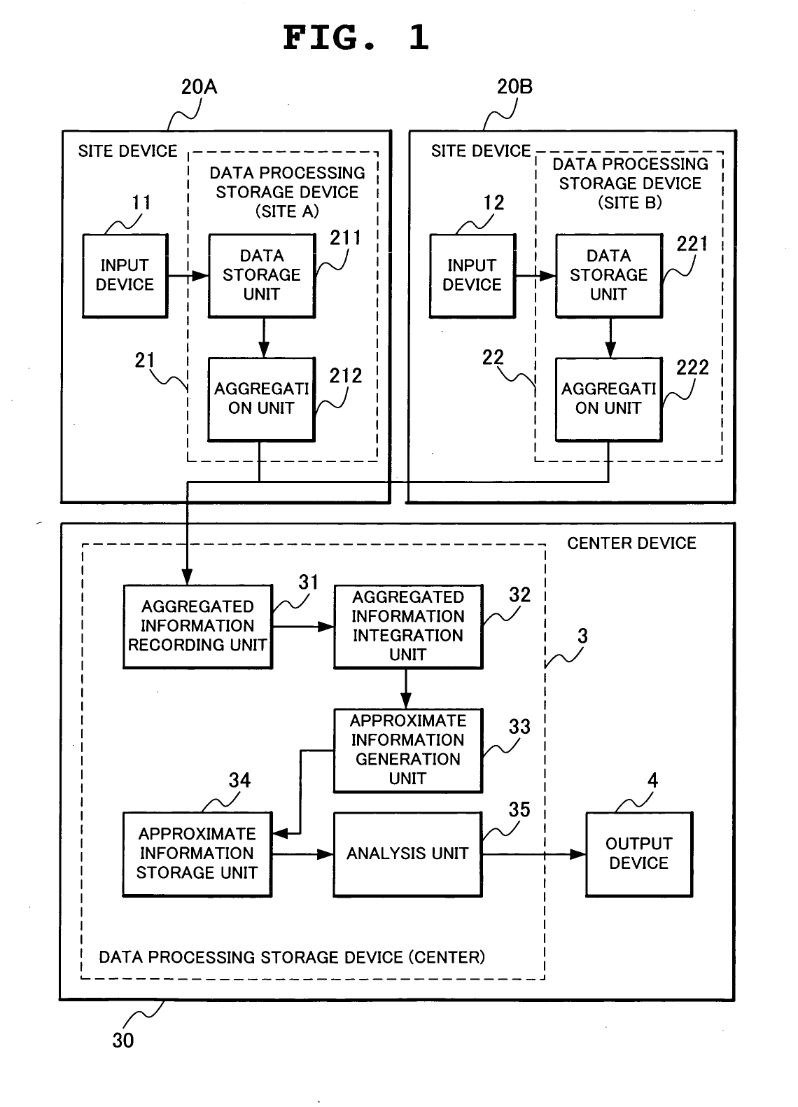

In the following, a first mode of implementation of the present invention will be described with reference to the drawings. FIG. 1 is a block diagram showing one example of a structure of a macro information generation system according to the present invention. As shown in FIG. 1, the macro information generation system includes site devices 20A and 20B which accumulate various kinds of data and a center device 30 for processing data. In addition, the respective site devices 20A and 20B and a data processing storage device 3 are connected through a communication network such as the Internet or LAN. Although shown in FIG. 1 are two site devices 20A and 20B, the macro information generation system may include three or more site devices.

In the present mode of implementation, the macro information generation system is applicable to an information analysis system for corporations which uses, for example, CRM (Customer Relationship Management), knowledge management, BPM (Business Process Management) or BAM (Business Activity Monitoring). In this case, the macro information generation system, for example, analyzes corporate knowledge such as activity reports or weekly reports to generate macro information based on data accumulated by a corporation. In addition, the macro information generation system is applicable for use in analyzing customer inquiry data to generate macro information at a contact center, for example. The macro information generation system is also applicable for use, for example, in analyzing articles publicized on a Web such as BLOG (Weblog), RSS (Rich Site Summary) and a bulletin board to generate macro information.

The site devices 20A and 20B are specifically realized by an information processing terminal such as a personal computer. In a case, for example, where the macro information generation system is used for analyzing corporate knowledge, the site devices 20A and 20B are disposed at the respective corporations. When the macro information generation system is used, for example, in analyzing customer inquiry data, the site devices 20A and 20B are disposed at a contact center or a call center. As shown in FIG. 1, the site devices 20A and 20B include input devices 11 and 12 and data processing storage devices (sites) 21 and 22.

The input devices 11 and 12 are specifically realized by a CPU of an information processing terminal operable according to a program and an input unit such as a keyboard or a mouse. The input devices 11 and 12 include an input unit for inputting data such a text document.

The input devices 11 and 12 receive input of various data through a keyboard according to, for example, input operation by a user at a site. In addition, the input devices 11 and 12 receive input, for example, of contact contents (contents of communication between an operator and a customer) at a call center through a contact center device. In this case, the input devices 11 and 12 use, for example, application software (hereinafter simply referred to as an application) to receive input of data which is transferred as it is from the contact center device.

In addition, the input devices 11 and 12 download, for example, articles and the like recited on a Web site through the Internet by using the application. The input devices 11 and 12 also receive input of system log accumulated at various servers, for example. In this case, the input devices 11 and 12 receive input of system log transferred as it is from various servers by using the application as data to be analyzed directed to the data processing storage devices (sites) 21 and 22.

The data processing storage devices 21 and 22, which are operable under program control, have a function of processing data input by the input devices 11 and 12. The data processing storage devices (sites) 21 and 22 include data storage units 211 and 221 and aggregation units 212 and 222, respectively.

The data storage units 211 and 221 are specifically realized by a storage device such as a magnetic disk device or an optical disk device. The data storage units 211 and 221 store data input by the input devices 11 and 12. In the present mode of implementation, the data storage units 211 and 221 store the data input by the input devices 11 and 12 as it is.

The aggregation units 212 and 222 are specifically realized by a CPU of an information processing terminal operable according to a program and a network interface unit. The aggregation 212 and 222 have a function of generating aggregated information which is obtained by aggregating data accumulated by the data storage units 211 and 221 by using a predetermined method. In the present mode of implementation, the aggregation 212 and 222 obtain, as aggregated information, a probability distribution based on accumulated data or a predetermined quantity of statistics, for example. In this case, the aggregation units 212 and 222 obtain, for example, a probability of inclusion of each word in data accumulated by the data storage units 211 and 221 or a quantity of statistics of inclusion of each word in the data. In the present mode of implementation, the aggregation 212 and 222 also generate, as aggregated information, a vector including such an information element as an obtained probability distribution or quantity of statistics. The aggregation units 212 and 222 further have a function of transmitting generated aggregated information to the center device 30 through the communication network.

The center device 30 is specifically realized by an information processing device such as a workstation or a personal computer. When the macro information generation system is used in analyzing corporate knowledge, for example, the center device 30 is a server operated by a service provider which distributes macro information as an analysis result of corporate knowledge to each corporation. On the other hand, when the macro information generation system is used in analyzing customer inquiry data, for example, the center device 30 is a server operated by a service provider which distributes macro information as an analysis result of customer inquiry data to each call center. As shown in FIG. 1, the center device 30 includes the data processing storage device (center) 3 and an output device 4.

The data processing storage device 3, which is operable under program control, has a function of processing information transmitted from the data processing storage devices (sites) 21 and 22. The data processing storage device (center) 3 includes an aggregated information recording unit 31, an aggregated information integration unit 32, an approximate information generation unit 33, an approximate information storage unit 34 and an analysis unit 35.

The aggregated information recording unit 31 is specifically realized by a CPU of an information processing device operable according to a program, a network interface unit and a storage device such as a magnetic disk device or an optical disk device. The aggregated information recording unit 31 has a function of recording information aggregated by the aggregation units 212 and 222 of each site.

In the present mode of implementation, the aggregated information recording unit 31 receives aggregated information from the respective site devices 20A and 20B through the communication network. In addition, the aggregated information recording unit 31 stores the received aggregated information in the storage device so as to be correlated with the site devices 20A and 20B. In this case, the aggregated information recording unit 31 stores the aggregated information received from the respective site devices 20A and 20B with information enabling a site to be specified (e.g. an IP address and a department name of the site devices 20A and 20B) added. For example, the center device 30 receives an IP address together with aggregated information from the site devices 20A and 20B to store the received aggregated information so as to be correlated with the IP addresses.

The aggregated information integration unit 32 is specifically realized by a CPU of an information processing device operable according to a program. The aggregated information integration unit 32 has a function of integrating aggregated information of each site which is stored in the aggregated information recording unit 31 by using a predetermined method. In the present mode of implementation, the aggregated information integrating unit 32 generates integrated aggregated information which is obtained by integrating each aggregated information stored by the integrated information recording unit 32.

The approximate information generation unit 33 is specifically realized by a CPU of an information processing device operable according to a program. The approximate information generation unit 33 has a function of reproducing data accumulated by each site based on aggregated information which is integrated (integrated aggregated information) by the aggregated information integration unit 32. In the present mode of implementation, the approximate information generation unit 33 reproduces data accumulated by all the sites which is indicated in the aggregated information by using integrated aggregated information which is generated by the aggregated information integration unit 32. In this case, as reproduction data which reproduces the contents of the data accumulated by the site, the approximate information generation unit 33 generates data containing information contents equivalent to the information contents of the data accumulated by the site (hereinafter, referred to also as approximate information) according to a predetermined algorithm.

The approximate information storage unit 34 is specifically realized by a storage device such as a magnetic disk device or an optical disk device. The approximate information storage unit 34 stores approximate information which is generated as reproduction data by the approximate information generation unit 33.

The analysis unit 35 is specifically realized by a CPU of an information processing device operable according to a program. The analysis unit 35 has a function of analyzing approximate information which is stored by the approximate information storage unit 34 to generate macro information as information obtained by stereoscopically integrating data accumulated at each site. The analysis unit 35 has a function of causing the output device 4 to output generated macro information.

The output device 4 is specifically realized by a display apparatus such as a display device or a printing apparatus such as a printer. The output device 4 has an output unit for outputting a result obtained by the data processing storage device (center). In addition, the output device 4 has a function of outputting macro information generated by the data processing storage device 3. In a case where the output device 4 is a display device, the output device 4 displays macro information generated by the analysis unit 35 according to an instruction of the analysis unit 35. When the output device 4 is a printer, the output device 4 prints macro information generated by the analysis unit 35 according to an instruction of the analysis unit 35.

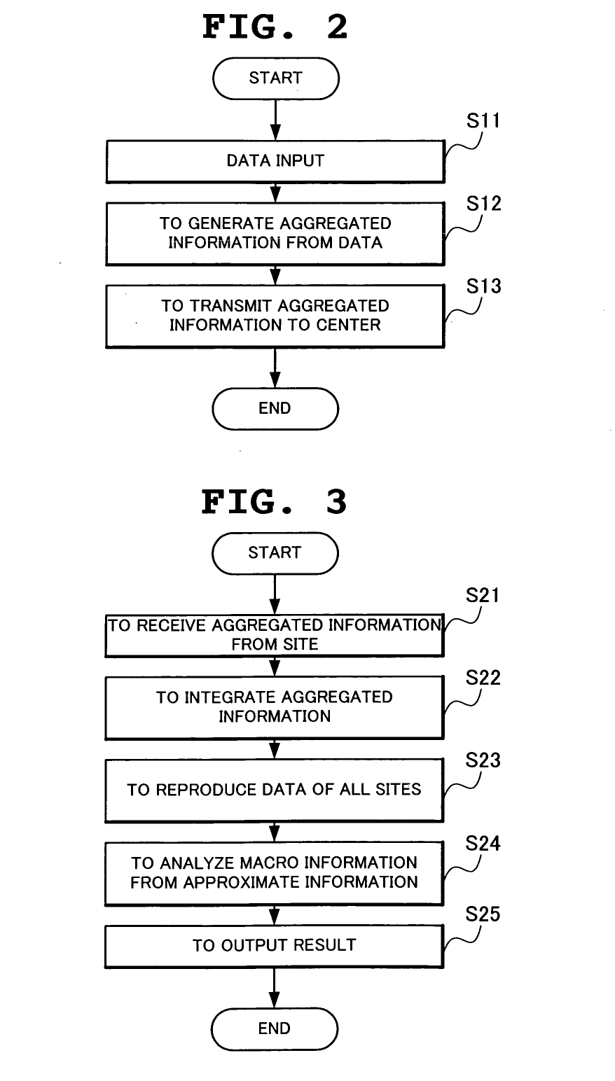

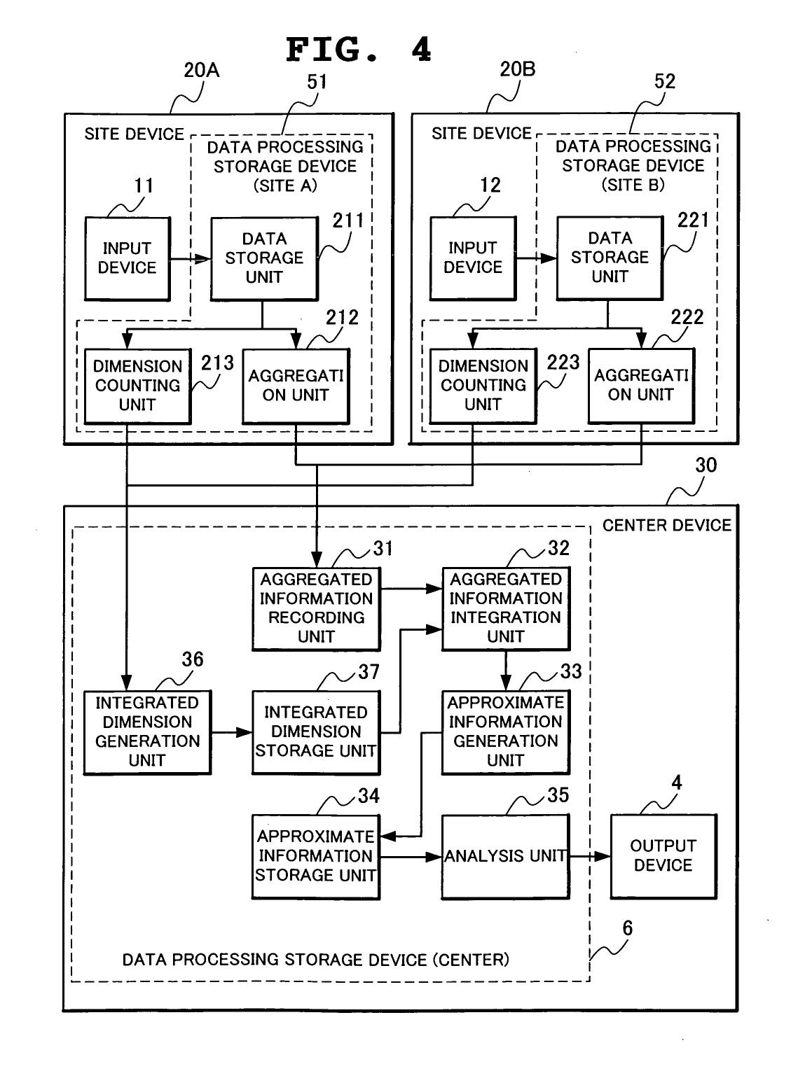

Next, operation will be described. FIG. 2 is a flow chart showing one example of processing of generating aggregated information and transmitting the same to the center device 30 by the site devices 20A and 20B (the input devices 11 and 12 and the data processing storage devices (sites) 21 and 22 ). In addition, FIG. 3 is a flow chart showing one example of processing of generating macro information by the center device 30 (the data processing storage device (center) 3 and the output device 4).

The data processing storage device 21 and 22 of the site devices 20A and 20B receive input of various kinds of data by using the input devices 11 and 12 (Step S11). When the macro information generation system is used for analysis of corporate knowledge, for example, the site devices 20A and 20B receive input of corporate knowledge such as activity reports or weekly reports according to operation by a person in charge of a corporation. In addition, the data processing storage devices (sites) 21 and 22 cause the data storage units 211 and 221 to store the applied data.

The aggregation 212 and 222 of the data processing storage devices (sites) 21 and 22 aggregate the data applied at Step S11 at predetermined timing. The aggregation 212 and 222, for example, extract all the data accumulated at the data storage units 211 and 221 at predetermined intervals. Then, the aggregation 212 and 222 aggregate the extracted data by using a predetermined method to generate aggregated information (Step S12). The aggregation units 212 and 222 also transmit the information aggregated (aggregated information) to the data processing storage device (center) 3 through the communication network (Step S13).

The aggregated information recording unit 31 of the data processing storage device (center) 3 receives the aggregated information through the communication network from each of the data processing storage devices (sites) 21 and 22 (Step S21). The aggregated information recording unit 31 also stores the respective aggregated information received in a storage device. In this case, the aggregated information recording unit 31 stores the aggregated information in addition to information which enables a received site to be specified in the aggregated information recording unit 32. For example, the aggregated information recording unit 31 receives an IP address of each of the site devices 20A and 20B together with the aggregated information from the data processing storage device 21 and 22 to store the aggregated information in the storage device so as to be correlated with the IP addresses.

In addition, the aggregated information integration unit 32 integrates the aggregated information which is accumulated by the aggregated information recording unit 31 at predetermined timing by using a predetermined method (Step S22). For example, when a manager of the center device 30 executes operation of instructing macro information generation, the aggregated information integration unit 32 extracts the aggregated information which is accumulated by the aggregated information recording unit 31 and integrates the aggregated information which is extracted to generate integrated aggregated information.

Based on the aggregated information which is integrated by the aggregated information integration unit 32 (integrated aggregated information), the approximate information generation unit 33 generates approximate information which enables reproduction of information contents of the data accumulated by all the sites (Step S23). The approximate information generation unit 33 also causes the approximate information storage unit 34 to store the generated approximate information.

The analysis unit 35 analyzes the approximate information which reproduces the information contents of the data to generate macro information (Step S24). In this case, the analysis unit 35 extracts the approximate information from the approximate information storage unit 34 and analyzes the extracted approximate information by using a predetermined method to generate macro information. Then, the analysis unit 35 causes the output device 4 to output the generated macro information (Step S25). In this case, the output device 4 displays or prints the macro information according to an instruction of the analysis unit 35.

As described in the foregoing, according to the present mode of implementation, the site device generates aggregated information and transmits the same to the center device without transmitting accumulated raw data (data itself which is accumulated by the site device). In addition, the center device integrates received aggregated information to generate approximate information which reproduces the contents of data of all the sites from the aggregated information integrated. Therefore, even without receiving raw data from each site device, the center device is allowed to analyze data accumulated by all the sites similarly to a case of analyzing raw data.

In other words, according to the present mode of implementation, only with transmission of aggregated information to the center device by each site device, the center device is allowed to reproduce raw data accumulated by each site device. As a result, at the time of executing data analysis to generate macro information, the center device is allowed to execute data analysis by using various analysis methods without being limited to a specific analysis method. Moreover, because the present mode of implementation enables the center device to execute data analysis with data accumulated by each site device reproduced, data analysis can be made to approximately the same degree of precision as that of a case of analyzing raw data accumulated by each site device. It is accordingly possible to generate macro information without concentrating raw data as data itself which is accumulated by each site on one place.

In addition, according to the present mode of implementation, the center device is allowed to integrate received aggregated information to generate approximate information which reproduces the contents of data of all the sites by using only the aggregated information integrated. As a result, only one transmission of aggregated information to the center device by each site device enables the center device to analyze macro information. In addition, because macro information can be generated by only one transmission of aggregated information from the site device to the center device, the required volume of communication of the entire system is small. Furthermore, because for analyzing macro information, it is unnecessary to transmit information of a certain site to other site, there will be no danger of analyzing and knowing information of its own site by other site. In addition, information transmitted by the site device is not raw data itself but aggregated information and transmission to the center device is only once, there will be little danger of leakage of information to the outside of the system. As a result, privacy can be more reliably preserved as compared with a case where raw data is concentrated on one place and analyzed.

(Second Mode of Implementation)

Next, a second mode of implementation of the present invention will be described with reference to the drawings. FIG. 4 is a block diagram showing another example of a structure of the macro information generation system. As shown in FIG. 4, the present mode of implementation differs from the first mode of implementation in that data processing storage devices (sites) 51 and 52 include, in addition to the components of the data processing storage devices (sites) 21 and 22 shown in FIG. 1, dimension counting units 213 and 223 for counting (extracting) a dimension of data. The present mode of implementation further differs from the first mode of implementation in that a data processing storage device (center) 6 includes, in addition to the components of the data processing storage device (center) 3 shown in FIG. 1, an integrated dimension unit 36 for integrating a dimension of each site to generate an integrated dimension and an integrated dimension storage unit 37 for storing an integrated dimension generated.

The dimension counting units 213 and 223 are specifically realized by a CPU of an information processing terminal operable according to a program and a network interface unit. The dimension counting units 213 and 223 have a function of generating dimension information indicative of a dimension of data accumulated by the site devices 20A and 20B. In the present mode of implementation, the dimension counting units 213 and 223 extract a dimension from aggregated information which is generated by the aggregation 212 and 222. The dimension counting units 213 and 223, for example, extract a dimension of a vector of aggregated information which is generated as a vector by the aggregation units 212 and 222 at predetermined timing (e.g. at predetermined intervals) to generate dimension information indicative of the extracted dimension. “Dimension” here, when data is text, for example, represents a vocabulary used in data (e.g. vocabularies such as “. . company”, “personal computer”, “world”). In a case where data is category data, for example, “dimension” represents a category corresponding to the data (e.g. when accumulated data is mail data, represents information indicative of a predetermined category such as “a kind of mail error”) .

In addition, the dimension counting units 213 and 223 have a function of transmitting generated dimension information to the center device 30 through the communication network.

The integrated dimension generation unit 36 is specifically realized by a CPU of an information processing device operable according to a program and a network interface unit. The integrated dimension unit 36 has a function of integrating a dimension transmitted from each of the site devices 20A and 20B. In the present mode of implementation, the integrated dimension generation unit 36 receives dimension information from the respective site devices 20A and 20B through the communication network. The integrated dimension generation unit 36 also causes a storage device such as a magnetic disk device to once store each dimension information received. The integrated dimension generation unit 36 extracts each dimension information from the storage device at predetermined timing (e.g. at predetermined intervals) and integrates each dimension information extracted by a predetermined method to generate integrated dimension information. When data is text data or category data, for example, the integrated dimension generation unit 36 correlates dimensions from vocabularies contained in the data to generate an integrated dimension.

The integrated dimension storage unit 37 is specifically realized by a storage device such as a magnetic disk device or an optical disk device. The integrated dimension storage unit 37 stores an integrated dimension (integrated dimension information) generated by the integrated dimension unit 36.

In the present mode of implementation, the functions of the respective components in the site devices 20A and 20B other than the dimension counting units 213 and 223 are the same as those of their counterparts shown in the first mode of implementation. In addition, the functions of the respective components in the center device 30 other than the integrated dimension generation unit 36 and the integrated dimension storage unit 37 are the same as those of their counterparts shown in the first mode of implementation.

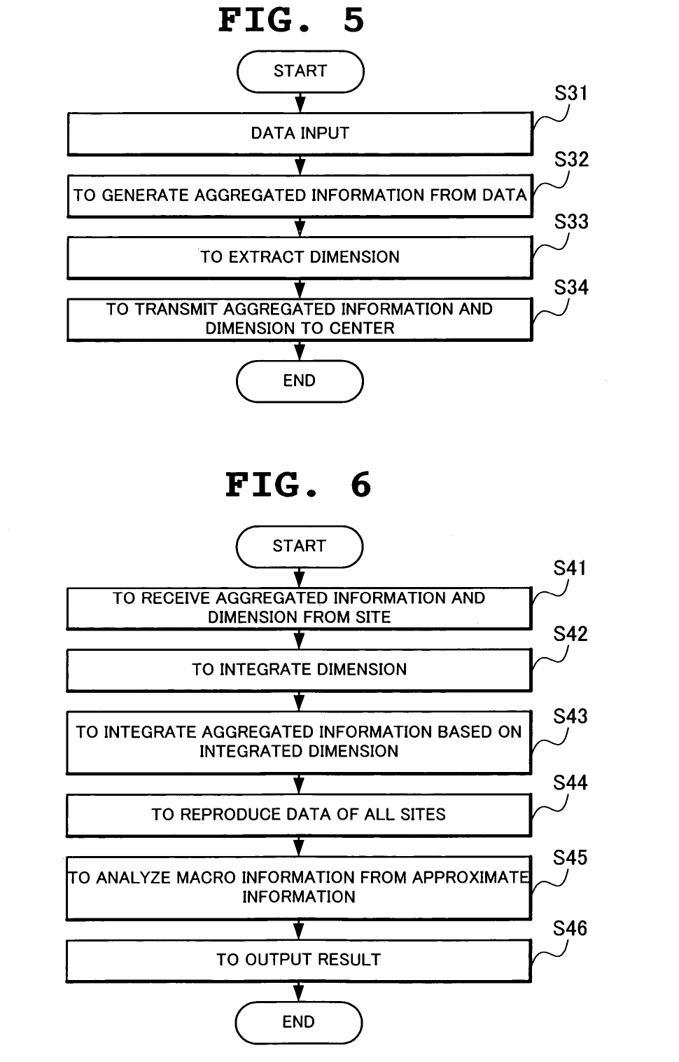

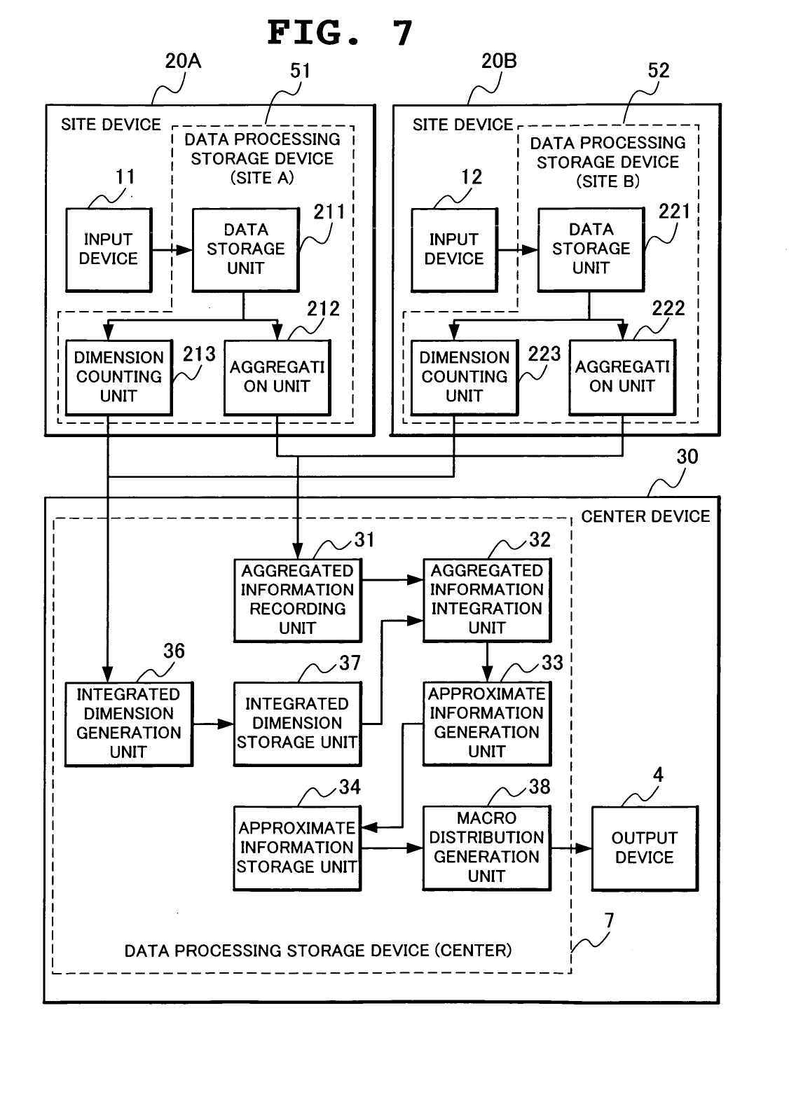

Next, operation will be described. FIG. 5 is a flow chart showing another example of processing of generating aggregated information and transmitting the same to the center device 30 by the site devices 20A and 20B (the input devices 11 and 12 and the data processing storage devices (sites) 51 and 52). FIG. 6 is a flow chart showing another example of processing of generating macro information by the center device 30 (the data processing storage device (center) 6 and the output device 4).

In the first mode of implementation, even when there exists heterogeneousness such as difference in dimension of data sets of data accumulated by the respective sites (difference in nature of data accumulated by the respective sites), data is handled as an individual dimension. In other words, in the first mode of implementation, macro information is generated without considering a difference in nature of data accumulated by the respective sites. In the present mode of implementation, even when there exists such heterogeneousness of a dimension in data accumulated by the respective sites, the macro information generation system integrates dimensions while eliminating the heterogeneousness of dimensions to generate macro information.

The data processing storage device 21 and 22 receive input of various data according to the same processing as that of Steps S11 and S12 shown in the first mode of implementation (Step S31) to generate aggregated information (Step S32). The dimension counting units 213 and 223 of the data processing storage device 21 and 22 count (extract) a dimension of data aggregated in the site at predetermined timing to generate dimension information (Step S33). When the data is text data, for example, the dimension counting units 213 and 223 extract a vocabulary appearing in the text to generate dimension information containing the extracted vocabulary. When the data is category data, fore example, the dimension counting units 213 and 223 extract a category used in the data to generate dimension information containing the extracted category.

The aggregation 212 and 222 transmit information aggregated (aggregated information) to the center device 30 through the communication network. The dimension counting units 213 and 223 transmit dimension information indicative of an extracted dimension to the data processing storage device (center) 6 through the communication network (Step S34). The dimension counting units 213 and 223 may transmit dimension information to the data processing storage device (center) 6 at different timing from timing of transmitting aggregated information by the aggregation 212 and 222.

The integrated information recording unit 31 of the data processing storage device (center) 6 receives and records aggregated information from the respective data processing storage devices (sites) 51 and 52 through the communication network. The integrated dimension generation unit 36 of the data processing storage device 6 receives dimension information from the data processing storage devices 51 and 52, respectively, through the communication network (Step S41 ). The integrated dimension generation unit 36 also stores each dimension information received once in the storage device.

The integrated dimension generation unit 36 integrates dimensions having heterogeneousness which are transmitted from the respective sites to generate an integrated dimension. In this case, the integrated dimension generation unit 36 extracts the dimension information once stored by the storage device to generate integrated dimension information by using a predetermined integration method (Step S42 ). Then, the integrated dimension generation unit 36 causes the integrated dimension storage unit 37 to store the generated integrated dimension information.

The integrated dimension generation unit 36 stores in advance in the storage device a synonym dictionary containing synonyms or a user dictionary defined by a user. In this case, when data is text, the integrated dimension generation unit 36 generates an integrated dimension while considering a difference in expression between sites or an expression differing due to variation of denotation or the like as an expression of the same dimension by using the synonym dictionary containing synonyms or the user dictionary defined by a user. The integrated dimension generation unit 36 considers “PC” and “personal computer” as expressions of the same significance by using the synonym dictionary to generate integrated dimension information.

The aggregated information integration unit 32 integrates aggregated information which is accumulated by the aggregated information recording unit 31 based on the integrated dimension (integrated dimension information) stored by the integrated dimension storage unit 37 at predetermined timing (Step S43). In this case, the aggregated information integration unit 32, for example, generates integrated aggregated information with a synonym contained in each aggregated information as the same expression based on the integrated dimension information.

When the integrated aggregated information is generated, the approximate information generation unit 33 generates approximate information according to the same processing as that of Step S23 shown in the first mode of implementation (Step S44 ). The analysis unit 35 generates macro information according to the same processing as that of Step S24 shown in the first mode of implementation (Step S45 ). The analysis unit 35 also causes the output device 4 to output macro information according to the same processing as that of Step S25 shown in first mode of implementation (Step S46).

As described in the foregoing, according to the present mode of implementation, each site device transmits dimension information in addition to aggregated information to the center device. Then, the center device generates macro information based on dimension information in addition to aggregated information. Since data analysis can be executed taking a dimension of accumulated data into consideration, even when data accumulated by each site device has heterogeneousness, macro information can be generated by integrating dimensions between data. It is accordingly possible to generate macro information with respect to heterogeneous data accumulated in distribution.

(Third Mode of Implementation)

Next, a third mode of implementation of the present invention will be described with reference to the drawings. FIG. 7 is a block diagram showing a still further example of a structure of the macro information generation system. As shown in FIG. 7, the present mode of implementation differs from the second mode of implementation in that a data processing storage device (center) 7 includes, in place of the analysis unit 35 of the data processing storage device (center) 6 shown in FIG. 4, a macro distribution generation unit 38 for predicting a distribution from information which reproduces site data.

The macro distribution generation unit 38 is specifically realized by a CPU of an information processing device operable according to a program. The macro distribution generation unit 38 predicts a probability distribution of information elements contained in data accumulated by each site (hereinafter also referred to as a macro distribution) by using information stored by the approximate information storage unit 34 (approximate information which reproduces data of all the sites). When accumulated data is text data, for example, the macro distribution generation unit 38 obtains a probability distribution of each vocabulary contained in the data (a distribution of a probability of each vocabulary appearing in the data). In the present mode of implementation, the macro distribution generation unit 38 generates a probability distribution as macro information. In addition, the macro distribution generation unit 38 has a function of causing the output device 4 to output an obtained macro distribution.

In the present mode of implementation, the functions of the site devices 20A and 20B are the same as those of the site devices 20A and 20B shown in the second mode of implementation. In addition, the functions of the respective components of the center device 30 other than the macro distribution generation unit 38 are the same as those of their counterparts shown in the second mode of implementation.

Next, operation will be described. In the present mode of implementation, the site devices 20A and 20B generate aggregated information and dimension information to transmit the same to the center device 30 according to the same processing as that of Step S31 to Step S34 shown in the second mode of implementation.

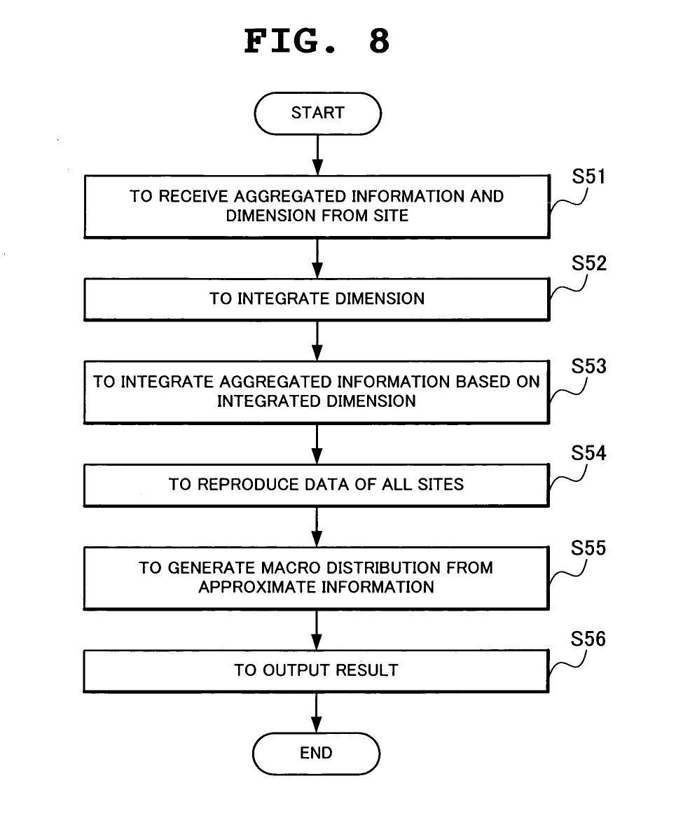

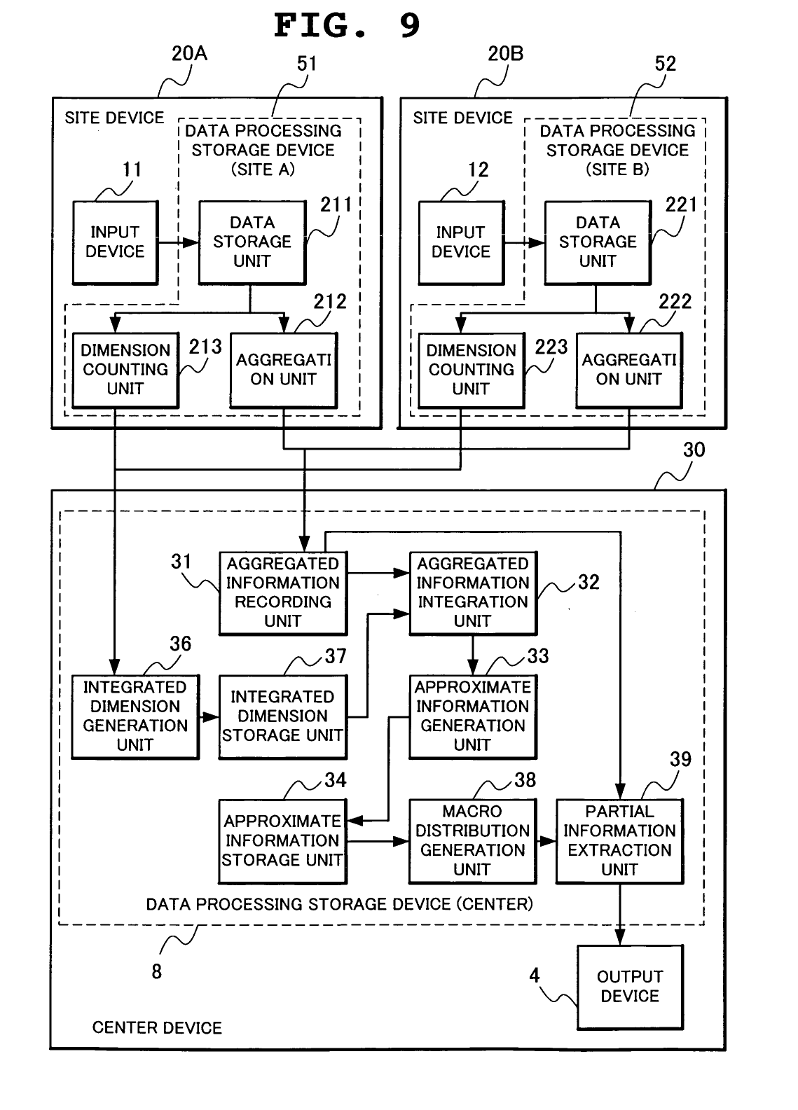

FIG. 8 is a flow chart showing a further example of processing of generating macro information by the center device 30 (the data processing storage device (center) 7 and the output device 4). The center device 30 generates integrated dimension information and integrated aggregated information according to the same processing as that of Step S41 to S44 shown in the second mode of implementation (Step S51 to Step S53) to generate approximate information which reproduces data accumulated by all the sites (Step S54).

The macro distribution generation unit 38 extracts approximate information from the approximate information storage unit 34 to obtain a macro distribution based on the extracted approximate information (Step S55). The macro distribution generation unit 38, for example, obtains a probability distribution of information contained in the data accumulated by each site as a macro distribution. In the first mode of implementation and the second mode of implementation, macro information generated from approximate information is not specifically limited. In the present mode of implementation, the macro distribution generation unit 38 estimates a probability distribution as macro information according to the approximate information stored in the approximate information storage unit 35.

Then, the macro distribution generation unit 38 causes the output device 4 to output the obtained macro distribution (Step S56). In this case, the output device 4 displays or prints the macro distribution according to an instruction of the macro distribution generation unit 38.

(Fourth Mode of Implementation)

Next, a fourth mode of implementation of the present invention will be described with reference to the drawings. FIG. 9 is a block diagram showing a still further example of a structure of the macro information generation system. As shown in FIG. 9, the present mode of implementation differs from the third mode of implementation in that a data processing storage device (center) 8 includes, in addition to the components of the data processing storage device (center) 7 shown in FIG. 7, a partial information extraction unit 39 for converting macro information or aggregated information of a site into information easy to grasp for a user.

The partial information extraction unit 39 is specifically realized by a CPU of an information processing device operable according to a program. The partial information extraction unit 39 has a function of extracting partial information from a macro distribution generated by the macro distribution generation unit 38 or information indicative of a distribution which is transmitted as aggregated information from the site according to a predetermined extraction condition. The partial information extraction unit 39 also has a function of converting extracted partial information into information easy to understand and valuable for a user (data form) according to a predetermined data conversion algorithm. The partial information extraction unit 39 further has a function of causing the output device 4 to output converted partial information.

In the present mode of implementation, the functions of the site devices 20A and 20B are the same as the functions of the site devices 20A and 20B shown in the second mode of implementation and in the third mode of implementation. The functions of the components in the center device 30 other than the partial information extraction unit 39 are the same as those of their counterparts shown in the third mode of implementation.

Next, operation will be described. In the present mode of implementation, the site devices 20A and 20B generate aggregated information and dimension information and transmit the same to the center device 30 according to the same processing as that of Step 31 to Step 34 shown in the second mode of implementation.

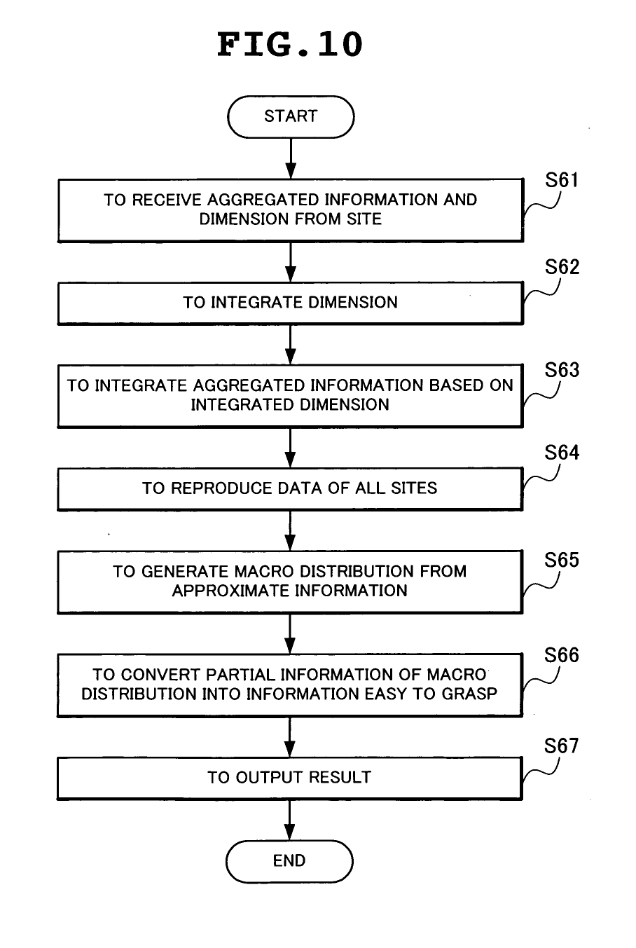

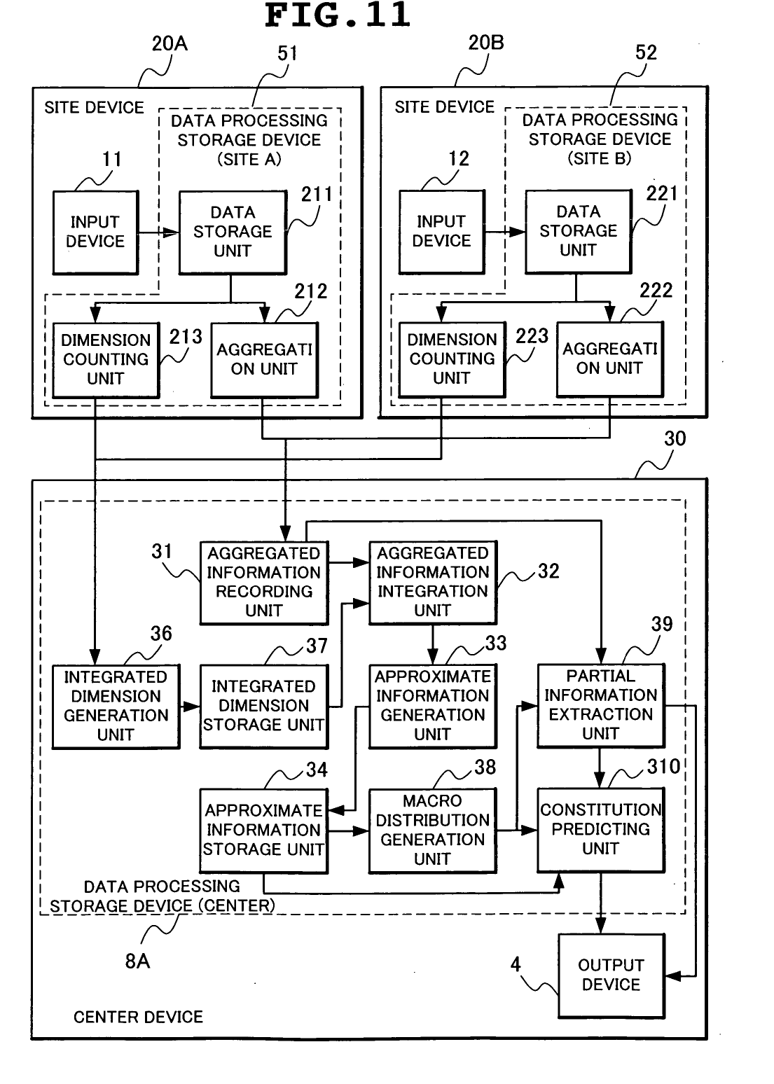

FIG. 10 is a flow chart showing a still further example of processing of generating macro information by the center device 30 (the data processing storage device (center) 8 and the output device 4). The center device 30 generates integrated dimension information and integrated aggregated information according to the same processing as that of Step S51 to S54 shown in the third mode of implementation (Step S61 to Step S63 to generate approximate information which reproduces data accumulated by all the sites (Step S64). The center device 30 also obtains a macro distribution according to the same processing as that of Step S55 shown in the third mode of implementation (Step S65).

The partial information extraction unit 39 extracts partial information from a macro distribution or aggregated information to convert the extracted partial information into information of a form easy to recognize for a user according to a predetermined algorithm (Step S66). In the third mode of implementation, the description has been made of a case where as macro information, only a distribution of all the site data is estimated from approximate information and no processing of converting the macro distribution into a form easy to grasp for a user is executed. In the present mode of implementation, the partial information extraction unit 39 extracts partial information from a macro distribution or aggregated information to convert the extracted information into information of a form easy to understand for a user.

The partial information extraction unit 39, for example, converts partial features of a macro distribution or partial activeness into numerical information and presents the information to a user. The partial information extraction unit 39 also extracts partial information from a distribution transmitted as aggregated information to the center to convert the information into a form easy to understand for a user.

Then, the partial information extraction unit 39 causes the output device 4 to output the converted partial information (Step S67). In this case, the output device 4 displays or prints the converted partial information according to an instruction of the partial information extraction unit 39.

As described in the foregoing, according to the present mode of implementation, the center device is allowed to reproduce the contents of data of all the sites and obtain aggregated information from each site device as well. This enables the center device to combine these two kinds of information (reproduction data and aggregated information) to present information in a data form easy to understand to a user. As a result, generated macro information can be converted into information of a data form easy to understand and valuable for a user and presented to the user. For example, even when the generated macro information is of a data form hard to understand for a user, it can be converted into information of a data form easy to understand and valuable for a user and presented.

(Fifth Mode of Implementation)

Next, a fifth mode of implementation of the present invention will be described with reference to the drawings. FIG. 11 is a block diagram showing a still further example of a structure of the macro information generation system. As shown in FIG. 11, the present mode of implementation differs from the fourth mode of implementation in that a data processing storage device (center) 8A includes, in addition to the components of the data processing storage device (center) 8 shown in FIG. 9, a constitution predicting unit 310 for converting a corresponding relationship between a macro distribution and a site into information of a form easy to grasp for a user.

The constitution predicting unit 310 is specifically realized by a CPU of an information processing device operable according to a program. The constitution predicting unit 310 has a function of obtaining a corresponding relationship between a macro distribution generated by the macro distribution generation unit 38 and each site or partial information indicative of a distribution of information contained in each site. The constitution predicting unit 310 also has a function of converting information indicative of an obtained corresponding relationship into information of a form easy to grasp for a user according to a predetermined algorithm. The constitution predicting unit 310 further has a function of causing the output device 4 to output converted information (information indicative of a corresponding relationship between a macro distribution and partial information).

In the present mode of implementation, the functions of the site devices 20A and 20B are the same as the functions of the site devices 20A and 20B shown in the second mode of implementation to the fourth mode of implementation. The functions of the components in the center device 30 other than the constitution predicting unit 310 are the same as those of their counterparts shown in the fourth mode of implementation.

Next, operation will be described. In the present mode of implementation, the site devices 20A and 20B generate aggregated information and dimension information to transmit the same to the center device 30 according to the same processing as that of Step S31 to Step S34 shown in the second mode of implementation.

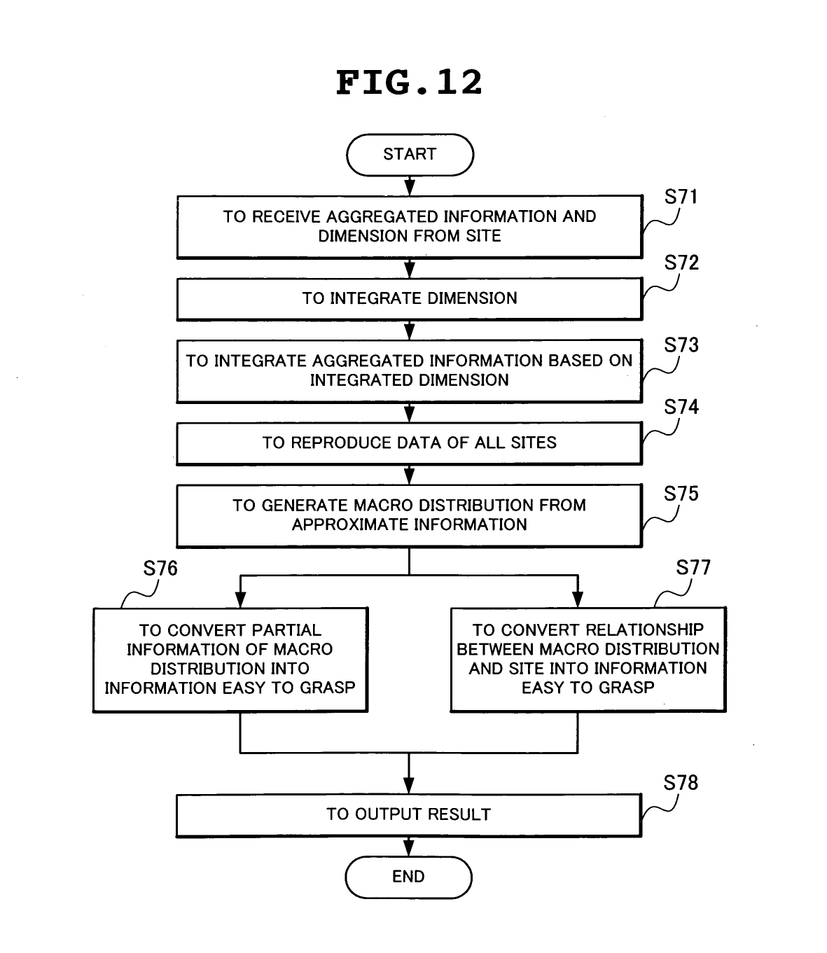

FIG. 12 is a flow chart showing a still further example of processing of generating macro information by the center device 30 (the data processing storage device (center) 9 and the output device 4). The center device 30 generates integrated dimension information and integrated aggregated information according to the same processing as that of Step S61 to S64 shown in the fourth mode of implementation (Step S71 to Step S73) to generate approximate information which reproduces data accumulated by all the sites (Step S74). The center device 30 obtains a macro distribution according to the same processing as that of Step S65 shown in the fourth mode of implementation (Step S75). The center device 30 extracts partial information from the macro distribution or aggregated information to convert the extracted partial information into information of a form easy to recognize for a user according to the same processing as that of Step S66 shown in the fourth mode of implementation (Step S76).

The constitution predicting unit 310 converts a corresponding relationship between the macro distribution and the partial information into information of a form easy to grasp for a user according to a predetermined algorithm (Step S77). In the fourth mode of implementation, executed is only the conversion of macro information and information accumulated by the sites into information of a form easy to grasp for a user but not presentation of information indicative of a corresponding relationship between the macro information and information accumulated by the sites to a user. In the present mode of implementation, the constitution predicting unit 310 converts information which correlates macro information and information accumulated by each site into information of a form easy to grasp for a user and presents the obtained information to a user. The constitution predicting unit 310, for example, generates information indicating to what extent partial information of macro information contributes to each site or to partial information of each site and presents the generated information in a form easy to understand to a user.

Then, the constitution predicting unit 310 causes the output device 4 to output the partial information converted at Step S76 and information converted at Step S77 (information indicative of a corresponding relationship between macro information and information accumulated by each site) (Step S78). In this case, the output device 4 displays or prints the converted partial information according to an instruction of the partial information extraction unit 39. In addition, the output device 4 displays or prints information converted according to an instruction of the constitution predicting unit 310.

As described in the foregoing, according to the present mode of implementation, a corresponding relationship between a macro distribution and partial information indicative of a distribution of information of each site is obtained and converted into information of a form easy to grasp for a user. It is accordingly possible to present macro information easy to grasp and significant to a user.

(Sixth Mode of Implementation)

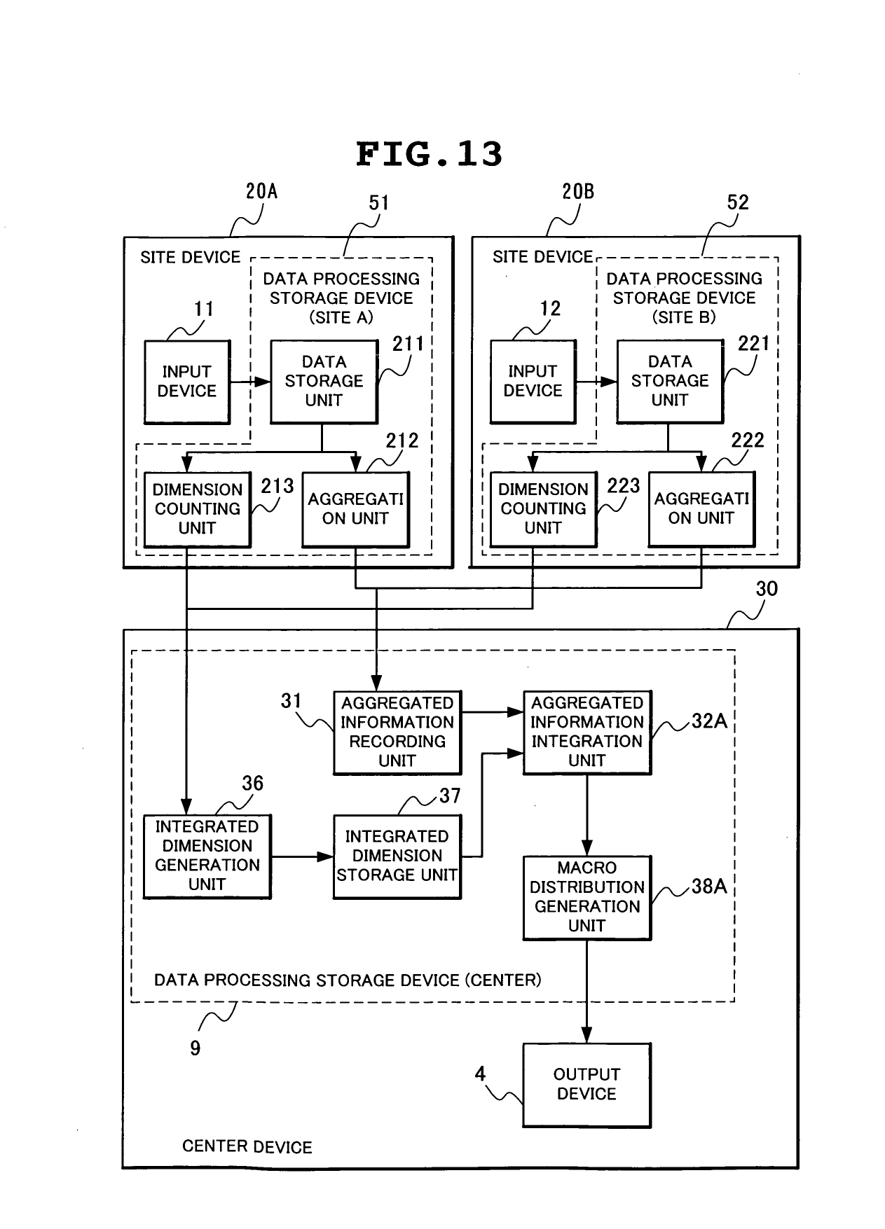

Next, a sixth mode of implementation of the present invention will be described with reference to the drawings. FIG. 13 is a block diagram showing a still further example of a structure of the macro information generation system. As shown in FIG. 13, the present mode of implementation differs from the third mode of implementation in that a data processing storage device (center) 9 fails to include, among the components of the data processing storage device (center) 8 shown in FIG. 7, the approximate information generation unit 33 and the approximate information storage unit 34. In the present mode of implementation, an aggregated information integration unit 32A differs from the aggregated information integration unit 32 shown in the third mode of implementation in directly outputting aggregated information (integrated aggregated information) to the macro distribution generation unit 38. Moreover, in the present mode of implementation, a macro distribution generation unit 38A differs from the macro distribution generation unit 38 shown in the third mode of implementation in obtaining a macro distribution from integrated aggregated information.

In the present mode of implementation, the functions of the site devices 20A and 20B are the same as the functions of the site devices 20A and 20B shown in the second mode of implementation and the third mode of implementation. The functions of the components of the center device 30 other than the aggregated information integration unit 32A are the same as those of their counterparts shown in the third mode of implementation.

Next, operation will be described. In the present mode of implementation, the site devices 20A and 20B generate aggregated information and dimension information to transmit the same to the center device 30 according to the same processing as that of Step S31 to Step S34 shown in the second mode of implementation.

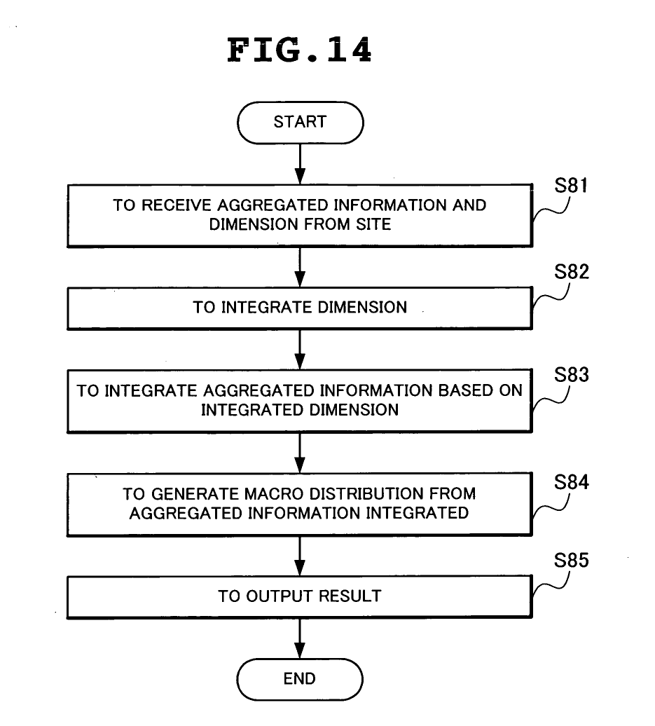

FIG. 14 is a flow chart showing a still further example of processing of generating macro information by the center device 30 (the data processing storage device (center) 9 and the output device 4). The center device 30 generates integrated dimension information and integrated aggregated information according to the same processing as that of Step S51 to S53 shown in the third mode of implementation (Step S81 to Step S83).

The macro distribution generation unit 38A obtains a macro distribution based on integrated aggregated information which is integrated by the aggregated information integration unit 32A (Step S84). In the third mode of implementation, the description has been made of a case where for analyzing macro information, approximate information which reproduces data in the site is once generated and analysis is executed by using the generated approximate information. In the present mode of implementation, the macro distribution generation unit 38A obtains a macro distribution by shortening an inter-distribution distance between a macro distribution obtained by the center device 30 and a distribution of information contained in the integrated aggregated information which is generated by the aggregated information integration unit 32A while changing the macro distribution. In this case, the macro distribution generation unit 38A obtains, as macro information, a macro distribution obtained when an inter-distribution distance is the minimum.

Then, the macro distribution generation unit 38A causes the output device 4 to output the obtained macro distribution (Step S56 ). In this case, the output device 4 displays or prints the macro distribution according to an instruction of the macro distribution generation unit 38A.

As described in the foregoing, according to the present mode of implementation, the center device is allowed to generate macro information only by transmission of aggregated information to the center device by each site device. It is accordingly possible to generate macro information without concentrating raw data as data itself which is accumulated by each site on one place.

(Seventh Mode of Implementation)

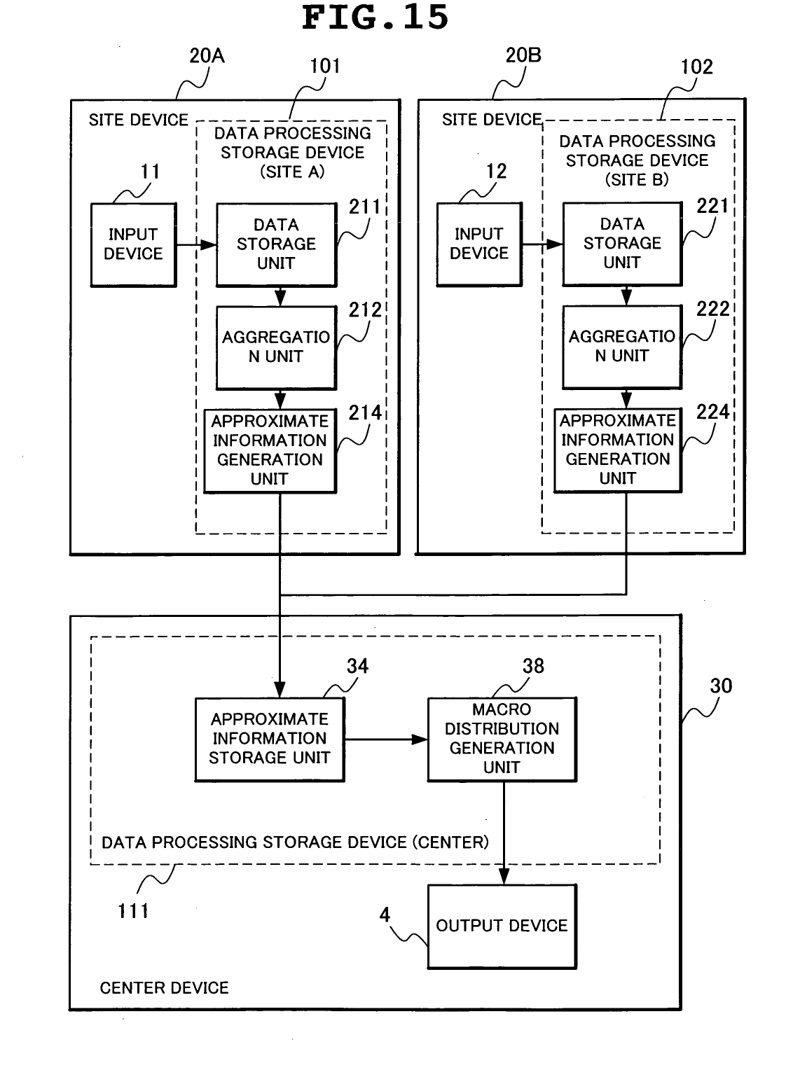

Next, a seventh mode of implementation of the present invention will be described with reference to the drawings. FIG. 15 is a block diagram showing a still further example of a structure of the macro information generation system. As shown in FIG. 15, the present mode of implementation differs from the third mode of implementation in that data processing storage devices (sites) 101 and 102 fail to include, among the components of the data processing storage devices (sites) 51 and 52 shown in FIG. 7, the dimension counting units 213 and 223. The present mode of implementation also differs from the third mode of implementation in that the data processing storage devices 101 and 102 include, in addition to the components of the data processing storage devices 51 and 52 shown in FIG. 7, approximate information generation units 214 and 224.

The present mode of implementation further differs from the third mode of implementation in that a data processing storage device (center) 111 fails to include, among the components of the data processing storage device (center) 9 shown in FIG. 7, the aggregated information recording unit 31, the aggregated information integration unit 32, the approximate information generation unit 33, the integrated dimension generation unit 36 and the integrated dimension storage unit 37.

The approximate information generation units 214 and 224 are specifically realized by a CPU of an information processing terminal operable according to a program and a network interface unit. The approximate information generation units 214 and 224 have a function of generating approximate information based on aggregated information which is generated by the aggregation units 212 and 222 according to the same processing as that of the approximate information generation unit 33 shown in FIG. 7. The approximate information generation units 214 and 224 also have a function of transmitting generated approximate information to the center device 30 through the communication network.

In the present mode of implementation, the functions of the components in the site devices 20A and 20B other than the approximate information generation units 214 and 224 are the same as the functions of their counterparts shown in the first mode of implementation to the third mode of implementation. The functions of the approximate information storage unit 34 and the macro distribution generation unit 38 of the center device 30 are the same as the functions of their counterparts shown in the third mode of implementation.

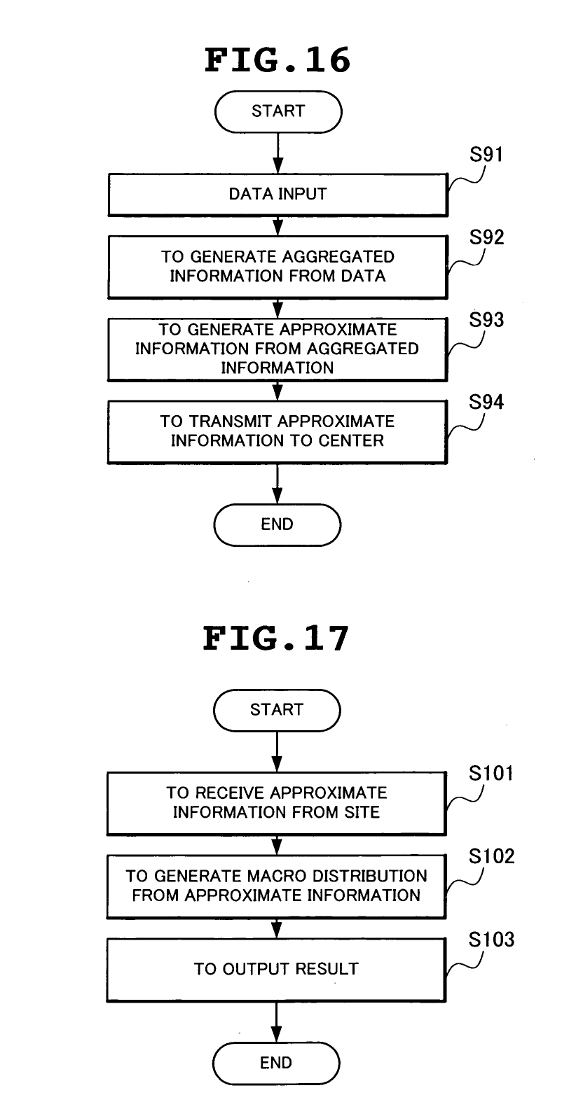

Next, operation will be described. FIG. 16 is a flow chart showing an example of processing of generating approximate information and transmitting the same to the center device 30 by the site devices 20A and 20B (the input devices 11 and 12 and the data processing storage devices (sites) 101 and 102). FIG. 17 is a flow chart showing a still further example of processing of generating macro information by the center device 30 (the data processing storage device (center) 111 and the output device 4).

The data processing storage devices 101 and 102 receive input of various kinds of data (Step S91) to generate aggregated information according to the same processing as that of Steps S11 to S12 shown in the first mode of implementation (Step S92). The approximate information generation units 214 and 224 generate approximate information which reproduces data accumulated by the data storage units 211 and 221 based on the aggregated information which is generated by the aggregation 212 and 222 (Step S93). Then, the approximate information generation units 214 and 224 transmit the generated approximate information to the center device 30 through the communication network (Step S94).

The data processing storage device 111 of the center device 30 receives the approximate information from the site devices 20A and 20B through the communication network (Step S101). The data processing storage device 111 also causes the approximate information storage unit 34 to store the received approximate information. In addition, the macro distribution generation unit 38 obtains a macro distribution based on the approximate information stored in the approximate information storage unit 34 (Step S102). Then, the macro distribution generation unit 38 causes the output device 4 to output the obtained macro distribution (Step S103).

The third mode of implementation has been described with respect to a case where the center device 30 integrates aggregated information to generate approximate information which reproduces data accumulated by the site. In the present mode of implementation, each of the site devices 20A and 20B generate approximate information based on aggregated information. Then, transmission of the approximate information generated by the respective site devices 20A and 20B to the center device 30 results in storing the approximate information in the approximate information storage unit 34 of the center device 30.

As described in the foregoing, according to the present embodiment, the center device is allowed to generate macro information only by transmission of approximate information to the center device by each site device. It is accordingly possible to generate macro information without concentrating raw data as data itself which is accumulated by each site on one place.

(Eighth Mode of Implementation)

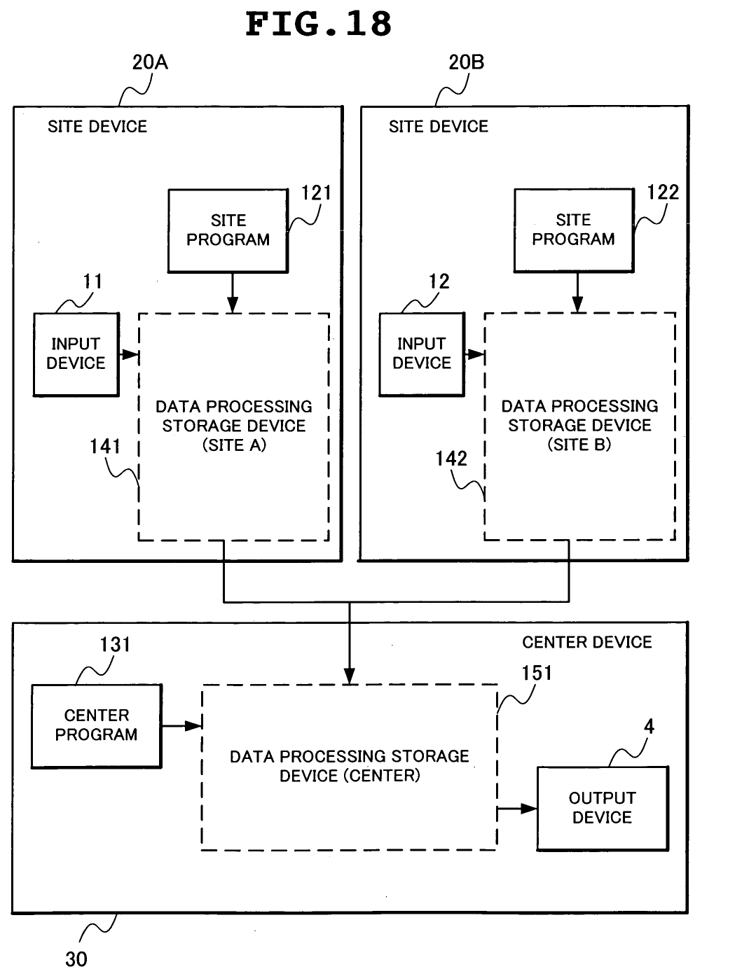

Next, an eighth mode of implementation of the present invention will be described with reference to the drawings. FIG. 18 is a block diagram showing a still further example of a structure of the macro information generation system. As shown in FIG. 18, in the present mode of implementation, the macro information generation system includes the site devices 20A and 20B and the center device 30 similarly to the first mode of implementation to the seventh mode of implementation. In addition, the site devices 20A and 20B include the input devices 11 and 12 and data processing storage devices (sites) 141 and 142. The center device 30 includes a data processing storage device (center) 151 and the output device 4.

In the present mode of implementation, the data processing storage devices 141 and 142 read site programs 121 and 122 stored by a storage medium (e.g. CD-ROM) to execute processing according to the read site programs 121 and 122. The site programs 121 and 122 are programs which are read into the data processing storage devices (sites) 141 and 142 to control operation of the data processing storage devices (sites) 141 and 142. In the present mode of implementation, the data processing storage devices 141 and 142 execute the processing according to the site programs 121 and 122 to generate dimension information, aggregated information and approximate information and transmit the same to the data processing storage device (center) 151.

By executing control according to the site programs 121 and 122, the data processing storage devices (sites) 141 and 142 execute the same processing as that of any of the data processing storage devices (sites) 21, 22, 51, 52, 101 and 102 shown in the first mode of implementation to the seventh mode of implementation.

The data processing storage devices 141 and 142 read as the site programs 121 and 122, for example, an accumulated data processing generation program for causing a computer to execute aggregated information generation processing of generating aggregated information which is obtained by aggregating data accumulated by a data accumulation unit by a predetermined method, data reproduction processing of generating reproduction data which reproduces the contents of the data accumulated by the data accumulation unit based on aggregated information generated, and reproduction data transmission processing of transmitting generated reproduction data to a data processing device which processes data accumulated by each data accumulation device through a communication network, thereby generating aggregated information or approximate information.

In addition, in the present mode of implementation, the data processing storage device 151 reads a center program 131 stored by a storage medium (e.g. CD-ROM) to execute processing according to the read center program 131. The center program 131 is a program which is read into the data processing storage device (center) 151 to control operation of the data processing storage device (center) 151. In the present mode of implementation, by executing the processing according to the center program 131, the data processing storage device 151 generates macro information and causes the output device 4 to output the information.

By executing control according to the center program 131, the data processing storage device (center) 151 executes the same processing as that of any of the data processing storage devices (centers) 3, 6, 7, 8, 9 and 111 shown in the first mode of implementation to the seventh mode of implementation.

The data processing storage device 151 reads as the center program 131, for example, a macro information generation program for causing a computer to execute aggregated information receiving processing of receiving aggregated information which is obtained, by a predetermined method, by aggregating data accumulated by a plurality of data accumulation devices which accumulate data through a communication network, data reproduction processing of generating reproduction data which reproduces the contents of data accumulated by each data accumulation device based on aggregated information received, and macro information generation processing of analyzing generated reproduction data to generate macro information, thereby generating macro information.

While the first mode of implementation to the eighth mode of implementation have been described with respect to a case where two site devices 20A and 20B (the input device and the data processing storage device (site)) are used, the number of site devices 20A and 20B (the input device and the data processing storage device (site)) is not limited to two. The macro information generation system may include three or more site devices.

(Ninth Mode of Implementation)

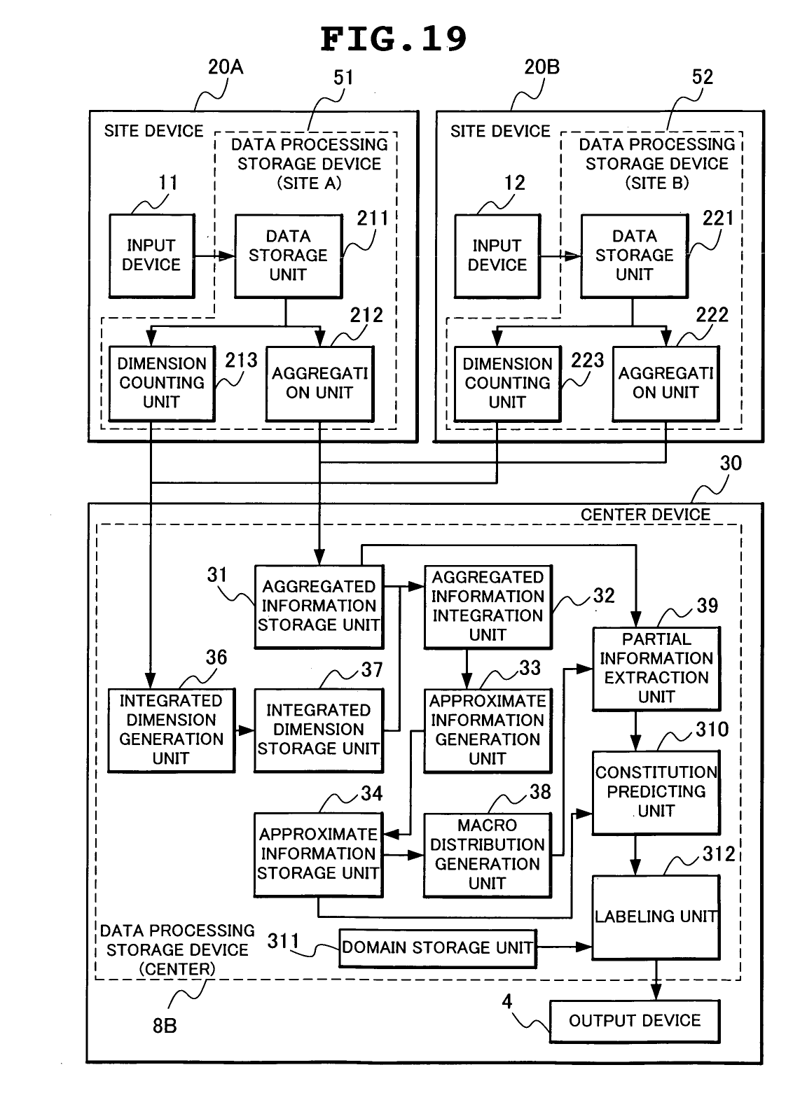

Next, a ninth mode of implementation of the present invention will be described with reference to the drawings. FIG. 19 is a block diagram showing a still further example of a structure of the macro information generation system. As shown in FIG. 19, the present mode of implementation differs from the fifth mode of implementation in that a data processing storage device (center) 8B includes, in addition to the components of the data processing storage device 8A shown in FIG. 11, a domain storage unit 311 for storing information (dictionary in this example) in which a name such as a product name or a technique name and its technical domain are described, and a labeling unit 312 for applying a label easier to understand for a user to macro information or aggregated information of a site by using information stored by the domain storage unit 311.

The domain storage unit 311 is specifically realized by a storage device such as a magnetic disk device or an optical disk device. The domain storage unit 311 stores a dictionary in which names such as a product name and a technique name used in each company or organization and a technical domain (e.g. a technical region to which a product or a technique belongs) related to its product name or technique name are correlated with each other.

The labeling unit 312 is specifically realized by a CPU of an information processing device operable according to a program. The labeling unit 312 has a function of converting partial information generated by the partial information extraction unit 39 (partial information which is generated from macro information or aggregated information of a site) into information of a form easier to grasp for a user. In this case, the labeling unit 312 executes predetermined labeling processing based on a domain dictionary stored by the domain storage unit 311. In the present mode of implementation, the labeling unit 312 applies a predetermined label to partial information by using the dictionary stored by the domain storage unit 311. The labeling unit 312 further has a function of causing the output device 4 to output the partial information with a label applied. The labeling unit 312, for example, extracts a technical domain corresponding to the partial information from the domain dictionary to apply (add) the extracted technical domain as label information to partial information.

In the present mode of implementation, the functions of the components in the site devices 20A and 20B are the same as those of the site devices 20A and 20B shown in the second mode of implementation and the third mode of implementation. The functions of the respective components of the center device 30 other than the domain storage unit 311 and the labeling unit 312 are the same as those shown in the fifth mode of implementation.

Next, operation will be described. In the present mode of implementation, the site devices 20A and 20B generate aggregated information and dimension information to transmit the same to the center device 30 according to the same processing as that of Step S31 to Step S34 shown in the second mode of implementation.

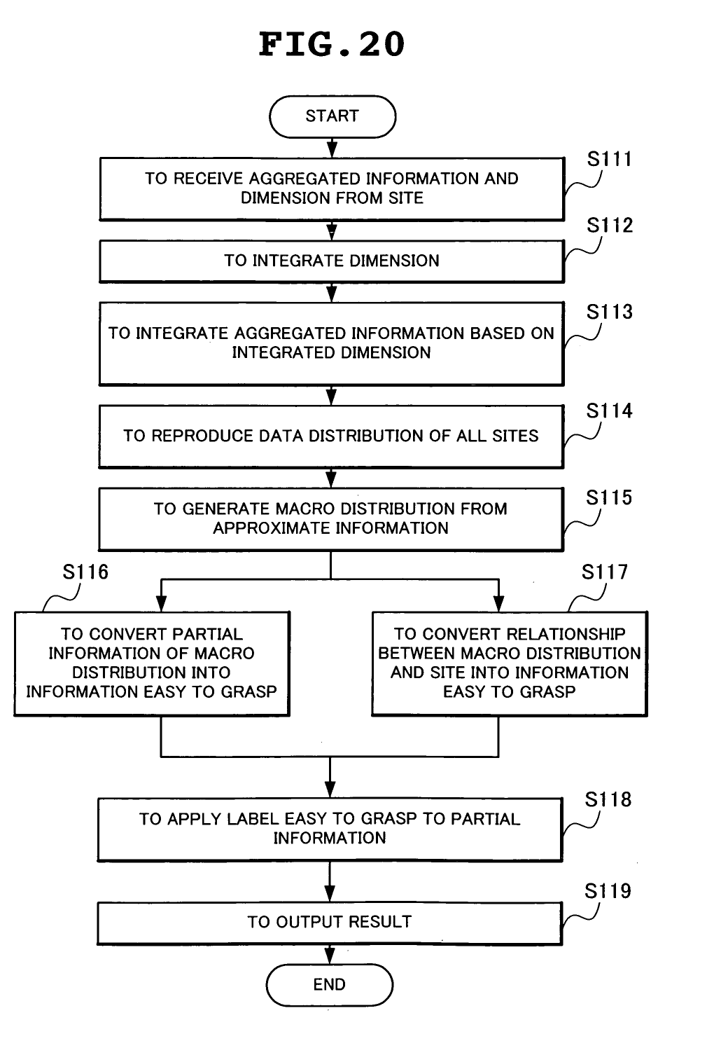

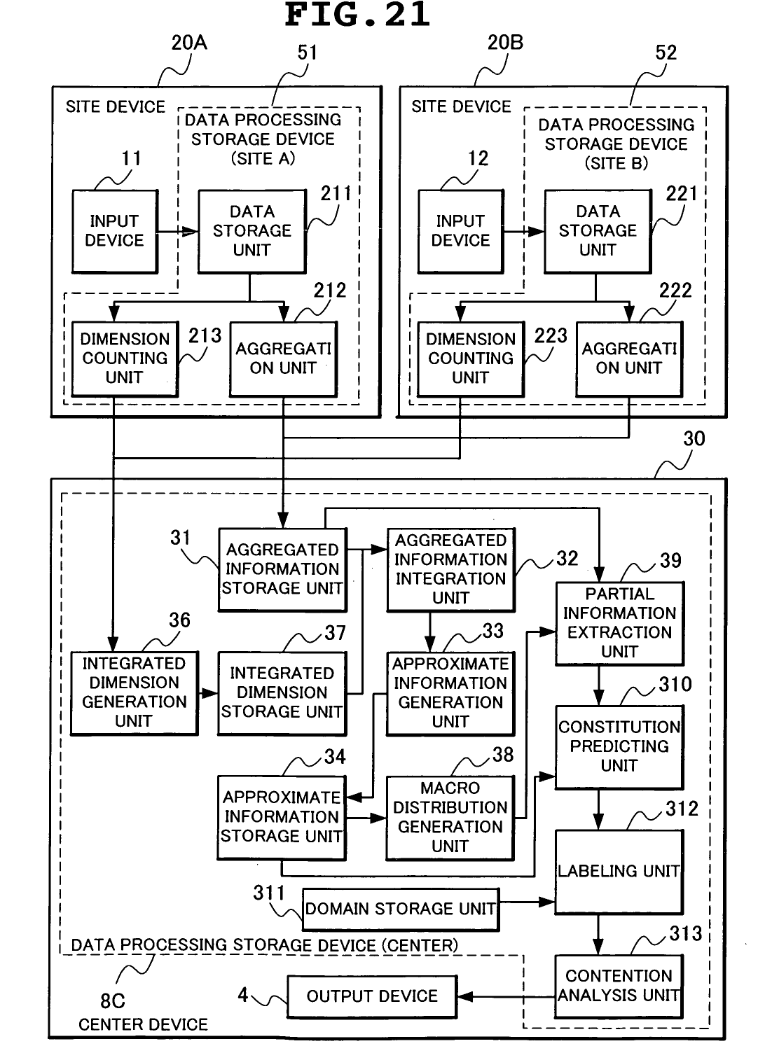

FIG. 20 is a flow chart showing a still further example of processing of generating macro information by the center device 30 (the data processing storage device (center) 8B and the output device 4). The center device 30 generates integrated dimension information and integrated aggregated information according to the same processing as that of Steps S71 to S74 shown in the fifth mode of implementation (Step S111 to Step S113) to generate approximate information which reproduces data accumulated by all the sites (Step S114). The center device 30 obtains a macro distribution according to the same processing as that of Step S75 shown in the fifth mode of implementation (Step S115).

The center device 30 also extracts partial information from a macro distribution or aggregated information to convert the extracted partial information into information of a form easy to recognize for a user according to the same processing as that of Step S76 shown in the fifth mode of implementation (Step S116). In addition, the center device 30 converts a corresponding relationship between a macro distribution and partial information into information of a form easy to grasp for a user according to the same processing as that of Step S77 shown in the fifth mode of implementation (Step S117).

The labeling unit 312 applies a predetermined label to partial information (partial information of macro information or aggregated information of a site). In this case, the labeling unit 312 applies a label of a form easier to grasp for a user according to a predetermined algorithm by using the dictionary stored by the domain storage unit 311 (Step S118).

Executed in the fifth mode of implementation is the processing of converting macro information or information accumulated by the site into information of a form easy to grasp for a user or of a form indicative of a corresponding relationship. In other words, not executed is applying a label represented in a word level easier to understand by using a separate information source (information generated from internal data or external information) and presenting the obtained information to a user. In the present mode of implementation, the labeling unit 312 applies a label represented in a word level easier to understand to partial information of macro information or partial information of aggregated information of each site by using a separate information source (dictionary in this example) to present the obtained information in a form easier to understand to a user.

The labeling unit 312 also applies label information converted at Step S118 to partial information converted at Step S116 or information converted at Step S117 (information indicative of a corresponding relationship between macro information and information accumulated at each site). Then, the labeling unit 312 causes the output device 4 to output the labeled information (partial information or information indicative of a corresponding relationship) (Step S119). In this case, the output device 4 displays or prints the converted information according to an instruction of the labeling unit 312.

As described in the foregoing, according to the present mode of implementation, partial information indicative of a macro distribution and a distribution of information of each site are converted into information easy to grasp for a user by using separate information (dictionary in this example). It is accordingly possible to present macro information easier to grasp and more significant to a user.

(Tenth Mode of Implementation)

Next, a tenth mode of implementation of the present invention will be described with reference to the drawings. FIG. 21 is a block diagram showing a still further example of a structure of the macro information generation system. As shown in FIG. 21, the present mode of implementation differs from the ninth mode of implementation in that a data processing storage device (center) 8C includes, in addition to the components of the data processing storage device 8B shown in FIG. 19, a contention analysis unit 313 for presenting a graph indicative of comparison between respective site information to a user.

The contention analysis unit 313 is specifically realized by a CPU of an information processing device operable according to a program. The contention analysis unit 313 has a function of generating a graph (graph indicative of comparison between the respective site information) for relative comparison between sites. The contention analysis unit 313, for example, generates a radar chart for contention analysis by using a constitution ratio between a topic on the site side and a topic on the center side. The contention analysis unit 313 further has a function of causing the output device 4 to output the graph for representing comparison between the respective site information.

In the present mode of implementation, the functions of the components in the site devices 20A and 20B are the same as those of the site devices 20A and 20B shown in the second mode of implementation and the third mode of implementation. The functions of the respective components of the center device 30 other than the contention analysis unit 313 are the same as those of their counterparts shown in the ninth mode of implementation.

Next, operation will be described. In the present mode of implementation, the site devices 20A and 20B generate aggregated information and dimension information to transmit the same to the center device 30 according to the same processing as that of Step S31 to Step S34 shown in the second mode of implementation.

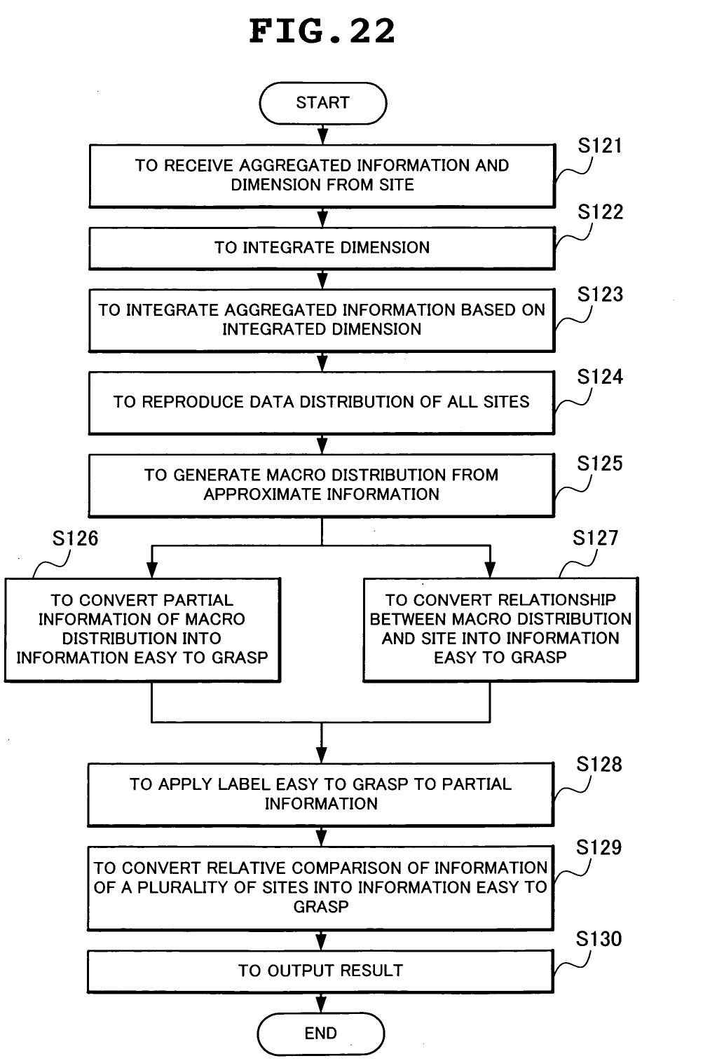

FIG. 22 is a flow chart showing a still further example of processing of generating macro information by the center device 30 (the data processing storage device (center) 8C and the output device 4). The center device 30 generates integrated dimension information and integrated aggregated information according to the same processing as that of Step S111 to Step S114 shown in the ninth mode of implementation (Step S121 to Step S123) to generate approximate information which reproduces data accumulated by all the sites (Step S124). The center device 30 obtains a macro distribution according to the same processing as that of Step S115 shown in the ninth mode of implementation (Step S125).

The center device 30 also extracts partial information from a macro distribution or aggregated information to convert the extracted partial information into information of a form easy to recognize for a user according to the same processing as that of Step S116 shown in the ninth mode of implementation (Step S126). In addition, the center device 30 converts a corresponding relationship between a macro distribution and partial information into information of a form easy to grasp for a user according to the same processing as that of Step S117 shown in the ninth mode of implementation (Step S127).

In addition, the center device 30 applies a label easier to grasp for a user to partial information (partial information of macro information or aggregated information of a site) according to the same processing as that of Step S118 shown in the ninth mode of implementation (Step S128).

The contention analysis unit 313 converts information correlating macro information and information of each site into information of a form which enables a relative comparison to be easily grasped according to a predetermined algorithm (Step S129). In the present mode of implementation, the contention analysis unit 313 generates a graph representing comparison between the respective site information based on the information correlating the macro information and the information of each site.

Executed in the ninth mode of implementation is only the processing of converting macro information or information accumulated by the site into information of a form indicative of a corresponding relationship. In other words, information enabling relative comparison between sites is not presented to a user. In the present mode of implementation, the contention analysis unit 313 presents information enabling relative comparison between sites to be executed with ease in a form easy to understand for a user by using macro information.

Then, the contention analysis unit 313 causes the output device 4 to output the information (graph) indicative of a relative comparison between sites which is converted (generated) at Step S129 (Step S130). In this case, the output device 4 displays or prints the converted information according to an instruction of the contention analysis unit 313.

As described in the foregoing, according to the present mode of implementation, for executing relative comparison between site information, information correlating macro information and information of each site is converted into information easy to understand for a user by using macro information. It is accordingly possible to present information to a user which is necessary for executing relative comparison between sites to support contention analysis and the like.

(First Embodiment)

Next, a first embodiment of the present invention will be described with reference to the drawings. A macro information generation system shown in the present embodiment is equivalent to the macro information generation system shown in the first mode of implementation. In the present embodiment, the macro information generation system includes a keyboard as the input devices 11 and 12 and a personal computer and a magnetic disk storage device as the data processing storage devices (sites) 21 and 22 and the data processing storage device (center) 3, respectively. The macro information generation system also includes a display device as the output device 4.

The personal computer on the site side has a central processor which functions as an aggregation unit. The personal computer on the center side has a central processor which functions as an aggregated information integration unit, an approximate information generation unit and an analysis unit. The magnetic disk storage device on the site side stores data to be analyzed. The magnetic disk storage device on the center side stores aggregated information and approximate information.

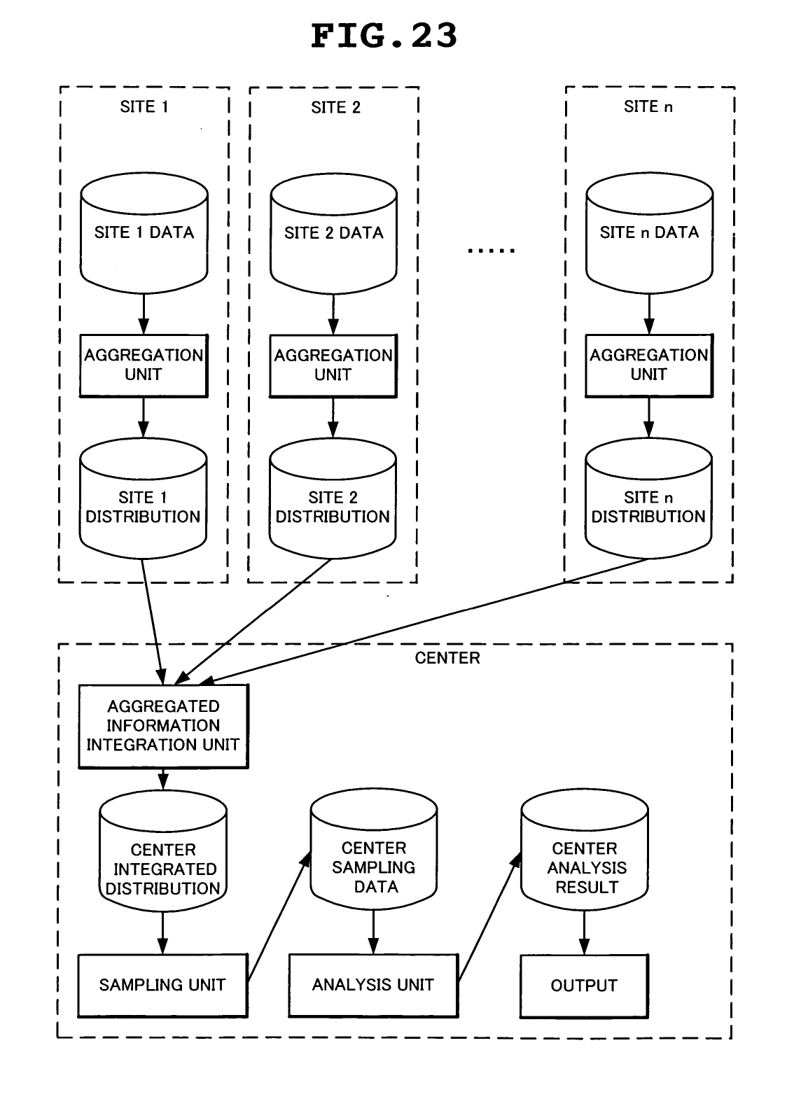

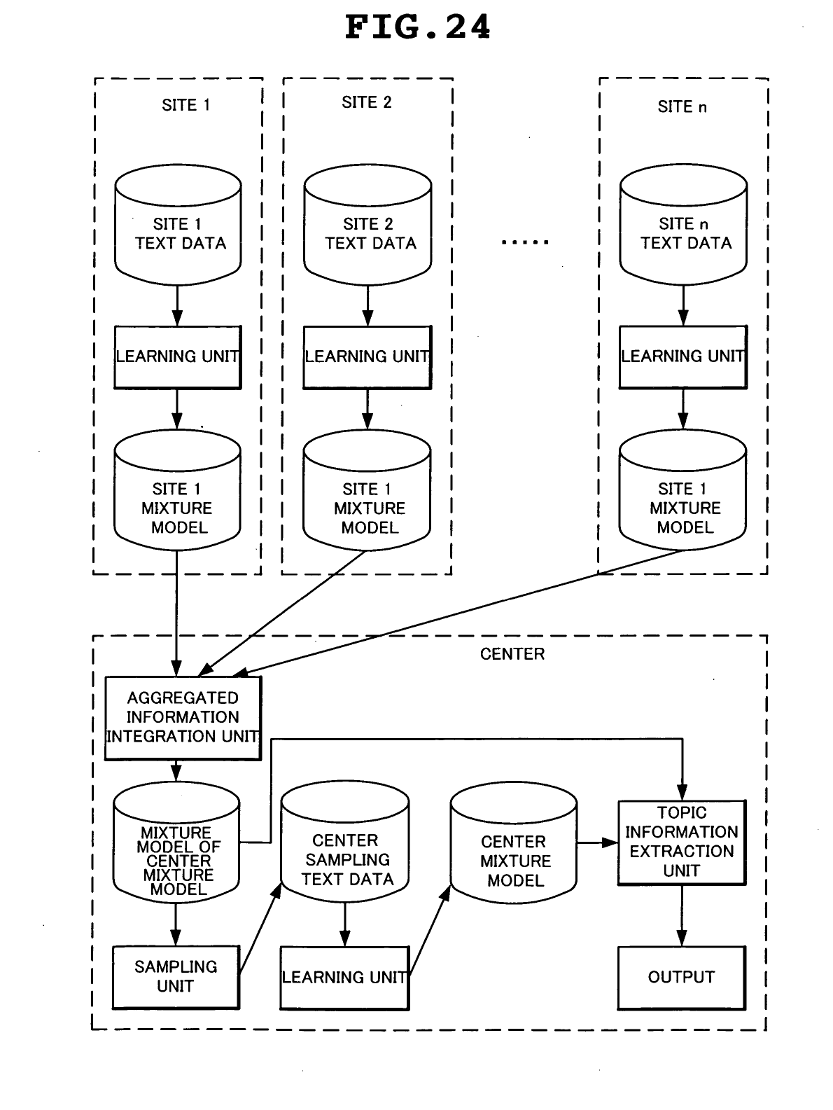

In the present embodiment, data accumulated in a remote site is aggregated and sent to the center. Then, integrating the aggregated information to reproduce data of all the sites from the integrated aggregated information on the center side enables various analyses without concentrating raw data on one place. FIG. 23 is a block diagram showing a specific example of a structure of the macro information generation system. FIG. 23 is equivalent to a further embodied structure of the macro information generation system shown in FIG. 1.

In a plurality of sites, an aggregation unit estimates a distribution of information elements (e.g. vocabulary) contained in data from applied data. Here, a distribution obtained by the aggregation unit represents a probability distribution of information elements contained in data or a quantity of statistics obtained from a value of each dimension.

When data to be analyzed is text, a dimension will be a word appearing in the text. Assume that all the words whose appearance is possible in the text are w1, w2, . . ., wN, one text data can be expressed by a vector (x(w1), x(w2), . . ., x(wN)). x(wi) will have the value “1” when, for example, the word wi appears in the text to be analyzed and the value “0” when the same fails to appear in the text.

The aggregation unit may estimate a distribution by estimating a finite mixture model by using an EM algorithm. The aggregation unit may also simply calculate a parameter of one probability distribution. Alternatively, the aggregation unit may obtain a total sum of the values of the respective dimensions to obtain a quantity of statistics. When estimating one normal distribution from data, the aggregation unit is only required to obtain a parameter such as an expected value or a dispersion for each dimension of the data.

As described in the foregoing, the aggregation unit estimates a distribution of information elements contained in data to be analyzed and transmits a parameter indicative of the obtained distribution as aggregated information to the center. When an estimated distribution is a normal distribution as aggregated information, for example, the aggregation unit transmits an expected value, dispersion, the number of data and a kind of distribution (normal distribution in this example).

In the center, by using a distribution received from each site, the aggregated information integration unit generates an integrated distribution which is obtained by integrating distributions of data accumulated by the respective sites. When a probability distribution is received as aggregated information from each site, for example, the aggregated information integration unit sets up (obtains) a model p′(x|θ′) as a mixture of a probability distribution p1(x|θ1) of each site 1 by using an expression (1). A parameterθ′ of the model p′(x|θ′) as a mixture of the probability distributions will represent integrated aggregated information which is integration of aggregated information.

$${P}^{′} ( χ \vert θ ) = {\sum }_{ι = 1}^{S} {n}_{ι} / N \cdot {p}^{ι} ( χ \vert {θ}^{ι} ) \qquad ( Numerical Expression 1 )$$

In the expression (1), nl is the number of data of the site 1, N represents the number of data of all the sites and s represents the total number of sites. When the quantity of statistics as a total sum of values of the respective dimensions is received as aggregated information from each site, the aggregated information integration unit also in the center obtains a total sum for a dimension indicative of the same significance in each site. The quantity of statistics obtained as the total sum will be equivalent to integrated aggregated information as integration of aggregated information.

Next, a sampling unit (equivalent to the approximate information generation unit) reproduces data accumulated by the site from the aggregated information thus integrated. When the aggregated information is a probability distribution, the sampling unit generates sampling data as approximate information by using a predetermined sampling technique. When the aggregated information is the quantity of statistics totaling the values of dimensions, the sampling unit obtains a value (mean value of a dimension) by dividing the quantity of statistics by the number of data of all the sites. Then, the sampling unit can reproduce data accumulated by the site by random sampling according to the obtained mean value of each dimension.

An analysis unit executes various analyses based on the data sampled by the sampling unit. When the data is text data, the analysis unit, for example, executes topic analysis by using a predetermined clustering technique. The analysis unit is also allowed to estimate a word characteristically appearing in data accumulated by each site by using a predetermined feature word extraction technique. When the data is log data such as system log, the analysis unit analyzes a correlation between systems in a plurality of sites and makes the result into a rule to generate rule information by using a predetermined system log analysis technique. The analysis unit is also allowed to seek a factor of a failure such as which site develops a failure at the time of a system failure.

(Second Embodiment)

Next, a second embodiment of the present invention will be described. A macro information generation system shown in the present embodiment is equivalent to the macro information generation system shown in the second mode of implementation. The present embodiment differs from the first embodiment in that the central processor of the personal computer on the site side functions also as a dimension counting unit. Another difference from the first embodiment is that the central processor of the personal computer on the center side functions also as an integrated dimension unit. A further difference from the first embodiment is that the magnetic disk storage device on the center side stores an integrated dimension as well.

In the first embodiment, even when dimensions of data have heterogeneousness between the sites, the center side determines that they are separate dimensions to execute analysis. Handling numbers of dimensions all as separate dimensions even when heterogeneousness exists between the data as in the first embodiment, however, makes analysis of macro information to high precision difficult. In the present embodiment, therefore, when dimensions of data are heterogeneous between the sites, the integrated dimension generation unit on the center side determines whether dimensions of the respective sites are the same or not.

When data is text, for example, the dimension counting unit of each site transmits a word used as a dimension in the text to the center. On the center side, the integrated dimension unit generates a corresponding rule between an integrated word and each word used in the site by using a word dictionary such an synonyms dictionary. When there exists a dimension as to a synonym which is represented as “personal computer” in a site A and represented as “PC” in other plurality of sites, for example, the integrated dimension unit adopts only “PC” as an integrated dimension. Then, the integrated dimension unit generates a rule indicating that the dimension “personal computer” in the site A represents a dimension “PC” in the integrated dimension. This arrangement enables precision of macro information generated to be ensured only by transmission of dimension information from the site to the center even when such a problem of heterogeneousness occurs as a difference in dimension between sites.

(Third Embodiment)

Next, a third embodiment of the present invention will be described. A macro information generation system shown in the present embodiment is equivalent to the macro information generation system shown in the third mode of implementation. The present embodiment differs from the second embodiment in that the central processor of the personal computer on the center side functions also as a macro distribution generation unit.

While in the first embodiment and the second embodiment, macro information generated by the analysis unit on the center side is not specified, while in the present embodiment, the macro distribution generation unit on the center side estimates a probability distribution as macro information. In the present embodiment, the macro distribution generation unit, for example, analyzes which topic exists as data as a whole with respect to text data accumulated in each site without collecting raw data accumulated by the site. “Topic” here represents a group of texts which describe a specific event or activity. The macro distribution generation unit generates a topic contained in text data by using a probability model called a finite mixture model, for example.

In the present embodiment, the functions of the components other than the macro distribution generation unit are the same as those of their counterparts shown in the first embodiment and the second embodiment.

The macro distribution generation unit finds a topic by learning a finite mixture model indicating one component as one topic from reproduction data which is generated as approximate information by the sampling unit. The macro distribution generation unit, for example, extracts a topic by learning a finite mixture model by using an EM (Expectation Maximization) algorithm. The macro distribution generation unit also extracts a topic, for example, by using a topic analysis method of learning a topic indicative of the same subject from a text stream represented as a time series by using the finite mixture model.

The topic analysis method described above is recited, for example, in “S. Morinaga, K. Yamanishi, “Tracking Dynamics of Topic Trends Using a Finite Mixture Models”, Proceedings of the Tenth ACM SIGKDD International Conference on Knowledge Discovery and Data Mining, ACM Press, 2004, August, pp. 811-816”.

Thus executing the processing enables the macro distribution generation unit to estimate, as macro information, a topic as the data as a whole which is represented by a finite mixture model.

(Fourth Embodiment)

Next, a fourth embodiment of the present invention will be described with reference to the drawings. A macro information generation system shown in the present embodiment is equivalent to the macro information generation system shown in the fourth mode of implementation. The present embodiment differs from the third embodiment in that the central processor of the personal computer on the center side functions also as a topic information extraction unit.

While the third embodiment has been described with respect to a case where a finite mixture model, for example, is estimated as macro information, no consideration is given to whether generated macro information (macro distribution) is information of a form easy to understand and valuable for a user. In the present embodiment, in order to make a macro distribution easy to grasp for a user, the macro information generation system converts each component information of a mixture model into information of a form easy to grasp. The macro information generation system not only converts a data form of a macro distribution but also converts each component information into information of a form easy to grasp even when aggregated information received from the site is expressed as a finite mixture model.

In the present embodiment, the macro information generation system extracts topic information as partial information of macro information based on aggregated information received from the site and the finite mixture model indicative of a topic generated on the center side. In this case, the macro information generation system extracts a word or activeness characteristically described with respect to each topic as topic information. “Activeness of topic” is a measure indicating to what extent of rate the topic is recited (to what extent words indicating a target topic are included in words). In the present embodiment, the aggregation unit of the site is assumed to estimate a finite mixture model to obtain aggregated information.

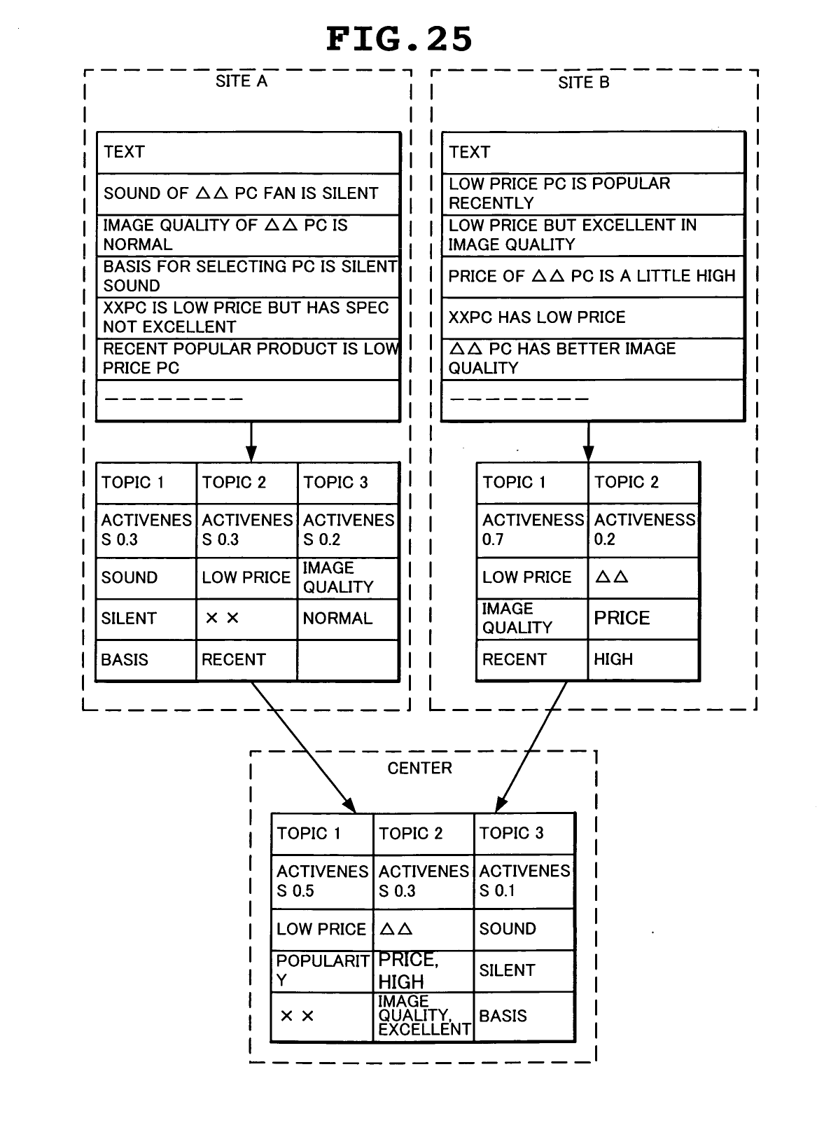

FIG. 24 is a block diagram showing another specific example of a structure of the macro information generation system. FIG. 24 is equivalent to a further embodied structure of the macro information generation system shown in FIG. 9. As shown in FIG. 24, the present embodiment differs from the third embodiment in that the site device of the macro information generation system includes a learning unit (equivalent to the aggregation unit) for estimating a finite mixture model. Another difference is that the center device has the topic information extraction unit (equivalent to a partial information extraction unit) for extracting topic information.

When indicating about which event each topic is described in general, not presenting as a numerical parameter but presenting to a user by using a word makes a macro distribution be information easier” to understand and more valuable for a user.

In the present embodiment, more specifically, the topic information extraction unit shown in FIG. 24 extracts a word peculiar to a topic from a macro distribution or aggregated information. In this case, the topic information extraction unit extracts a word peculiar to a topic by using a method called ESC (Extended Stochastic Complexity) shown in an expression (2), for example.
G(W)=ESC−(ESC1+ESC0)
ESC=A+L×Sqrt((A+B)×log(A+B)
ESC1=D+L×Sqrt(C+D)×log(C+D)
ESC0=(A−C)+L×Sqrt((A+B−C−D)×log(A+B−C−D)) Expression (2)

Here, in the expression (2), A represents the number of documents which include a topic to be analyzed and B represents the number of documents which include other topics than the topic to be analyzed. C represents the number of documents which include a word W in the topic to be analyzed and D represents the number of documents which fail to include the word W in the topic to be analyzed. L is a constant.

When obtaining A and B, with respect to a topic i of a site 1, the topic information extraction unit is allowed to obtain the number of documents which include the topic by calculating nl×pi. In addition, as to a topic of the center, the topic information extraction unit is allowed to obtain the number of documents which include the topic by calculating N×(nl/n)×pi to predict A and B. Here, nl represents the number of data of the site 1 and n represents the number of data of all the sites. pi represents a mixture ratio of the topic i and N represents the number of sampling data. The topic information extraction unit is also allowed to predict C and D from the number A of data of the topic to be analyzed by using a predetermined sampling technique.

The activeness of a topic is equivalent to a mixture ratio p of each component of the finite mixture model. By obtaining the activeness of each topic, it is possible to present to what extent the topic is mainly described in the entire site in a form of numeric values easy to understand for a system user. Furthermore, when activeness is already known, even if there exists no raw data accumulated by the site, the number of text data occupying the topic can be predicted. For example, the topic information extraction unit is allowed to predict the number of text data belonging to the topic i of the site 1 by calculating nl×pi (Spi=1). The topic information extraction unit is also allowed to predict, for example, the number of text data belonging to a topic j of the center by calculating n×pj (Spj=1). In this case, one text data is assumed to belong to only one topic.

FIG. 25 is a diagram for use in explaining an output example of text data and a topic analysis result accumulated in each site and an output example of a topic analysis result of the entire site as macro information. As shown in FIG. 25, the center device outputs a predetermined table as an output example of a topic analysis result. In the table showing a topic analysis result, each column of the table represents a main topic which includes activeness and a characteristic expression (output result of the topic information extraction unit) for each topic.

For example, in an analysis example at a site A shown in FIG. 25, a first component is a main topic including the activeness “0.3” and characteristic expressions (“sound”, “silent”, “basis”) , a second component is a main topic including the activeness “0.3” and characteristic expressions (“low price”, “xx”, “recent”) , and a third component is a main topic including the activeness “0.2” and characteristic expressions (“image quality”, “normal”) . In an analysis example in a site B, a first component is a main topic including the activeness “0.7” and characteristic expressions (“low rice”, “image quality”, “recent”) and a second component is a main topic including the activeness “0.2” and characteristic expressions (“□□”, “price”, “high”).

The topic information extraction unit is allowed to obtain a topic analysis result as macro information by executing sampling based on a model which integrates topic information of each site shown in FIG. 25 to re-learn the sampling data.

As shown in FIG. 25, in the analysis example (predicted result) at the center, a first component is a main topic including the activeness “0.5” and characteristic expressions (“low prince”, “popularity”, “xx”) , a second component is a main topic including the activeness “0.3” and characteristic expressions (“□□”, “price”, “high”, “image quality”, “excellent”), and a third component is a main topic including the activeness “0.1” and characteristic expressions (“sound”, “silent”, “basis”). By outputting the analysis result shown in FIG. 25 by the center device, a user is allowed to know with ease that as the entire system including the site A and the site B, “low price”, “popularity”, “xx” are most mainly described as a topic.

Methods of extracting a word peculiar to a topic by using ESC described above are recited, for example, in Patent Laying-Open No. 02-098775 (“Method and Device for Generating Decision List”) and Patent Laying-Open No. 2001-266060 (“Analysis System Questionnaire Answer”).

(Fifth Embodiment)

Next, a fifth embodiment of the present invention will be described with reference to the drawings. A macro information generation system shown in the present embodiment is equivalent to the macro information generation system shown in the fifth mode of implementation of the present invention. In the present embodiment, the macro information generation system predicts a site occupying each topic and a topic included in the site as macro information by using sampling text data.

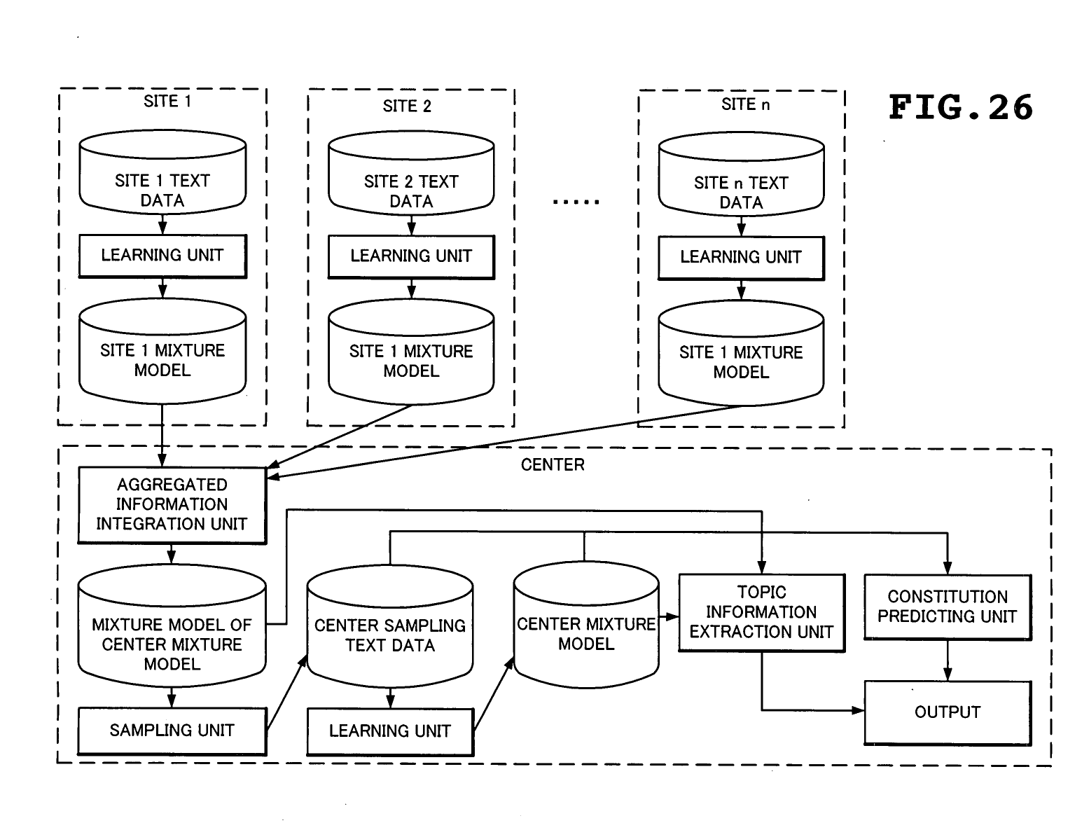

FIG. 26 is a block diagram showing a still further specific example of a structure of the macro information generation system. The present embodiment differs from the fourth embodiment in that the center device includes, in addition to the components of the center device shown in FIG. 24, a constitution predicting unit for predicting a topic constitution ratio by using sampling text data and a learned mixture model.

The constitution predicting unit predicts to what extent each site or data of a component of each site is grouped with respect to each component of a mixture model learned by the center side. In the present embodiment, a value predicted by the constitution predicting unit will be referred to as a constitution ratio (a constitution ratio of a topic included in a site).

For obtaining a constitution ratio, the constitution predicting unit obtains a probability that each data will belong to each component (hereinafter referred to as a posterior probability) by using the EM algorithm used by a learning unit on the center side. In the present embodiment, sampling data is assumed to be grouped into a component having the maximum posterior probability. In this case, the constitution predicting unit is allowed to specify by which component in which site causes generation of each sampling data (based on which component, sampling data is generated) by using a posterior probability. The constitution predicting unit is therefore allowed to check (obtain) constitution of data grouped into components by using information of a site to be predicted or of a component of the site. This arrangement enables a constitution ratio of a site or a topic of a site to be found with respect to each topic of the macro information.

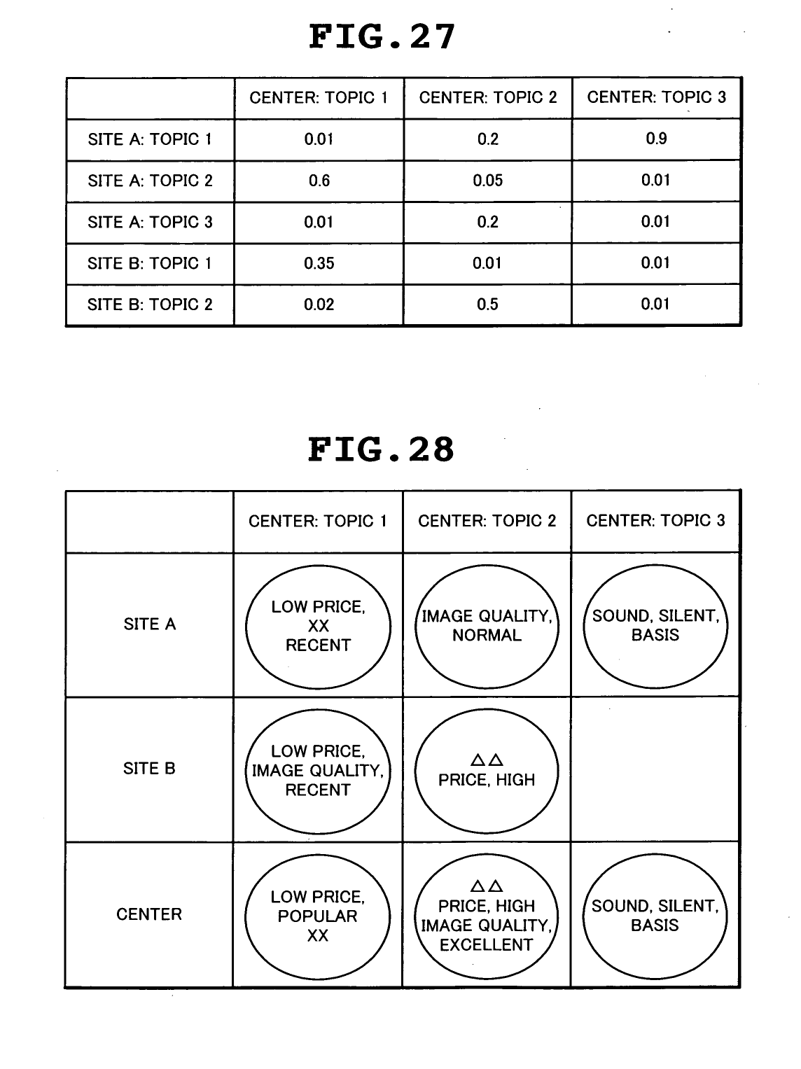

FIG. 27 is a diagram for use in explaining an example of a constitution ratio of a site or a topic of a site obtained by the constitution predicting unit with respect to each topic on the center side. As shown in FIG. 27, the center device outputs a table containing a constitution ratio of each topic. In FIG. 27, a column of the table represents a topic on the center side and a row represents a topic on the site side. Numerical value indicated in each field of the table shows a constitution ratio of a topic. In the analysis result shown in FIG. 27, it can be found from the topic constitution ratio that a topic 1 of the center is mainly formed of a topic 2 of the site A and a topic 1 of the site B.

(Sixth Embodiment)

Next, a sixth embodiment of the present invention will be described with reference to the drawings. A macro information generation system shown in the present embodiment is equivalent to the macro information generation system shown in the fifth mode of implementation of the present invention. Also in the present embodiment, the structure of the macro information generation system is the same as that of the macro information generation system shown in the fifth embodiment. According to the present embodiment, the macro information generation system determines to which topic on the center side a topic on each site side corresponds and creates a table in which topics on the center side and the site side are correlated.

In the present embodiment, the constitution predicting unit obtains information such as information that sampling data generated based on a certain topic of a certain site belongs most to a specific topic on the center side. In other words, the constitution predicting unit specifies to which topic on the center side, sampling data based on a certain topic on the site side belongs most. The constitution predicting unit also determines that a topic on the center side determined to have most data belonging corresponds to a topic of a site to be predicted.

FIG. 28 is a diagram for use in explaining an example of a table in which topics on the center side and the site side are correlated. The table shown in FIG. 28 is equivalent to a corresponding table created by the constitution predicting unit based on the data shown in FIG. 25. In FIG. 28, information indicated in a circle which is included in each field of the table is equivalent to one topic. Also in FIG. 28, the column of the table shows a topic on the site side corresponding to a topic on the center side. The circle indicating a topic includes characteristic expressions obtained by the same processing as that of the fourth embodiment. It is possible, for example, to indicate an activeness of a topic obtained by the same processing as that of the fourth embodiment by outputting a circle to the output device with its size changed.

(Seventh Embodiment)

Next, a seventh embodiment of the present invention will be described. A macro information generation system shown in the present embodiment is equivalent to the macro information generation system shown in the fifth mode of implementation of the present invention. Also in the present embodiment, the structure of the macro information generation system is the same as those of the macro information generation systems shown in the fifth embodiment and the sixth embodiment.

In the present embodiment, the center devices transmits information of an obtained mixture model to the site device through a communication network. Here, when a probability distribution at the center is a normal distribution, for example, the center transmits, to the site device, an expected value (μ), a dispersion covariance matrix (S), a mixture ratio (p), a kind of probability distribution (normal distribution in this example), an integrated dimension and a topic feature word list. This arrangement enables the site side as well to grasp a topic in the entire system to know whether data accumulated in its own site is a topic of high precision or not.

(Eighth Embodiment)

Next, an eighth embodiment of the present invention will be described. A macro information generation system shown in the present embodiment is equivalent to the macro information generation system shown in the fifth mode of implementation of the present invention. Also in the present embodiment, the structure of the macro information generation system is the same as those of the macro information generation systems shown in the fifth to seventh embodiments. The present embodiment will be described with respect to a case where the macro information generation system is applied to a specific business model.

In the present embodiment, the site is assumed to be a customer such as a corporation and the center is assumed to be a service provider. Then, the corporation as a customer makes a contract in advance with the center as a service provider to receive supply of macro information distribution service. The present embodiment proposes a business model of collecting charges (information fee) from each site by providing a mixture model as macro information to each site device by the center device.

In the present embodiment, each site device generates aggregated information according to the same processing as that of the seventh embodiment and transmits the information to the center device through a communication network such as the Internet. The center device generates a mixture model as macro information based on the aggregated information received from each site device. Then, the center device distributes the obtained macro information to each site device through the communication network at predetermined intervals. For example, the center device also distributes macro information to the site device through the communication network in response to a request from the site device. In other words, in the present embodiment, a mixture model predicted by the center side according to the same processing as that of the seventh embodiment is transmitted to each site.

Mixture model as macro information is information which can not be created based singly on data accumulated by one site and is a group of topics whose analysis precision is high for the site side. Therefore, it is information which a site such as a corporation wants to obtain even by paying a charge (information fee). The foregoing processing enables the center to execute business of providing macro information analysis service of generating macro information and distributing the information to each site only by collecting aggregated information from a plurality of sites.

(Ninth Embodiment)

Next, a ninth embodiment of the present invention will be described. A macro information generation system shown in the present embodiment is equivalent to the macro information generation system shown in the fifth mode of implementation of the present invention. Also in the present embodiment, the structure of the macro information generation system is the same as those of the macro information generation systems shown in the fifth to eighth embodiments.

The seventh embodiment has been described with respect to a case where the center device transmits a mixture model itself as macro information to the site device. In the present embodiment, the center device transmits to the site device not a mixture model itself as macro information but a topic of macro information closely related to the site (topic contained in data accumulated by the site). The center device alternatively transmits a topic unrelated to the site (topic not contained in the data accumulated by the site).

In the present embodiment, the center device predicts a constitution ratio of a topic according to the same processing as that of the fifth embodiment. Based on the obtained constitution ratio, the center device also quantitatively obtains a contribution rate indicating to what extent each site contributes to calculation with respect to a topic obtained as macro information. Then, setting a predetermined threshold value enables the center side to obtain existence/non-existence of a relationship between a topic of macro information and a site. In this case, the center device, for example, determines whether an obtained contribution rate is larger than a predetermined threshold value or not and when determining that it is larger than the predetermined threshold value, determines that the topic of the macro information is closely related to the site. Execution of this processing enables transmission of only a topic closely related to each site or a topic not related to each site to the site device.

(Tenth Embodiment)

Next, a tenth embodiment of the present invention will be described. A macro information generation system shown in the present embodiment is equivalent to the macro information generation system shown in the fifth mode of implementation of the present invention. Also in the present embodiment, the structure of the macro information generation system is the same as those of the macro information generation systems shown in the fifth to ninth embodiments. The present embodiment, similarly to the eighth embodiment, will be described with respect to a case where the macro information generation system is applied to a specific business model.

In the present embodiment, the site is assumed to be a customer such as a corporation and the center is assumed to be a service provider. Then, the corporation as a customer makes a contract in advance with the center as a service provider to receive supply of macro information distribution service. The present embodiment proposes a business model of collecting charges (information fee) from each site by providing a part of topics in macro information to each site device by the center device.

In the present embodiment, each site device generates aggregated information and transmits the same to the center device through a communication network according to the same processing as that of the ninth embodiment. The center device generates macro information based on the aggregated information received from each site device. The center device also extracts a topic closely related to the site or a topic not related to the site from among the topics in the macro information according to the same processing as that of the ninth mode of implementation. Then, the center device transmits the extracted topic to each site device through the communication network at predetermined intervals. For example, the center device distributes the extracted topic to the site device through the communication network in response to a request from the site device. In other words, the present embodiment enables a topic closely related to the site or a topic not closely related to the site to be transmitted to the site according to the same processing as that of the ninth embodiment.

Topic closely related to the site, which also includes information of other site, is a topic with a higher precision for the site side. Topic not closely related to the site, which is seldom found in data accumulated by its own site, is a topic often found in data accumulated by other sites and is useful for a corporation and the like.

Consider a case, for example, where each site is a corporation of the same business field and data accumulated by each site is an activity report of a corporation which operates the site. In this case, although a topic not closely related to its own company is not actively made use of, it may be a topic actively made use of by other company of the same business field in some cases. Such information made use of by other companies is information necessary for the corporation in order to know activities of a plurality of other rival companies. Accordingly, both a topic related to the site and a topic not closely related to the site are information which a site such as a corporation wants even paying charges (information fees). In the present embodiment, the foregoing processing enables the center to provide macro information analysis service to each site similarly to the eighth embodiment.

(Eleventh Embodiment)

Next, an eleventh embodiment of the present invention will be described. A macro information generation system shown in the present embodiment is equivalent to the macro information generation system shown in the fifth mode of implementation of the present invention. Also in the present embodiment, the structure of the macro information generation system is the same as that of the macro information generation system shown in the seventh embodiment.

In the present embodiment, with a predetermined flag applied in advance to accumulated data by the site device, analysis with respect to a topic by using a flag and prediction of new data by using a flag are executed. In a case, for example, where accumulated data is an activity report, the site device adds a flag indicating whether a project has been achieved by a due date. On the other hand, when accumulated data is an article on BLOG or a bulletin board, for example, the site device adds a flag indicating whether it is a popular article whose number of accesses is large. In this case, the site device, for example, adds a predetermined flag to new data or edited data according to user's operation at the time of new data input or data edition.

In the present embodiment, assume a case where a mixture model predicted according to the processing shown in the seventh embodiment is transmitted in advance to each site device by the center device. It is also assumed that each site device receives the mixture model from the center device in advance and stores the same in a storage device.

Each site device checks (obtains) a posterior probability Wᵢⱼ indicating to which topic on the center side accumulated raw data belongs by using an expression (3) at predetermined timing (e.g. at predetermined intervals) based on the mixture model stored in advance.

$${W}_{ij} = \frac{π ipi ( χ j \vert θ j )}{{\sum }_{i = 1}^{K} π ipi ( χ j \vert θ j )} \qquad ( Numerical Expression 3 )$$

Here, in the expression (3), xⱼ represents data accumulated by a site and pᵢ represents a probability density function of a component i. In addition, k represents the number of components and θᵢ represents a parameter of the component i. The site device obtains a posterior probability of each data by using the expression (3) to group the respective data into topics on the center side which will have the maximum posterior probability.

Next, with respect to each topic on the center side, the site device counts up (obtains) the number of flags added to the data grouped into the topics. Then, the site device transmits the obtained number of flags to the center device through a communication network. The foregoing processing will be advance preparation for executing analyses based on a flag on the center side.

Execution of the foregoing processing enables the center device to execute analysis using a flag with respect to each topic. Consider a case, for example, where accumulated data is an activity report of one corporation and each site device is a server managed by a project department of the same corporation. Also assume that each site device adds a flag indicating whether sufficient profits are obtained in a project to accumulated data. In this case, the center device is allowed to analyze a reason why sufficient profits are obtained in topics for overseas in many cases or analyze a reason why no profit is obtained in topics for PC sales based on the number of flags received from each site device.

Furthermore, the center device, by checking (determining) to which topic on the center side new data input at the site belongs, is allowed to make prediction based on a flag. Consider a case, for example, where accumulated data is an activity report and each site device adds a flag indicating whether a project will succeed or not to the accumulated data. In this case, by making determination based on the number of flags received from each site device, the center device is allowed to predict whether the project shown in new text will succeed or not from past cases. Also consider a case, for example, where accumulated data is a BLOG article and each site device adds a flag indicating whether it is a popular article or not to the accumulated data. In this case, by making determination based on the number of flags received from each site device, the center device is allowed to predict popularity of a new article from past cases.

(Twelfth Embodiment)

Next, a twelfth embodiment of the present invention will be described. A macro information generation system shown in the present embodiment is equivalent to the macro information generation system shown in the fifth mode of implementation of the present invention. Also in the present embodiment, the structure of the macro information generation system is the same as that of the macro information generation system shown in the eleventh embodiment. The present embodiment, similarly to the eighth embodiment and the tenth embodiment, will be described with respect to a case where the macro information generation system is applied to a specific business model.

In the present embodiment, it is assumed that the center device is capable of executing prediction based on a flag by using information related to a flag received from each site device (the number of flags) according to the same processing as that of the eleventh embodiment. In the present embodiment, the site is assumed to be a customer such as a corporation and the center is assumed to be a service provider. Then, the corporation as a customer makes a contract in advance with the center as a service provider to receive supply of macro information distribution service. The present embodiment proposes a business model of collecting charges (information fee) from each site by providing (distributing) a prediction result to each site device by the center device.

In the present embodiment, each site device obtains the number of flags and transmits the same to the center device through a communication network according to the same processing as that of the eleventh embodiment. The center device executes prediction processing based on the number of flags received from each site device according to the same processing as that of the eleventh embodiment. Then, the center device distributes the obtained prediction result to each site device through the communication network at predetermined intervals. In addition, the center device, for example, distributes the obtained prediction result to the site device through the communication network in response to a request from the site device.

Consider a case, for example, where each site is a corporation of the same business field. In the present embodiment, execution of the above-described processing enables a corporation as a customer to execute various predictions such as whether a project will succeed or not from past cases of corporations of the same business field including its own company based on the information of distributed prediction results. These prediction results distributed from the center device are information which can be obtained only by a main frame which generates macro information without concentrating raw data on the center and information valuable enough for a corporation. In the present embodiment, execution of the above-described processing enables the center to provide each site with macro information analysis service similarly to the eighth embodiment and the tenth embodiment.

(Thirteenth Embodiment)

Next, a thirteenth embodiment of the present invention will be described. A macro information generation system shown in the present embodiment is equivalent to the macro information generation system shown in the fifth mode of implementation of the present invention. In the present embodiment, the structure of the macro information generation system is the same as that of the macro information generation system shown in the eighth embodiment.

In the present embodiment, with respect to new data, the center device automatically searches data similar to the new data among data accumulated by all the sites. In the present embodiment, assume a case where a mixture model predicted according to the processing shown in the seventh embodiment is transmitted to each site device in advance. In addition, each site device is assumed to receive the mixture model from the center device in advance and store the same in a storage device.

First, each site device is assumed to group data accumulated by the site according to topics as macro information by the same processing as that of the eighth embodiment. Then, each site device notifies the center only about which topic, data is accumulated without transmission of the data itself (i.e. raw data accumulated by the site) to the center device. In this case, each site device transmits notification information indicating about which topic, data is accumulated, to the center device in advance through the communication network. In addition, the center device in advance stores the notification information received from each site device in a data base so as to be correlated with the site device (e.g. an ID or an IP address of the site device). In the present embodiment, it is assumed that processing of the above-described advance preparation is ordinarily completed.

In the present embodiment, occasions where the macro information generation system is used are as follows. Consider a case, for example, where a request is made to search, at a certain site, data similar to new data which is newly obtained (input) from among data accumulated by a plurality of other sites. In the following, a site requesting the similarity search will be referred to as a similarity search requesting site.

First, the site device of the similarity search requesting site checks to specify to which topic on the center side new data belongs based on a mixture model stored in the storage device according to the same processing as that of the eighth embodiment. In addition, the site device makes (transmits), to the center device, a request for searching data related to a specified topic (similar data) through the communication network.

Next, the center device checks to specify which site device accumulates data (similar data) belonging to the topic whose search is requested based on the search demand (search request) received from the similarity search requesting site. In this case, the center device, for example, selects notification information containing the topic whose search is requested from among the notification information accumulated in the data base in advance. The center also specifies a site corresponding to the selected notification information as a site in which data similar to the topic whose search is requested is accumulated. Then, the center device transmits, to the site device of the specified site (site which accumulates the similar data whose search is requested), a request for transmitting similar data to the similarity search requesting site through the communication network.

The site having received the transmission request from the center (site which accumulates the similar data) transmits information to the similarity search requesting site or discloses information by linking within a range of allowable access. In this case, the site device, for example, receives address information of the site as a transmission destination (similarity search requesting site) together with the similar data transmission request from the center device. Then, the site device transmits the similar data to the site device of the similarity search requesting site through the communication network according to the received address information. Execution of the above-described processing enables each site device to execute similarity search related to information accumulated by other site without transmitting raw data to the center device.

(Fourteenth Embodiment)

Next, a fourteenth embodiment of the present invention will be described with reference to the drawings. A macro information generation system shown in the present embodiment is equivalent to the macro information generation system shown in the fifth mode of implementation of the present invention. Also in the present embodiment, the structure of the macro information generation system is the same as that of the macro information generation system shown in the thirteenth embodiment. The present embodiment, similarly to the eighth embodiment, the tenth embodiment and the twelfth embodiment, will be described with respect to a case where the macro information generation system is applied to a specific business model.

In the present embodiment, it is assumed that each site device and the center device are capable of automatically searching data similar to data to be searched from among data accumulated by all the sites according to the same processing as that of the thirteenth embodiment. In the present embodiment, the site is assumed to be a customer such as a corporation and the center is assumed to be a service provider. Then, the corporation as a customer makes a contract in advance with the center as a service provider to receive supply of macro information distribution service. The present embodiment proposes a business model of collecting charges (intermediate fee) from each site for the agency service of making a similar data transmission request provided by the center device which acts for each site device.

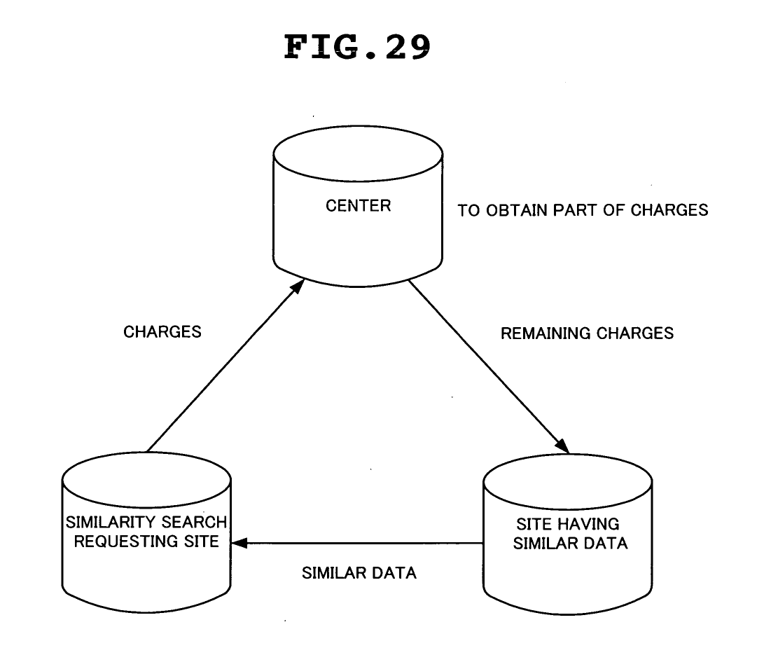

FIG. 29 is a diagram for use in explaining business model application concept according to the present embodiment. In the present embodiment, a site device of a similarity search requesting site transmits a similar data search request to the center device through the communication network according to the same processing as that of the thirteenth embodiment. The center device specifies a site which accumulates similar data based on notification information stored in advance in the data base according to the same processing as that of the thirteenth embodiment. The center device also transmits a request for transmitting similar data to the similarity search requesting site to the site device of the specified site through the communication network. Then, the site device having received the transmission request transmits similar data to the site device of the similarity search requesting site through the communication network.

In the present embodiment, the similarity search requesting site pays a charge to the center as shown in FIG. 29. In addition, the center obtains a part of charges (intermediate fee) incurred in providing request agency service from the charge collected from the similarity search requesting site. The center also pays a charge as a remainder obtained by subtracting the intermediate fee (information fee) to a similar data owner site which provides the similar data. This arrangement enables provision of service of automatically searching and obtaining similar data to each site even when the data is data accumulated by other site. This also allows the site which provides similar data to receive payment of a charge (information fee) from the center. In the present embodiment, execution of the above-described processing enables the center to provide each site with macro information analysis service similarly to the eighth embodiment, the tenth embodiment and the twelfth embodiment.

(Fifteenth Embodiment)

Next, a fifteenth embodiment of the present invention will be described. A macro information generation system shown in the present embodiment is equivalent to the macro information generation system shown in the sixth mode of implementation of the present invention. Also in the present embodiment, a central processor of a personal computer of a site fails to include the dimension counting unit among the components shown in the ninth embodiment. Also in the present embodiment, a central processor of a personal computer of a center fails to include the integrated dimension generation unit and the approximate information generation unit. In the present embodiment, a magnetic disk storage device of the center stores neither an integrated dimension nor approximate information.

In the first embodiment to the ninth embodiment, the center device reproduces data accumulated by the site by executing predetermined sampling processing. In the present embodiment, the center device directly obtains a probability distribution as macro information by integration based on an integrated probability distribution without executing sampling processing. The center device, for example, obtains a probability distribution (macro distribution) as macro information by using a predetermined integration expression based on an integrated probability distribution.

Assume a probability distribution (also referred to as an integrated distribution) integrated by the aggregated information integration unit is represented as p′(x|θ′). The integrated distribution p′(x|θ′) to be obtained by the aggregated information integration unit is equivalent to an expression of a distribution of data accumulated by each site by a predetermined expression method. Also assume that a distribution indicative of macro information to be obtained by the center device (macro distribution) is represented as p(x|θ).

In order to predict a value of θ in the macro distribution p(x|θ), the center device approximates θ so as to make an inter-distribution distance D (p′, p) between two probability distributions be minimum. This arrangement enables the center device to obtain the macro distribution p(x|θ). Thus, the center device estimates a value of θ when the inter-distribution distance D (p′, p) attains the minimum value. In the present embodiment, KL (Kullback Leibler) divergence is obtained as an inter-distribution distance by the center device by using an

$$\begin{matrix}\begin{matrix}D ( {P}^{′} , P ) = \int {P}^{′} ( χ \vert {θ}^{′} ) log {P}^{′} ( χ \vert {θ}^{′} ) / P ( χ \vert θ ) ⅆ x \\ = \int {P}^{′} ( χ \vert {θ}^{′} ) log P ( χ \vert θ ) ⅆ x\end{matrix} & expression ( 4 ) \\ \int {P}^{′} ( χ \vert {θ}^{′} ) log P ( χ \vert θ ) ⅆ x & ( Numerical Expression 4 )\end{matrix}$$

In the expression (4) here, ┌∫p′(x|θ′)log p′(x|θ′)dx┘ represents a constant independent of θ. Therefore, minimizing the inter-distribution distance D (p′,p) leads to estimating θ which maximizes ┌∫ p′(x|θ′)log p′(x|θ′)dx┘. As a result, by obtaining ┌∫ p′(x|θ′)log p′(x|θ′)dx┘ by using a predetermined integration technique, the center device is allowed to estimate θ with ease. Then, using the value of the estimated θ, the center device is allowed to obtain the macro distribution p(x|θ).

(Sixteenth Embodiment)

Next, a sixteenth embodiment of the present invention will be described. A macro information generation system shown in the present embodiment is equivalent to the macro information generation system shown in the seventh mode of implementation of the present invention. Also in the present embodiment, a central processor of a personal computer of a site includes an approximate information generation unit in addition to the components shown in the fourteenth embodiment. In addition, a central processor of a personal computer of a center fails to include an aggregated information integration unit, an integrated dimension generation unit and an approximate information generation unit among the components shown in the fourteenth embodiment. The present embodiment differs from the fourteenth embodiment in that a magnetic disk storage device of the center fails to store aggregated information.

The first embodiment to the ninth embodiment have been described with respect to a case where the site device transmits aggregated information such as a probability distribution and the quantity of statistics to the center device and the center device generates approximate information. In the present embodiment, the site device generates approximate information and transmits the generated approximate information to the center. Then, the center device generates macro information based on the approximate information received from the site device.

The approximate information generation unit of the site device generates approximate information according to the same processing as that of the approximate information generation unit of the center device shown in the first embodiment. When aggregated information is a probability distribution, for example, the site device generates approximate information by using a predetermined sampling technique. When aggregated information is a quantity of statistics as a total sum of values of dimensions of a data vector, for example, the site device obtains a mean value by dividing the quantity of statistics by the number of data of the site. Then, the site device generates approximate information by executing random sampling according to the obtained mean value.

Approximate information can be regarded as not raw data itself but representative data generated from a distribution of the site. In the present embodiment, therefore, approximate information can be regarded as a kind of aggregated information. As a result, only transmission of aggregated information to the center device by each site device by the transmission of approximate information from the site device to the center device enables the center device to reproduce raw data accumulated by each site device. In addition, only one transmission of aggregated information to the center device by each site device enables the center device to analyze macro information to reduce danger of information leakage to the outside of the system. Furthermore, it is possible to convert generated macro information into information of a data form easy to understand and valuable for a user and present the obtained information.

The macro information generation systems shown in the above-described respective modes of implementation and embodiments are applicable to various kinds of business models. In CRM (Customer Relationship Management), knowledge management, BPM (Business Process Management) and BAM (Business Activity Monitoring), for example, the systems are applicable for use in distributing information as analyses of corporate knowledge such as activity reports and weekly reports. They are also applicable for use in distributing information as analyses of customer inquiry data at a contact center. Further possible application is, for example, for use in distributing information as analyses of articles on WEB such as BLOG (Weblog), RSS (Rich Site Summary) and bulletin boards.

When used for analyzing corporate knowledge, for example, effective knowledge management or effective use are expected by executing the processing shown in the first embodiment to the sixteenth embodiment. Also consider a case, for example, where each site is each department and a center is a management department of a corporation. In this case, a host management department is allowed to easily grasp a topic which is emphasized by a company as a whole or how much efforts each project department makes for the topic by executing the processing shown in the first to sixth embodiments, the fifteenth embodiment or the sixteenth embodiment.

In order to integrate corporate knowledge dispersed in a company, it is also possible to modify an accumulation system of data accumulated in the company while regarding a topic as a department. Execution of the processing shown in the seventh embodiment to the tenth embodiment, for example, enables each department to grasp a company topic with ease or know a topic having a high precision even with a small amount of data. It is further possible to know effects exerted on company topics by its own department or make relative comparison with other department.

Moreover, execution of the processing shown in the eleventh embodiment or the twelfth embodiment enables various predictions such as prediction of costs or progress of a new project from past cases. In addition, execution of the processing shown in the thirteenth embodiment or the fourteenth embodiment enables access to similar information of other departments. As a result, ideas of those who have various views which are different from your own can be referred to, so that it is expected to serve to help create new idea. In addition, with a site being one corporation as a customer and a center being a service provider which integrates and analyzes information of a plurality of corporations, effective knowledge management and use for each company as a customer is expected.

Furthermore, the macro information generation systems shown in the above-described respective modes of implementation and embodiments are applicable to a business model in which information stored in a plurality of remote sites is analyzed to obtain macro information. More specifically, the macro information generation systems analyze information according to the processing shown in the eighth embodiment, the tenth embodiment, the twelfth embodiment or the fourteenth embodiment.

It is in general difficult, for example, to protect privacy of data transmitted and received between sites and between a site and a center and it is accordingly difficult to realize a business model for executing macro information analyses. The macro information generation systems shown in the above-described respective modes of implementation and embodiments enable generation of macro information without direct transmission of raw data from each site to a center or transmission of information of one site to the other site. It is therefore possible to protect privacy with respect to data transmitted and received between sites and between a site and a center. As a result, a new business model of executing macro information analyses can be realized, which is expected to be effectively used in industry.

(Seventeenth Embodiment)

Next, a seventeenth embodiment of the present invention will be described. A macro information generation system shown in the present embodiment is equivalent to the macro information generation system shown in the fifth mode of implementation of the present invention. In the present embodiment, a structure of the macro information generation system is the same as the structure of the macro information generation system shown in the eighth embodiment.

In the present embodiment, with respect to data updated or newly generated as time passes (e.g. text data), the center device discovers a common topic noted (appears) over the whole time zone, an individual topic noted (appears) in a certain specific period, or a new topic newly appearing as time passes. The center device extracts a topic, fore example, based on data of blog or an electronic bulletin board system or data such as proceedings of a regular conference.

It is first assumed in the present embodiment that each site device owns (accumulates) data within a fixed period among data updated or newly generated according to a time base. Next, the center device generates topics and a table in which respective topics are correlated as macro information based on data accumulated by the site according to the same processing as that of the eighth embodiment. As a case where the site device is a device used by a customer and the center device is a device operated by a service provider, when positions of the site and the center are different, the center device transmits macro information including topics or a table in which the respective topics are correlated to each site device through the communication network.

Upon reference by the site to the table in which topics are correlated, when to a certain topic as macro information, there exists a topic correlated commonly to all the sites, the center device extracts the common topic. In addition, when there exists a topic correlated only to a specific site, the center device extracts the individual topic. Furthermore, the center device realigns sites according to a time base and when there appears a topic correlated to the site in the course of the time base, extracts a new topic. In this case, by discovering (extracting) a common topic, a topic noted with respect to the data over the whole time zone can be known with ease. In addition, finding an individual topic enables a temporary topic which is not found in other periods to be known with ease. Also, it is possible to know with ease a topic whose recitation starts in the period by finding a new topic.

(Eighteenth Embodiment)

Next, an eighteenth embodiment of the present invention will be described. A macro information generation system shown in the present embodiment is equivalent to the macro information generation system shown in the fifth mode of implementation of the present invention. Also in the present embodiment, the structure of the macro information generation system is the same as that of the macro information generation systems shown in the eighth embodiment, the tenth embodiment, the twelfth embodiment and the fourteenth embodiment. The present embodiment will be described with respect to a case where the macro information generation system is applied to a specific business model.

In the present embodiment, it is assumed that each site device and the center device discover (extract), according to the same processing as that of the seventeenth embodiment, a common topic, an individual topic and a new topic when data to be updated or generated according to a time base is accumulated in each site in every specific period. It is assumed in the present embodiment that the site device is a device used by a customer such as the same company and the center device is a device operated by a service provider or by the same customer as that of the site. When the center is a service provider, the company as a customer makes a contract in advance to receive provision of macro information distribution service with the center as a service provider. The present embodiment proposes a business model of collecting charges from a site by providing macro information including a topic analyzed by the center device and a topic table in which topics are correlated.

(Nineteenth Embodiment)

Next, a nineteenth embodiment of the present invention will be described. A macro information generation system shown in the present embodiment is equivalent to the macro information generation system shown in the fifth mode of implementation of the present invention. In the present embodiment, the structure of the macro information generation system is the same as that of the macro information generation system shown in the eighth embodiment.

In the present embodiment, with respect to data (e.g. text data) owned (accumulated) by certain one site, the center device compares data (evaluation information) indicative of criticism contents (evaluation) of the contents described in the data or of a target.

In the present embodiment, first, certain one site device accumulates data to be compared such as publicity data of one product of one company. Other site device accumulates evaluation information obtained (e.g. extracted) from blog of data to be compared or data of an electronic bulletin board system. Each site device, for example, stores evaluation information in the data storage units 211 and 221 in advance. Next, the center device generates a topic or a table (corresponding table) in which the respective topics are correlated as macro information based on data accumulated by the site according to the same processing as that of the eighth embodiment. The center device, for example, generates a corresponding table indicative of a corresponding relationship between text data corresponding to evaluation information and data contents of the text data or a target. Moreover, the center device transmits macro information including a topic or a table which correlates the respective topics to the site device which owns (accumulates) data to be compared through the communication network.

In the present embodiment, consider the following scenes as an occasion where the macro information generation system is used. Consider a case, for example, where a certain site requests to obtain information about how a product in sale is evaluated by the market or about whether the evaluation is coincident with recognition of the sales side. In the following, a site requesting examination of the evaluation will be referred to as an evaluation examination requesting site.

First, a site device of an evaluation examination requesting site makes (transmits) an evaluation examination request for a specific product to the center device through the communication network. Next, the center device specifies a plurality of site devices which accumulate information reciting evaluation information of the requested product based on the evaluation examination request received from the evaluation examination requesting site. Then, the center device transmits a topic analysis request related to the product to the site device of a specific site through a communication network.

The site device of the site having received the topic analysis request from the center, upon receiving the topic analysis request command, analyzes accumulated data based on the stored evaluation information. In the present embodiment, the site device aggregates information (including the evaluation information) at the site and transmits the aggregated information to the center device according to the same processing as that of the eighth embodiment. The center device having received the aggregated information generates macro information including a topic and a table (corresponding table) in which topics are correlated based on the aggregated information from the evaluation examination requesting site and a specific site having (accumulating) evaluation information according to the same processing as that of the eighth embodiment. Then, the center device transmits the generated macro information to the site device of the evaluation examination requesting site.

Execution of the above-described processing allows the site device of the evaluation examination requesting site to grasp a difference in recognition of a product between the evaluation examination requesting site and the market from the topic corresponding table without transmitting raw data to the center device. In addition, because evaluation information is put in order for each topic such as performance or costs, a difference in recognition of a product between the evaluation examination requesting site and the market can be comprehended with ease.

(Twentieth Embodiment)

Next, a twentieth embodiment of the present invention will be described. A macro information generation system shown in the present embodiment is equivalent to the macro information generation system shown in the fifth mode of implementation of the present invention. Also in the present embodiment, the structure of the macro information generation system is the same as those of the macro information generation systems shown in the eighth embodiment, the tenth embodiment, the twelfth embodiment, the fourteenth embodiment and the eighteenth embodiment. The present embodiment will be described with respect to a case where the macro information generation system is applied to a specific business model.

In the present embodiment, with respect to data owned (accumulated) by one site, each site device and the center device compare data criticizing the contents described in the data or a target by the same processing as that of the nineteenth embodiment. It is assumed in the present embodiment that certain one site is a customer such as a company and other sites are companies having information sources whose evaluation information is recited. Also assume that the center is a service provider. The company as a customer makes a contract in advance to receive provision of macro information distribution service with the center as a service provider. The present embodiment proposes a business model of providing macro information including a topic analyzed by the center device or a table of topics correlated with each other to collect charges from a site as a customer, as well as paying a part of the charges (e.g. information fee) collected from the customer to a site having the evaluation information. This arrangement allows also a site having evaluation information to obtain charges for analyses of the owned data to gain profits.

(Twenty-First Embodiment)

Next, a twenty-first embodiment of the present invention will be described with reference to the drawings. A macro information generation system shown in the present embodiment is equivalent to the macro information generation system shown in the ninth mode of implementation of the present invention. Also in the present embodiment, the structure of the macro information generation system is the same as that of the macro information generation system shown in the sixth embodiment. In the present embodiment, the macro information generation system applies a label easier to understand to a topic on each site side or a topic on the center side by using a dictionary in which a technical region and a name such as a product name are correlated.

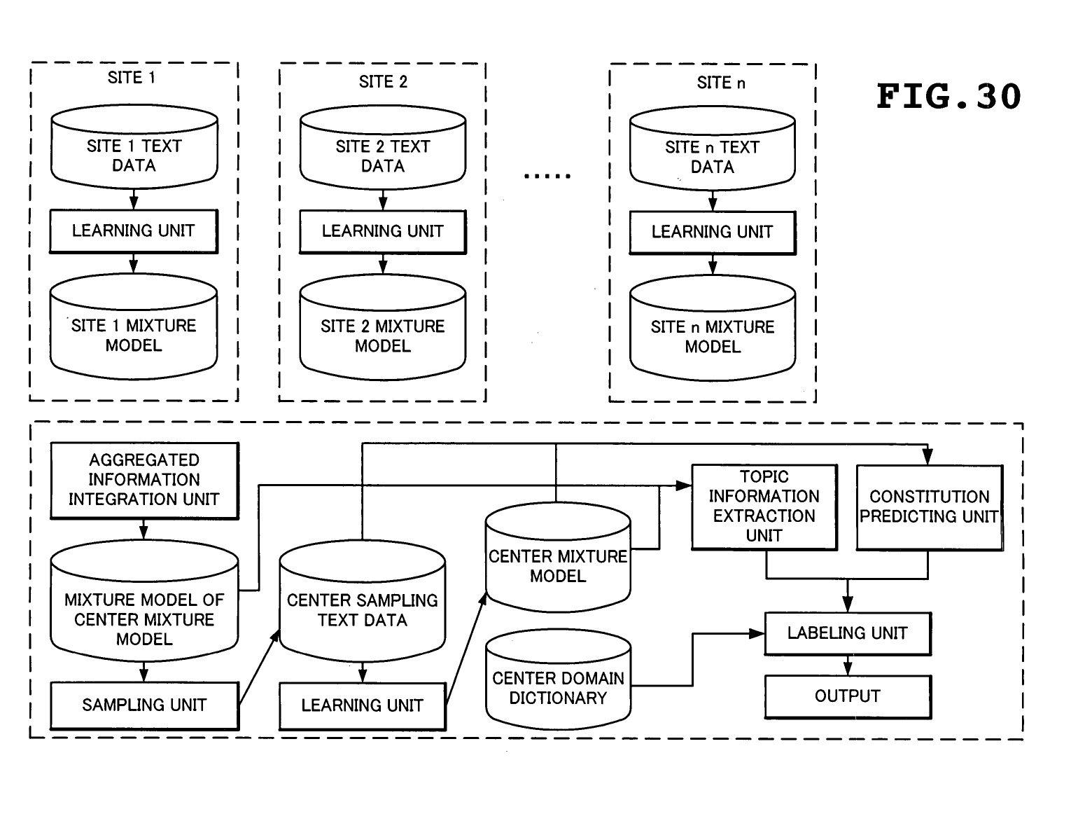

FIG. 30 is a block diagram showing a still further specific example of a structure of the macro information generation system. The present embodiment differs from the sixth embodiment in that a center device includes, in addition to the components of the center device shown in FIG. 26, a domain dictionary and a labeling unit for applying a label easy to grasp to a topic.

In the present embodiment, the domain dictionary includes correlation between a name represented mainly as a proper noun such as a product name or a technique and a domain such as a technical region to which the product or the technique belongs. Such a domain dictionary is, for example, manually (e.g. by a manager of the center device) created in advance based on information obtained from an external information source such as Web. On the other hand, the labeling unit first extracts a name of a product or a technique from information such as sampling data and feature words belonging to topics on the center side and the site side. The labeling unit checks to which technical domain the extracted name belongs by using the domain dictionary. Then, the labeling units applies the specified technical domain as a label to the topic.

Among methods of applying a technical domain to a topic is, for example, a method of selecting a technical domain most frequently appearing as a label of the topic. This arrangement enables application, as a label of information about which subject a specific topic is described in a form easy for a user to grasp (in a form of a technical domain).

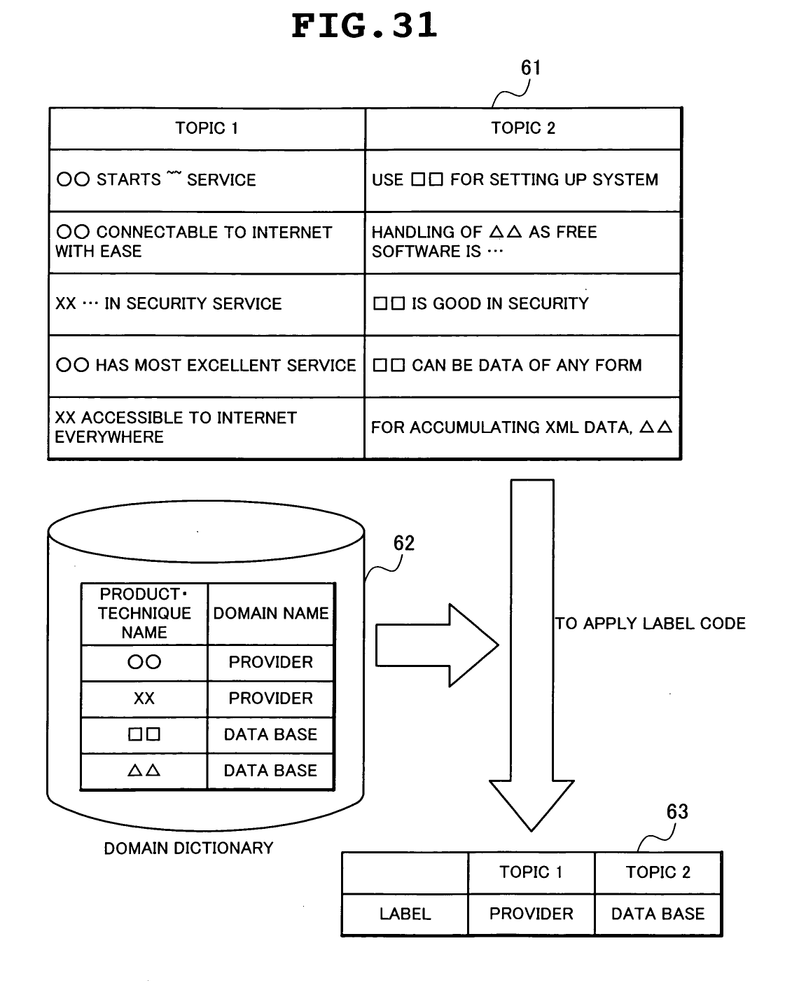

FIG. 31 is a diagram for use in explaining an example of labeling to a topic. In FIG. 31, a table 61 indicates articles belonging to a topic 1 and a topic 2. Also as shown in FIG. 31, a domain dictionary 62 includes a name of a product, a technique or the like. (the left field of the table in the domain dictionary 62 in FIG. 31) and a domain name of the name of the product or the technique (the right field of the table in the domain dictionary 62).

In the example shown in FIG. 31, the labeling unit extracts a name of a product, a technique or the like in the articles of each topic. The labeling unit counts the number of domains appearing corresponding to a product name or a technique name by using the domain dictionary 62 to label a topic as a domain name most frequently included (the largest number of count). Then, as shown in a labeling result 63 in FIG. 31, a label “provider” is applied to the topic 1 and a label “data base” is applied to the topic 2.

(Twenty-Second Embodiment)

Next, a twenty-second embodiment of the present invention will be described. A macro information generation system shown in the present embodiment is equivalent to the macro information generation system shown in the tenth mode of implementation of the present invention. Also in the present embodiment, the structure of the macro information generation system is the same as that of the macro information generation system shown in the twenty-first embodiment. In the present embodiment, the macro information generation system generates a graph such as a radar chart for supporting contention analysis of analyzing advantages and disadvantages of each site.

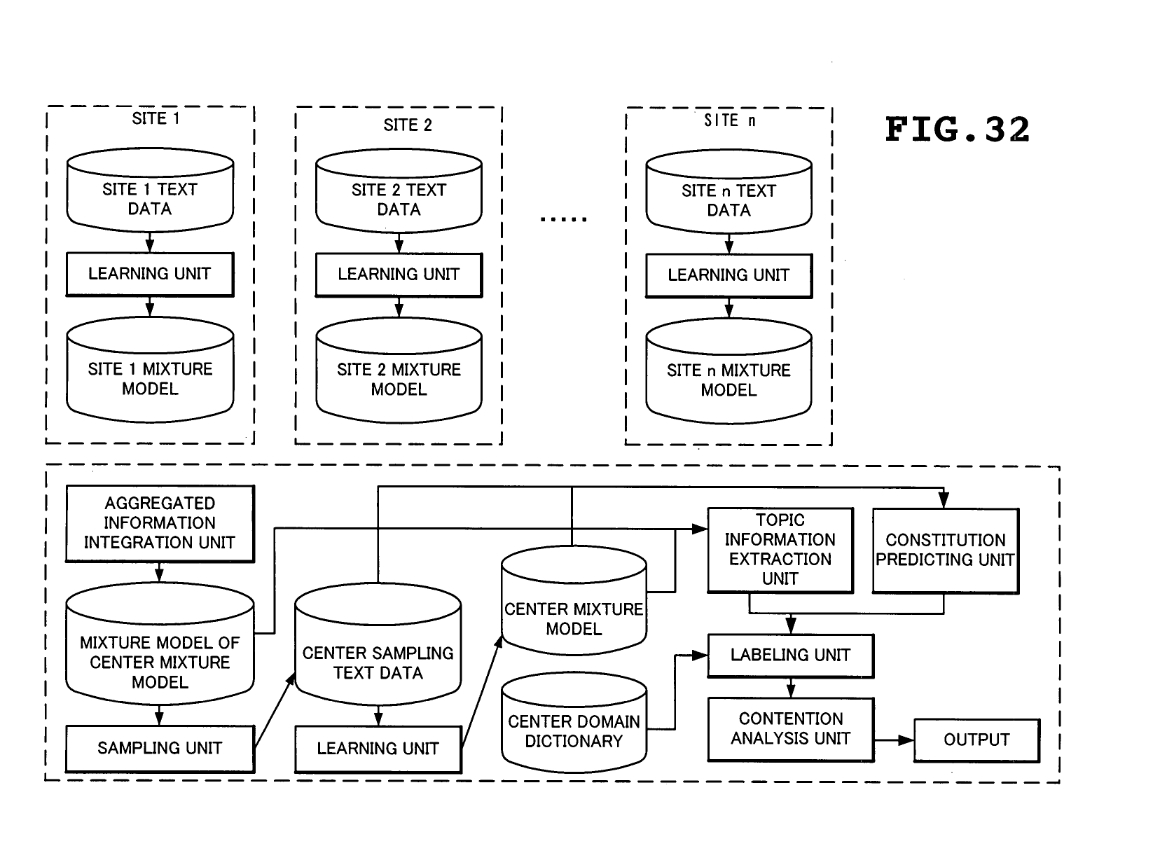

FIG. 32 is a block diagram showing a still further specific example of a structure of the macro information generation system. The present embodiment differs from the twenty-first embodiment in that a center device includes, in addition to the components of the center device shown in FIG. 30, a contention analysis unit for generating a graph such as a radar chart for supporting contention analysis of each site.

In the present embodiment, the contention analysis unit generates a graph such as a radar chart with a topic on the center side as an axis based on a contribution rate of a site to the topic on the center side which is obtained by the constitution predicting unit. The contention analysis unit, for example, plots a point indicative of a site most contributing to calculation of macro information to a position of a maximum value of the axis of the radar chart and a point indicative of other site to a position of a value obtained from a relative ratio to a site having the maximum value. The contention analysis unit also applies, as a label of the axis, a technical domain generated by the labeling unit, for example.

With the foregoing arrangement, as long as sites are corporations of the same business field, in terms of the volume of data, that is, which corporation owns the largest volume of data with respect to a specific technical domain, each company (corporation) is allowed to know advantages and disadvantages of each corporation in the relevant technical region. This accordingly helps contention analysis by each corporation. When data accumulated in the site is patent information owned by a corporation, for example, a patent map indicating which corporation has the largest number of patent applications in the industrial field or the like can be automatically created with respect to a specific technical domain.

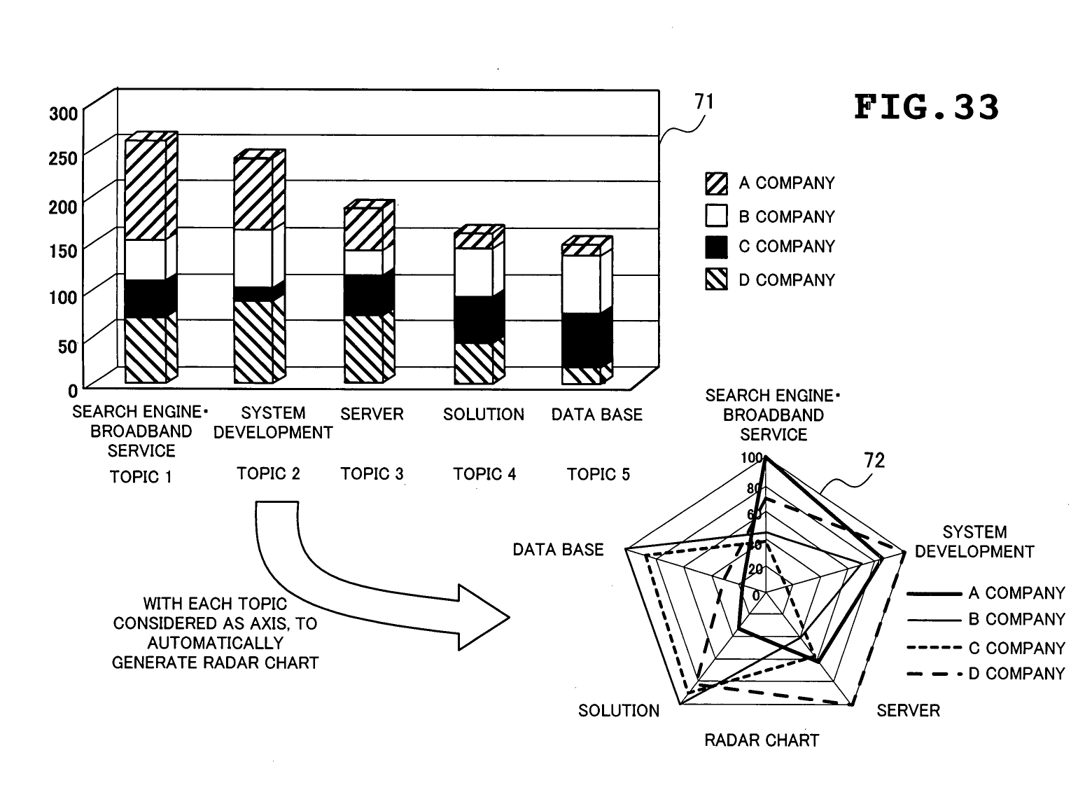

FIG. 33 is diagram for use in explaining an output example of a radar chart automatically generated and output based on a site constitution ratio of a center topic. In FIG. 33, a bar chart 71 is a graph showing a constitution ratio obtained based on a contribution rate of each site to a center topic. The bar chart 71 is generated by the constitution predicting unit and the labeling unit shown in FIG. 32. In the example shown in FIG. 33, a label “search engine broadband service” is applied to the topic 1 and a label “system development” is applied to the topic 2.

The contention analysis unit automatically generates a radar chart 72 shown in FIG. 33 with each topic shown in the bar chart in FIG. 33 as each axis of the radar chart. In this case, as a method of inputting a value to the radar chart 72, the contention analysis unit plots a most contributing site to a maximum value of the axis and plots other sites based on a relative ratio to the site having the maximum value. Thus, in the example shown in FIG. 33, it can be found, for example, that as compared with A company and D company, B company and C company own (accumulate) more data related to a data base and that B company and C company are advantageous in the topic “data base”.

### INDUSTRIAL USE

The present invention is applicable for use in generating macro information such as a probability distribution based on data accumulated by a plurality of sites. The present invention is in particular applicable to a business model of providing macro information distribution service of distributing macro information generated by a center device to each site device.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A macro information generation system, comprising:
a plurality of data accumulation devices which accumulate data; and
a data processing device which processes data accumulated by each said data accumulation device, wherein
said data accumulation device including
aggregated information generation unit which generates aggregated information obtained by aggregating accumulated data by a predetermined method, and
aggregated information transmission unit which transmits aggregated information generated by said aggregated information generation unit to said data processing device through a communication network, and
said data processing device including
data reproduction unit which generates reproduction data which reproduces the contents of data accumulated by each said data accumulation device based on aggregated information received from each said data accumulation device, and
macro information generation unit which analyzes reproduction data generated by said data reproduction unit to generate macro information as information obtained by macroscopically integrating data accumulated by each said data accumulation device.

2. The macro information generation system as set forth in claim 1, wherein
said data processing device includes aggregated information integration unit which generates integrated aggregated information which is obtained by integrating aggregated information received from each data accumulation device, and
said data reproduction unit generates reproduction data based on integrated aggregated information which is generated by said aggregated information integration unit.

3. The macro information generation system as set forth in claim 1, wherein
said macro information generation unit generates sampling data as reproduction data by sampling aggregated information received from each data accumulation device.

4. The macro information generation system as set forth in claim 1, wherein
said data processing device includes aggregated information integration unit which generates integrated aggregated information which is obtained by integrating aggregated information received from each data accumulation device,
said data reproduction unit generates reproduction data based on integrated aggregated information which is generated by said aggregated information integration unit, and
said macro information generation unit generates sampling data as reproduction data by sampling aggregated information received from each data accumulation device.

5. The macro information generation system as set forth in claim 1, wherein
said data accumulation device includes
dimension information generation unit which generates dimension information indicative of a dimension of accumulated data, and
dimension information transmission unit which transmits dimension information generated by said dimension information generation unit to the data processing device through the communication network, and
said data processing device includes
dimension information integration unit which generates integrated dimension information obtained by integrating dimension information received from each data accumulation device, and
said data reproduction unit generates reproduction data based on aggregated information received from each said data accumulation device and integrated dimension information generated by said dimension information integration unit.

6. The macro information generation system as set forth in claim 5, wherein
said data processing device includes dictionary storage unit which stores a predetermined word dictionary, and
said dimension information integration unit generates, as integrated dimension information, a correspondence rule indicative of a corresponding relationship between words contained in dimension information received from each data accumulation device based on the word dictionary stored by said dictionary storage unit.

7. The macro information generation system as set forth in claim 1, wherein
said macro information generation unit obtains, as macro information, a macro distribution which is a distribution of a probability that an information element contained in data accumulated by each data accumulation device will appear in said data.

8. The macro information generation system as set forth in claim 7, wherein
said data processing device includes data conversion unit which converts a macro distribution generated by said macro information generation unit into a predetermined data form.

9. The macro information generation system as set forth in claim 8, wherein
said data conversion unit converts a macro distribution generated by said macro information generation unit into a predetermined data form by extracting activeness or a characteristic word in each topic contained in data accumulated by each data accumulation device.

10. The macro information generation system as set forth in claim 8, wherein
said data conversion unit extracts partial information from a macro distribution generated by said macro information generation unit to convert said partial information extracted into a predetermined data form according to predetermined extraction conditions.

11. The macro information generation system as set forth in claim 8, wherein
said data processing device includes corresponding relationship calculation unit which obtains information indicative of a corresponding relationship between a macro distribution generated by said macro information generation unit and partial information extracted by said data conversion unit.

12. The macro information generation system as set forth in claim 11, wherein
said data processing device includes
domain dictionary storage unit which stores a domain dictionary as a dictionary in which information and a technical domain are correlated, and
labeling processing unit which executes predetermined labeling processing based on the domain dictionary stored by said domain dictionary storage unit.

13. The macro information generation system as set forth in claim 12, wherein
said data conversion unit extracts partial information from a macro distribution generated by said macro information generation unit according to predetermined extraction conditions, and
said labeling processing unit applies predetermined label information to partial information extracted by said data conversion unit based on the domain dictionary stored by said domain dictionary storage unit.

14. The macro information generation system as set forth in claim 13, wherein
said labeling processing unit extracts a technical domain corresponding to partial information from said domain dictionary to apply the extracted technical domain as label information to said partial information.

15. The macro information generation system as set forth in claim 12, wherein
said data processing device includes graph generation unit which generates a graph for displaying comparison between data accumulated by the respective data accumulation devices.

16. The macro information generation system as set forth in claim 15, wherein
said graph generation unit generates a radar chart for competition analysis by using a constitution ratio of a topic on said data accumulation device side and a topic on the data processing device side.

17. The macro information generation system as set forth in claim 1, wherein
said aggregated information generation unit obtains, as aggregated information, a distribution of a probability that an information element contained in data accumulated by said data accumulation device will appear in said data or a quantity of statistics based on a dimension of the data accumulated by said data accumulation device.

18. The macro information generation system as set forth in claim 1, wherein
said data processing device includes topic extraction unit which extracts a common topic appearing commonly over the whole time zone, an individual topic appearing in a specific period or a new topic newly appearing based on time series text data.

19. The macro information generation system as set forth in claim 1, wherein
said data accumulation device includes
evaluation information storage unit which stores evaluation information indicative of evaluation of data contents of text data or a target, and
evaluation information transmission unit which transmits evaluation information stored by said evaluation information storage unit to the data processing device through the communication network, and
said data processing device includes
correspondence information generation unit which generates correspondence information indicative of a corresponding relationship between text data corresponding to evaluation information received from said data accumulation device and data contents of said text data or a target.

20. A macro information generation system, comprising:
a plurality of data accumulation devices which accumulate data; and
a data processing device which processes data accumulated by each said data accumulation device, wherein
said data accumulation device including
aggregated information generation unit which generates aggregated information obtained by aggregating accumulated data by a predetermined method, and
aggregated information transmission unit which transmits aggregated information generated by said aggregated information generation unit to said data processing device through a communication network, and
said data processing device including
aggregated information integration unit which generates integrated aggregated information which is obtained by integrating aggregated information received from each data accumulation device, and
macro information generation unit which generates macro information as information obtained by macroscopically integrating data accumulated by each said data accumulation device based on integrated aggregated information generated by said aggregated information integration unit.

21. The macro information generation system as set forth in claim 20, wherein
said data accumulation device includes
dimension information generation unit which generates dimension information indicative of a dimension of accumulated data, and
dimension information transmission unit which transmits dimension information generated by said dimension information generation unit to the data processing device through the communication network,
said data processing device includes
dimension information integration unit which generates integrated dimension information obtained by integrating dimension information received from each data accumulation device, and
said data reproduction unit generates reproduction data based on integrated aggregated information which is generated by said aggregated information integration unit and integrated dimension information generated by said dimension information integration unit.

22. A macro information generation system, comprising:
a plurality of data accumulation devices which accumulate data; and
a data processing device which processes data accumulated by each said data accumulation device, wherein
said data accumulation device including
aggregated information generation unit which generates aggregated information obtained by aggregating accumulated data by a predetermined method,
data reproduction unit which generates reproduction data which reproduces the contents of data accumulated by said data accumulation device based on aggregated information generated by said aggregated information generation unit, and
reproduction data transmission unit which transmits reproduction data generated by said data reproduction unit to said data processing device through a communication network, and
said data processing device including
macro information generation unit which analyzes reproduction data received from said data accumulation device to generate macro information as information obtained by macroscopically integrating data accumulated by each said data accumulation device.

23. A macro information distribution system, comprising:
a plurality of data accumulation devices which accumulate data; and
a data processing device which processes data accumulated by each said data accumulation device, wherein
said data accumulation device including
aggregated information generation unit which generates aggregated information obtained by aggregating accumulated data by a predetermined method, and
aggregated information transmission unit which transmits aggregated information generated by said aggregated information generation unit to said data processing device through a communication network, and
said data processing device including
data reproduction unit which generates reproduction data which reproduces the contents of data accumulated by each said data accumulation device based on aggregated information received from each said data accumulation device,
macro information generation unit which analyzes reproduction data generated by said data reproduction unit to generate macro information as information obtained by macroscopically integrating data accumulated by each said data accumulation device, and
macro information distribution unit which transmits macro information generated by said macro information generation unit to said data accumulation device through the communication network.

24. The macro information distribution system as set forth in claim 23, wherein
said data processing device includes topic extraction unit which extracts a topic contained in macro information generated by said macro information generation unit according to predetermined extraction conditions, and
said macro information distribution unit transmits a topic extracted by said topic extraction unit to the data accumulation device through the communication network.

25. The macro information distribution system as set forth in claim 24, wherein
said topic extraction unit extracts a common topic appearing commonly over the whole time zone, an individual topic appearing in a specific period or a new topic newly appearing based on time series text data.

26. The macro information distribution system as set forth in claim 23, wherein
said data accumulation device includes flag addition unit which adds a predetermined flag to accumulated data,
said aggregated information generation unit obtains, as aggregated information, the number of flags added to data accumulated by said data accumulation device, and
said macro information generation unit generates macro information by executing predetermined prediction processing based on the number of flags received from said data accumulation device.

27. The macro information distribution system as set forth in claim 23, wherein
said data accumulation device includes
declaration information transmission unit which transmits declaration information indicating to which topic the data accumulated by the data accumulation device in question relates to the data processing device through the communication network, and
search request transmission unit which transmits a search request for similar data which is similar to data accumulated by the data accumulation device in question to said data processing device through the communication network, and
said data processing device includes
declaration information storage unit which stores declaration information received from each data accumulation device so as to be correlated with the data accumulation device,
accumulation device specifying unit which, upon receiving a search request from the data accumulation device, specifies the data accumulation device which accumulates similar data whose search is requested based on the declaration information stored by said declaration information storage unit, and
data transmission request unit which transmits a request for transmission of similar data to the data accumulation device having receiving a search request to the data accumulation device specified by said accumulation device specifying unit through the communication network.

28. The macro information distribution system as set forth in claim 23, wherein
said data accumulation device includes
evaluation information storage unit which stores evaluation information indicative of evaluation of data contents of text data or a target, and
evaluation information transmission unit which transmits evaluation information stored by said evaluation information storage unit to the data processing device through the communication network,
said data processing device includes
correspondence information generation unit which generates correspondence information indicative of a corresponding relationship between text data corresponding to evaluation information received from the data accumulation device and data contents of said text data or a target, and
said macro information distribution unit transmits correspondence information generated by said correspondence information generation unit to the data accumulation device through the communication network.

29. A macro information generation device, comprising:
aggregated information reception unit which receives, from a plurality of data accumulation devices which accumulate data, aggregated information obtained by aggregating data accumulated by said data accumulation device by a predetermined method through a communication network;
data reproduction unit which generates reproduction data which reproduces the contents of data accumulated by each said data accumulation device based on aggregated information received by said aggregated information reception unit; and
macro information generation unit which analyzes reproduction data generated by said data reproduction unit to generate macro information as information obtained by macroscopically integrating data accumulated by each said data accumulation device.

30. The macro information generation device as set forth in claim 29, further comprising:
aggregated information integration unit which generates integrated aggregated information which is obtained by integrating aggregated information received by said aggregated information reception unit,
wherein said data reproduction unit generates reproduction data based on integrated aggregated information which is generated by said aggregated information integration unit.

31. The macro information generation device as set forth in claim 29, further comprising:
dimension information reception unit which receives dimension information indicative of a dimension of data accumulated by the data accumulation device from each data accumulation device through the communication network, and
dimension information integration unit which generates integrated dimension information which is obtained by integrating dimension information received by said dimension information reception unit, wherein
said data reproduction unit generates reproduction data based on aggregated information received by said aggregated information reception unit and integrated dimension information generated by said dimension information integration unit.

32. A macro information distribution device, further comprising:
aggregated information reception unit which receives, from a plurality of data accumulation devices which accumulate data, aggregated information obtained by aggregating data accumulated by said data accumulation device by a predetermined method through a communication networks,
data reproduction unit which generates reproduction data which reproduces the contents of data accumulated by each said data accumulation device based on aggregated information received by said aggregated information reception unit,
macro information generation unit which analyzes reproduction data generated by said data reproduction unit to generate macro information as information obtained by macroscopically integrating data accumulated by each said data accumulation device, and
macro information distribution unit which transmits macro information generated by said macro information generation unit to said data accumulation device through the communication network.

33. A data accumulation device in a macro information generation system which generates macro information as information obtained by macroscopically integrating data accumulated by a plurality of data accumulation devices, comprising:
aggregated information generation unit which generates aggregated information obtained by aggregating accumulated data by a predetermined method;
data reproduction unit which generates reproduction data which reproduces the contents of data accumulated by said data accumulation device based on aggregated information generated by said aggregated information generation unit; and
reproduction data transmission unit which transmits reproduction data generated by said data reproduction unit to a data processing device which processes data accumulated by each data accumulation device through a communication network.

34. A macro information generation method, comprising the steps of:
a step, of a plurality of data accumulation devices which accumulate data, of generating aggregated information which is obtained by aggregating accumulated data by a predetermined method;
a step of each said data accumulation device of transmitting said aggregated information generated to a data processing device which processes data accumulated by each said data accumulation device through a communication network;
a step of said data processing device of generating reproduction data which reproduces the contents of data accumulated by each said data accumulation device based on aggregated information received from each said data accumulation device; and
a step of said data processing device of analyzing said reproduction data generated to generate macro information as information obtained by macroscopically integrating data accumulated by each said data accumulation device.

35. A macro information generation program for generating macro information as information obtained by macroscopically integrating data accumulated by a plurality of data accumulation devices, comprising the following functions executed on a computer:
aggregated information reception function of receiving aggregated information obtained by aggregating data accumulated by said data accumulation device by a predetermined method from the plurality of data accumulation devices which accumulate data through a communication network;
data reproduction function of generating reproduction data which reproduces the contents of data accumulated by each said data accumulation device based on said aggregated information received; and
macro information generation function of analyzing said reproduction data generated to generate macro information.

36. The macro information generation program as set forth in claim 35, further comprising the function of:
aggregated information integration function of generating integrated aggregated information which is obtained by integrating aggregated information received from each data accumulation device, wherein
said data reproduction function including function of generating reproduction data based on said integrated aggregated information generated.

37. The macro information generation program as set forth in claim 35, further comprising the functions of:
dimension information reception function of receiving dimension information indicative of a dimension of data accumulated by the data accumulation device from each data accumulation device through the communication network, and
dimension information integration function of generating integrated dimension information which is obtained by integrating dimension information received from each data accumulation device, wherein
said data reproduction function including function of generating reproduction data based on aggregated information received from the data accumulation device and said integrated dimension information generated.

38. A macro information distribution program for distributing macro information as information obtained by macroscopically integrating data accumulated by a plurality of data accumulation devices, comprising the following functions executed on a computer:
aggregated information reception function of receiving aggregated information obtained by aggregating data accumulated by said data accumulation device by a predetermined method from the plurality of data accumulation devices which accumulate data through a communication network;
data reproduction function of generating reproduction data which reproduces the contents of data accumulated by each said data accumulation device based on aggregated information received from each data accumulation device;
macro information generation function of analyzing said reproduction data generated to generate macro information; and
macro information distribution function of transmitting said macro information generated to said data accumulation device through the communication network.

39. An accumulated data processing program for a data accumulation device to process accumulated data in a macro information generation system which generates macro information as information obtained by macroscopically integrating data accumulated by a plurality of data accumulation devices, comprising the following functions executed on a computer including data accumulation unit for accumulating data:
aggregated information generation function of generating aggregated information obtained by aggregating data accumulated by said data accumulation unit by a predetermined method;
data reproduction function of generating reproduction data which reproduces the contents of data accumulated by said data accumulation unit based on said aggregated information generated; and
reproduction data transmission function of transmitting said reproduction data generated to a data processing device which processes data accumulated by each data accumulation device through a communication network.
